(19) United States
(12) Patent Application Publication
(10) Pub. No.: US 2023/0258681 A1
(43) Pub. Date: Aug. 17, 2023

(54) AUTOMATIC ANALYZER

(71) Applicant: Canon Medical Systems Corporation, Otawara-shi (JP)

(72) Inventor: Shozo HASHIMOTO, Nasushiobara (JP)

(73) Assignee: Canon Medical Systems Corporation, Otawara-shi (JP)

(21) Appl. No.: 18/050,210

(22) Filed: Oct. 27, 2022

(30) Foreign Application Priority Data
Oct. 27, 2021 (JP) 2021-175385
Nov. 17, 2021 (JP) 2021-187028
Oct. 25, 2022 (JP) 2022-170713

(51) Int. Cl. G01N 35/10; G01N 35/02

(52) U.S. Cl. CPC G01N 35/109; G01N 35/1002; G01N 35/025; G01N 2035/0455

(57) ABSTRACT

According to one embodiment, an automatic analyzer includes a holding unit configured to hold a measurement sheet having a roll shape, the measurement sheet including a measurement section where a sample dispensed at a dispensing position is measured; a conveyance unit configured to convey the measurement sheet to the dispensing position and a measurement position where measurement is performed on the sample; and a measurement unit configured to move to the measurement position and measure a material property value of the sample.

### CROSS-REFERENCE TO RELATED APPLICATIONS

This application is based upon and claims the benefit of priority from the prior Japanese Patent Applications No. 2021-175385, filed Oct. 27, 2021; No. 2021-187028, filed Nov. 17, 2021; and No. 2022-170713, filed Oct. 25, 2022; the entire contents of all of which are incorporated herein by reference.

### FIELD

Embodiments disclosed herein and the accompanying drawings relate to an automatic analyzer.

### BACKGROUND

Automatic analyzers are devices that measure the concentration or activity value of components contained in blood or urine optically or electrically using chemical reactions with test reagents.

An automatic analyzer discharges samples contained for each examinee, such as patients and medical checkup examinees, into individual reaction containers assigned for measurement of each test item. The automatic analyzer discharges a reagent corresponding to each test item into a reaction container corresponding to that test item. Then, measurement is performed for the test item using a mixture liquid of a sample and a reagent in each reaction container.

One measurement method for test items is, for example, electrode measurement. In electrode measurement, the potential of a calibration liquid needs to be measured between one measurement and the next. This reduces throughput. In addition, the device tends to be large in size due to the need for a washing mechanism for reaction tubes used in the measurement and a reagent probe to dispense the reagent into the reaction tubes.

### BRIEF DESCRIPTION OF THE DRAWINGS

FIG. 1 is a diagram showing a configuration of an automatic analyzer according to a first embodiment.

FIG. 2 is a perspective view showing an example of a configuration of an analysis mechanism of the automatic analyzer according to the first embodiment.

FIG. 3 is a perspective view showing an example of a configuration of a measurement unit of the automatic analyzer according to the first embodiment.

FIG. 4 is a diagram showing an example of a configuration of a sheet holding part of the automatic analyzer according to the first embodiment.

FIG. 5 is a diagram showing the sheet holding part of the automatic analyzer according to the first embodiment rotated 180° from the state shown in FIG. 4.

FIG. 6 is a diagram showing an example of a configuration of a measurement sheet of the automatic analyzer according to the first embodiment.

FIG. 7 is an enlarged view of one item measurement part shown in FIG. 6.

FIG. 8 is a diagram showing an example of configurations of a conveyor mechanism and a measuring device of the automatic analyzer according to the first embodiment.

FIG. 9 is a diagram showing a state in which a connection part of the measurement sheet and a connection part of the conveyor mechanism of the automatic analyzer according to the first embodiment are connected together.

FIG. 10 is a diagram showing a state in which a distal end portion of the measurement sheet of the automatic analyzer according to the first embodiment has reached a position where a feed mechanism is arranged.

FIG. 11 is a flowchart illustrating a processing procedure of automatic conveyance processing performed by the automatic analyzer according to the first embodiment.

FIG. 12 is a flowchart illustrating a processing procedure of a measurement process performed by the automatic analyzer according to the first embodiment.

FIG. 13 is a diagram showing electrode measurement being performed using the measurement sheet of the automatic analyzer according to the first embodiment, as viewed from the front side of the sheet in FIG. 8.

FIG. 14 is a diagram showing the electrode measurement being performed using the measurement sheet of the automatic analyzer according to the first embodiment, as viewed from the front side of the sheet in FIG. 8.

FIG. 15 is a diagram showing the electrode measurement being performed using the measurement sheet of the automatic analyzer according to the first embodiment, as viewed from the front side of the sheet in FIG. 8.

FIG. 16 is a cross-sectional view taken along line A-A in FIG. 14.

FIG. 17 is a cross-sectional view taken along line A-A in FIG. 15.

FIG. 18 is a diagram showing colorimetric measurement being performed using the measurement sheet of the automatic analyzer according to the first embodiment, as viewed from the front side of the sheet in FIG. 8.

FIG. 19 is a diagram showing the colorimetric measurement being performed using the measurement sheet of the automatic analyzer according to the first embodiment, as viewed from the front side of the sheet in FIG. 8.

FIG. 20 is a diagram showing the colorimetric measurement being performed using the measurement sheet of the automatic analyzer according to the first embodiment, as viewed from the front side of the sheet in FIG. 8.

FIG. 21 is a cross-sectional view taken along line A-A in FIG. 19.

FIG. 22 is a cross-sectional view taken along line A-A in FIG. 20.

FIG. 23 is a diagram showing a state in which the measurement sheet of the automatic analyzer according to the first embodiment has been used to the end.

FIG. 24 is a diagram showing a state in which a used measurement sheet of the automatic analyzer according to the first embodiment has been collected by the sheet holding part.

FIG. 25 is a diagram showing a state in which the used measurement sheet of the automatic analyzer according to the first embodiment has moved to an installation position.

FIG. 26 is a flowchart illustrating a processing procedure of status display processing performed by the automatic analyzer according to the first embodiment.

FIG. 27 is a perspective view showing a state of use or replacement of the measurement sheet being displayed by the automatic analyzer according to the first embodiment.

FIG. 28 is a diagram showing an example of a configuration of a measurement sheet of an automatic analyzer according to a first modification of the first embodiment.

FIG. 29 is a diagram showing a configuration of an automatic analyzer according to a second modification of the first embodiment.

FIG. 30 is a diagram showing electrode measurement being performed by using the automatic analyzer according to the second modification of the first embodiment.

FIG. 31 is a diagram showing a configuration of an automatic analyzer according to a third modification of the first embodiment.

FIG. 32 is a diagram showing an example of configurations of a conveyor mechanism and a measuring device according to a fifth modification of the first embodiment.

FIG. 33 is a diagram showing a configuration of an automatic analyzer according to a second embodiment.

FIG. 34 is a block diagram showing an example of a configuration of an automatic analyzer according to a third embodiment.

FIG. 35 is a diagram showing an example of a configuration of an analyzing device in the automatic analyzer according to the third embodiment.

FIG. 36A is a diagram showing an example of a measurement sheet in the third embodiment.

FIG. 36B is a diagram showing an example of the measurement sheet in the third embodiment.

FIG. 36C is a diagram showing an example of the measurement sheet in the third embodiment.

FIG. 36D is a diagram showing an example of the measurement sheet in the third embodiment.

FIG. 37A is a diagram showing an example of potential measurement using the measurement sheet in the third embodiment.

FIG. 37B is a diagram showing an example of the potential measurement using the measurement sheet in the third embodiment.

FIG. 37C is a diagram showing an example of the potential measurement using the measurement sheet in the third embodiment.

FIG. 38A is a diagram showing an example of colorimetric measurement using the measurement sheet in the third embodiment.

FIG. 38B is a diagram showing an example of the colorimetric measurement using the measurement sheet in the third embodiment.

FIG. 38C is a diagram showing an example of the colorimetric measurement using the measurement sheet in the third embodiment.

FIG. 39 is a diagram showing an example of a measurement cartridge in the third embodiment.

FIG. 40A is a diagram showing an example of a measurement cartridge conveyor mechanism in the third embodiment.

FIG. 40B is a diagram showing an example of the measurement cartridge conveyor mechanism in the third embodiment.

FIG. 41A is a diagram for explaining processing of the automatic analyzer according to the third embodiment.

FIG. 41B is a diagram for explaining the processing of the automatic analyzer according to the third embodiment.

FIG. 41C is a diagram for explaining the processing of the automatic analyzer according to the third embodiment.

FIG. 41D is a diagram for explaining the processing of the automatic analyzer according to the third embodiment.

FIG. 41E is a diagram for explaining the processing of the automatic analyzer according to the third embodiment.

FIG. 41F is diagram for explaining the processing of the automatic analyzer according to the third embodiment.

FIG. 42A is a diagram for explaining a sheet collection mechanism connection part and a sheet collection slide mechanism in the third embodiment.

FIG. 42B is a diagram for explaining the sheet collection mechanism connection part and the sheet collection slide mechanism in the third embodiment.

FIG. 42C is a diagram for explaining the sheet collection mechanism connection part and the sheet collection slide mechanism in the third embodiment.

FIG. 42D is a diagram for explaining the sheet collection mechanism connection part and the sheet collection slide mechanism in the third embodiment.

FIG. 43A is a diagram for explaining the sheet collection slide mechanism in the third embodiment.

FIG. 43B is a diagram for explaining the sheet collection slide mechanism in the third embodiment.

FIG. 43C is a diagram for explaining the sheet collection slide mechanism in the third embodiment.

FIG. 43D is a diagram for explaining the sheet collection slide mechanism in the third embodiment.

FIG. 43E is a diagram for explaining the sheet collection slide mechanism in the third embodiment.

FIG. 43F is a diagram for explaining the sheet collection slide mechanism in the third embodiment.

FIG. 44A is a diagram for explaining the sheet collection slide mechanism in the third embodiment.

FIG. 44B is a diagram for explaining the sheet collection slide mechanism in the third embodiment.

FIG. 45A is a diagram for explaining processing of an automatic analyzer according to a first modification of the third embodiment.

FIG. 45B is a diagram for explaining the processing of the automatic analyzer according to the first modification of the third embodiment.

FIG. 45C is a diagram for explaining the processing of the automatic analyzer according to the first modification of the third embodiment.

FIG. 45D is a diagram for explaining the processing of the automatic analyzer according to the first modification of the third embodiment.

FIG. 45E is a diagram for explaining the processing of the automatic analyzer according to the first modification of the third embodiment.

FIG. 45F is a diagram for explaining the processing of the automatic analyzer according to the first modification of the third embodiment.

FIG. 46A is a diagram for explaining a sheet collection mechanism connection part and a sheet collection mechanism in the first modification of the third embodiment.

FIG. 46B is a diagram for explaining the sheet collection mechanism connection part and the sheet collection mechanism in the first modification of the third embodiment.

FIG. 46C is a diagram for explaining the sheet collection mechanism connection part and the sheet collection mechanism in the first modification of the third embodiment.

FIG. 46D is a diagram for explaining the sheet collection mechanism connection part and the sheet collection mechanism in the first modification of the third embodiment.

FIG. 47A is a diagram for explaining processing of an automatic analyzer according to a second modification of the third embodiment.

FIG. 47B is a diagram for explaining the processing of the automatic analyzer according to the second modification of the third embodiment.

FIG. 48 is a diagram for explaining the processing of the automatic analyzer according to the second modification of the third embodiment.

### DETAILED DESCRIPTION

According to one embodiment, an automatic analyzer includes a holding unit configured to hold a measurement sheet having a roll shape, the measurement sheet including a measurement section where a sample dispensed at a dispensing position is measured; a conveyance unit configured to convey the measurement sheet to the dispensing position and a measurement position where measurement is performed on the sample; and a measurement unit configured to move to the measurement position and measure a material property value of the sample.

An object is to achieve downsizing of a device.

Embodiments of an automatic analyzer will be described in detail below with reference to the drawings.

In the following descriptions, components having approximately the same function and configuration are denoted by the same reference numerals, and duplicate explanations will be given only where necessary.

### First Embodiment

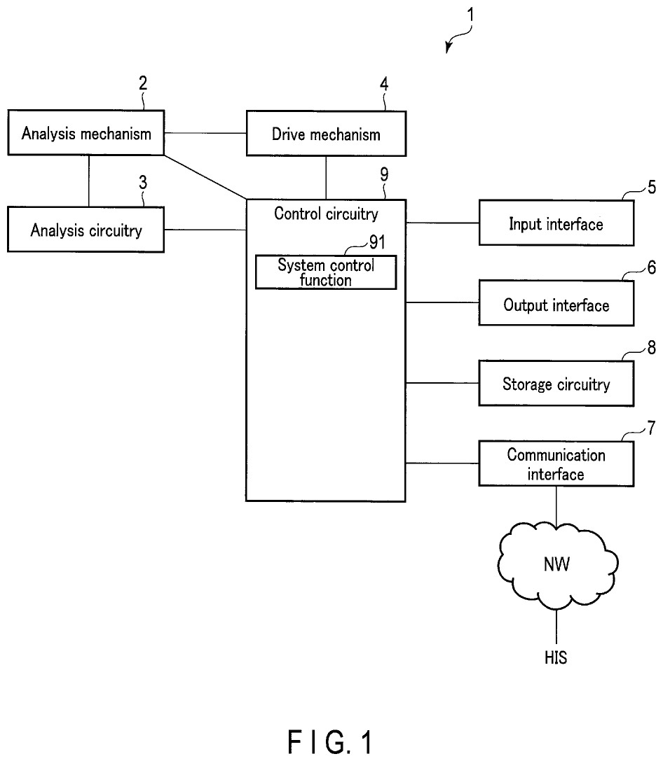

FIG. 1 is a diagram showing a configuration of an automatic analyzer 1 according to a first embodiment. The automatic analyzer 1 includes an analysis mechanism 2, analysis circuitry 3, a drive mechanism 4, an input interface 5, an output interface 6, a communication interface 7, storage circuitry 8, and control circuitry 9.

The analysis mechanism 2 discharges a sample such as blood or urine onto a measurement sheet. Depending on the test item, the analysis mechanism 2 discharges a standard liquid, in which the sample is diluted at a predetermined magnification, onto the measurement sheet. The analysis mechanism 2 measures a material property value of the sample by measuring specific components contained in the sample using the measurement sheet. As measurement methods, colorimetric measurement, which measures a change in color of a sample that reacts with a reagent using an imaging device, and electrode measurement, which measures a change in potential of an electrode, are used. The analysis mechanism 2 generates standard data and subject data, including a measurement result. The sample may also be referred to as an “analyte”.

The analysis circuitry 3 is a processor to analyze the standard data and the subject data generated by the analysis mechanism 2 to generate calibration data and analysis data. The analysis circuitry 3, for example, reads an analysis program from the storage circuitry 8 and analyzes the standard data and the subject data according to the read analysis program. For example, the analysis circuitry 3 calculates a concentration of a specific component contained in a sample (analyte) based on the color change or potential of the sample that is measured by the analysis mechanism 2. The control circuitry 3 may include a storage area for storing at least a portion of the data stored in the storage circuitry 8.

The drive mechanism 4 drives the analysis mechanism 2 under control of the control circuitry 9. The drive mechanism 4 is realized by, for example, a combination of a gear, a stepping motor, a belt conveyor, a lead screw, etc.

The input interface 5 accepts, for example, settings of analysis parameters, etc., for each test item intended for a measurement-requested sample, from an operator or via an in-hospital network NW. The input interface 5 is realized by, for example, one or more of a mouse, a keyboard, a touch pad on which instructions are input by touching an operation screen, a touch panel, etc. The input interface 5 is connected to the control circuitry 9 so that it converts operational commands input by an operator, etc. into electric signals and outputs them to the control circuitry 9. The input interface 5 is an example of an input means.

In the present specification, the input interface is not limited to physical operating components such as a mouse and a keyboard. The input interface 5 may also include electric signal processing circuitry that receives an electric signal corresponding to an operational command input from an external input device separate from the automatic analyzer 1 and outputs this electric signal to the control circuitry 9.

The output interface 6 is connected to the control circuitry 9, and outputs a signal supplied from the control circuitry 9. The output interface 6 is realized by, for example, one or more of display circuitry, print circuitry, an audio device, etc. The output interface 6 notifies the user of a result of residual water detection. The interface 6 is an example of a notifying means. The notifying means may also be referred to as a reporting means.

The display circuitry includes, for example, a CRT display, a liquid crystal display, an organic EL display, an LED display, a plasma display, etc. Also, the display circuitry may include processing circuitry for converting data of a display subject into video signals and outputting the video signals to external entities. The print circuitry includes, for example, a printer, etc. The print circuitry may also include output circuitry for outputting data of a print subject to external entities. The audio device includes, for example, a speaker, etc. The audio device may also include output circuitry for supplying an audio signal to external entities. The output interface 6 may be realized as a touch panel or touch screen together with the input interface 5.

The communication interface 7 is, for example, connected to the in-hospital network NW. The communication interface 7 performs data communication with a hospital information system (HIS) via the in-hospital network NW. It is also possible for the communication interface 7 to perform data communication with the HIS via a laboratory information system (LIS) connected to the in-hospital network NW.

The storage circuitry 8 stores analysis programs for execution by the analysis circuitry 3 and control programs for realization of functions of the control circuitry 9. The storage circuitry 8 stores, for each test item, the calibration data generated by the analysis circuitry 3. The storage circuitry 8 stores, for each sample, the analysis data generated by the analysis circuitry 3. The storage circuitry 8 stores a test order input from an operator, or a test order received by the communication interface 7 via the in-hospital network NW.

The storage circuitry 8 is a storage device which stores various types of information, such as a hard disk drive (HDD), a solid state drive (SSD), or integrated circuitry. In addition to the HDD, SSD, etc., the storage circuitry 8 may be a portable storage medium such as a CD (Compact Disc), a DVD (Digital Versatile Disc), or a flash memory. The storage circuitry 8 may be a drive device that reads and writes various information to and from a semiconductor memory element, etc. such as a flash memory or a random access memory (RAM). The storage circuitry 8 may also be referred to as a “memory”.

The storage circuitry 8 stores programs to be executed by the control circuitry 9, various types of data to be used in the processing performed by the control circuitry 9, etc. As the program, for example, a program that is installed in a computer from a network or a non-transitory computer-readable storage medium in advance and causes the computer to realize each function of the processing circuitry 9 is used. The various data handled in the present specification are typically digital data. The storage circuitry 8 is an example of a storing means.

The control circuitry 9 is a processor functioning as a center of the automatic analyzer 1. The control circuitry 9 performs a system control function 91 by executing a program read from the storage circuitry 8. That is, the control circuitry 9 includes the system control function 91. Note that the present embodiment will be described assuming that a single processor realizes each function, but the embodiment is not limited thereto. For example, control circuitry may be formed by combining a plurality of independent processors, and the processors may execute respective programs to perform the functions. The system control function 91 may be referred to as system control circuitry or implemented as hardware circuitry. The above description of each function performed by the processing circuitry 9 also applies to each of the following embodiments and modifications. The control circuitry 9 may include a storage area for storing at least a portion of the data stored in the storage circuitry 8. The control circuitry 9 may be referred to as a controller or processing circuitry.

The term “processor” used in the above description means, for example, a central processing unit (CPU), a graphics processing unit (GPU), or circuitry such as an ASIC, a programmable logic device (e.g., a simple programmable logic device (SPLD)), a complex programmable logic device (CPLD), and a field programmable gate array (FPGA). The processor realizes a function by reading and executing a program stored in the storage circuitry 8. Instead of storing the program in the storage circuitry 8, the program may be directly embedded in circuitry of the processor. In this case, the processor realizes the function by reading and executing the program embedded in the circuitry. The embodiments herein do not limit each processor to a single circuitry-type processor. Multiple independent circuits may be combined and integrated as one processor to realize the intended functions. Furthermore, the plural components as given in FIG. 1 may be integrated as one processor to realize the functions thereof. The above description of the “processor” also applies to each of the following embodiments and modifications.

The control circuitry 9, with the system control function 91, controls all units in the automatic analyzer 1 based on input information received from the input interface 5. For example, in the system control function 91, the control circuitry 9 drives the drive mechanism 4 to perform measurement according to test items, and controls the analysis circuitry 3 to analyze the standard data and the subject data generated by the analysis mechanism 2. The processing circuitry 9 that realizes the system control function 91 is an example of a controller.

The control circuitry 9, with the system control function 91, determines the necessity for remeasurement based on measurement results of samples, and causes a sample for which remeasurement is determined to be required to be conveyed to a second aspirating position, which is different from a first aspirating position where unmeasured samples are aspirated.

The control circuitry 9, with the system control function 91, also determines a state of use or replacement of a measurement sheet based on a drive state of the drive mechanism 4, and controls a state of a display part according to a result of the determination to display the state of use or replacement of the measurement sheet on the display part.

Next, a detailed description will be given of a configuration of the analysis mechanism 2.

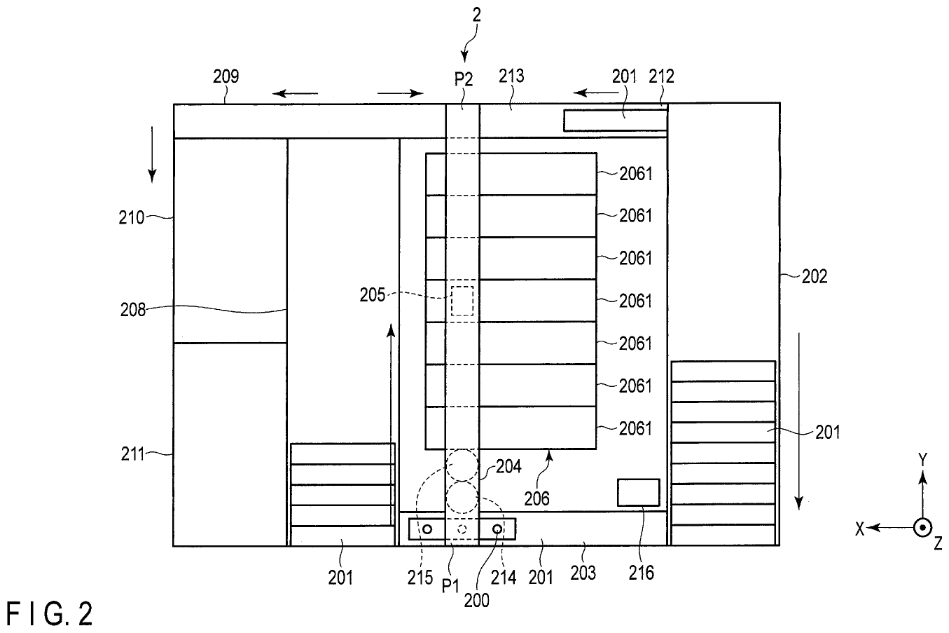

FIG. 2 is a diagram showing an example of the configuration of the analysis mechanism 2 shown in FIG. 1. The analysis mechanism 2 includes a sample rack 201, a rack loading part 202, a first conveyance part 203, a dispensing rail 204, a dispensing probe 205, a measurement unit 206, a during-measurement rack standby part 208, a second conveyance part 209, a rack storage part 210, and a rack collection part 211.

Each sample rack 201 holds a plurality of sample containers 200 containing measurement-requested samples. For example, the sample rack 201 can hold five sample containers in parallel.

A loaded sample rack 201 is placed in the rack loading part 202.

The first conveyance part 203 conveys the sample rack 201 placed in the rack loading part 202 to a first aspirating position P1 by the drive mechanism 4. At the first aspirating position P1, an unmeasured sample is aspirated.

The dispensing rail 204 supports the dispensing probe 205 in such a manner that the dispensing probe 205 can be moved. The dispensing probe 205 dispenses the sample contained in the sample rack 201. Specifically, the dispensing probe 205 aspirates the sample contained in the sample rack 201 conveyed to the first aspirating position P1, then moves along the dispensing rail 204 toward the measurement unit 206, and discharges the aspirated sample to a dispensing position set in the measurement unit 206.

The measurement unit 206 measures material properties of the sample dispensed from the sample rack. The measurement method is, for example, electrode measurement or colorimetric measurement. The measurement unit 206 generates standard data or subject data based on a measurement result. The measurement unit 206 outputs the standard data and the subject data to the analysis circuitry 3.

The first conveyance part 203 conveys the sample rack 201 from which the sample has been dispensed at the first aspirating position P1 to the during-measurement rack standby part 208.

The sample rack 201, from which the sample is aspirated at the first aspirating position P1, is conveyed to the during-measurement rack standby part 208. The sample rack 201 stands by in the during-measurement rack standby part 208 until the sample measurement by the measurement unit 206 is completed.

The analysis mechanism 2 also includes the second conveyance part 209.

The second conveyance part 209 conveys the sample rack 201 that has undergone the measurement operation from the during-measurement rack standby part 208 to a second aspirating position P2 or the rack storage part 210. If the measurement by the measurement unit 206 is successfully completed, the second conveyance part 209 conveys the sample rack 201 to the rack storage part 210 by the drive mechanism 4. On the other hand, if a retest by the measurement unit 206 is required, the second conveyance part 209 conveys the sample rack 201 requiring a retest to the second aspirating position P2 by the drive mechanism 4. At the second aspirating position P2, the sample that is determined to require remeasurement is aspirated.

The sample contained in the sample rack 201 conveyed to the second aspirating position P2 is aspirated by the dispensing probe 205. The dispensing probe 205 moves along the dispensing rail 204 toward the measurement unit 206, and discharges the aspirated sample to the measurement unit 206. The remeasurement of the sample is then performed by the measurement unit 206.

In the rack storage part 210, the sample rack 201 that has undergone the measurement operation by the measurement unit 206 is conveyed.

In the rack collection part 211, the sample rack 201 that has undergone the measurement operation is collected.

The analysis mechanism 2 also includes an emergency analyte placement part 212 and a third conveyance part 213.

In the emergency analyte placement part 212, a sample rack 201 containing an analyte that needs to be tested urgently (hereinafter referred to as an “emergency analyte”) is placed.

The third conveyance part 213 conveys the sample rack 201 placed in the emergency analyte placement part 212 to the second aspirating position P2 by the drive mechanism 4.

The emergency analyte contained in the sample rack 201 conveyed to the second aspirating position P2 is aspirated by the dispensing probe 205. The dispensing probe 205 then moves along the dispensing rail 204 toward the measurement unit 206, and discharges the aspirated sample to the measurement unit 206. The measurement of the emergency analyte is then performed by the measurement unit 206.

Next, an arrangement of each component included in the analysis mechanism 2 will be described. Here, as shown in FIG. 2, an X-axis direction (conveying direction), a Y-axis direction (measurement direction), and a Z-axis direction (vertical direction) are defined.

The rack loading part 202 is arranged at one end of the analysis mechanism 2 in the X-axis direction, and the rack storage part 210 and the rack collection part 211 are arranged at the other end of the analysis mechanism 2 in the X-axis direction. The during-measurement rack standby part 208 is arranged adjacent to the rack storage part 210 between the rack loading part 202 and the rack storage part 210 in the X-axis direction. The measurement unit 206 is arranged between the rack loading part 202 and the during-measurement rack standby part 208 in the X-axis direction.

The first conveyance part 203 is arranged at one end of the analysis mechanism 2 in the Y-axis direction, and the third conveyance part 213 is arranged at the other end of the analysis mechanism 2 in the Y-axis direction. The measurement unit 206 is arranged between the first conveyance part 203 and the third conveyance part 213 in the Y-axis direction. That is, the third conveyance part 213 is arranged at an end opposite to the first conveyance part 203 in the Y-axis direction.

The dispensing rail 204 is provided between the rack loading part 202 and the during-measurement rack standby part 208 in the X-axis direction. The dispensing rail 204 extends along the Y-axis direction.

The dispensing probe 205 can be moved relative to the dispensing rail 204 by the drive mechanism 4. The dispensing probe 205 can be moved along the dispensing rail 204 in the Y-axis direction by driving of the drive mechanism 4. The dispensing probe 205 can also be moved vertically in the Z-axis direction relative to the dispensing rail 204.

The dispensing rail 204 is provided over a range from a position directly above the first conveyance part 203 to a position directly above the third conveyance part 213. That is, a traveling path of the dispensing probe 205 intersects each of the first conveyance part 203 and the third conveyance part 213. The first aspirating position P1 is set at an intersection between the traveling path of the dispensing probe 205 and the first conveyance part 203. The second aspirating position P2 is set at an intersection between the traveling path of the dispensing probe 205 and the third conveyance part 213.

Further, a discharging position is set on the traveling path of the dispensing probe 205. At the discharging position, a sample aspirated by the dispensing probe 205 is discharged to the measurement unit 206.

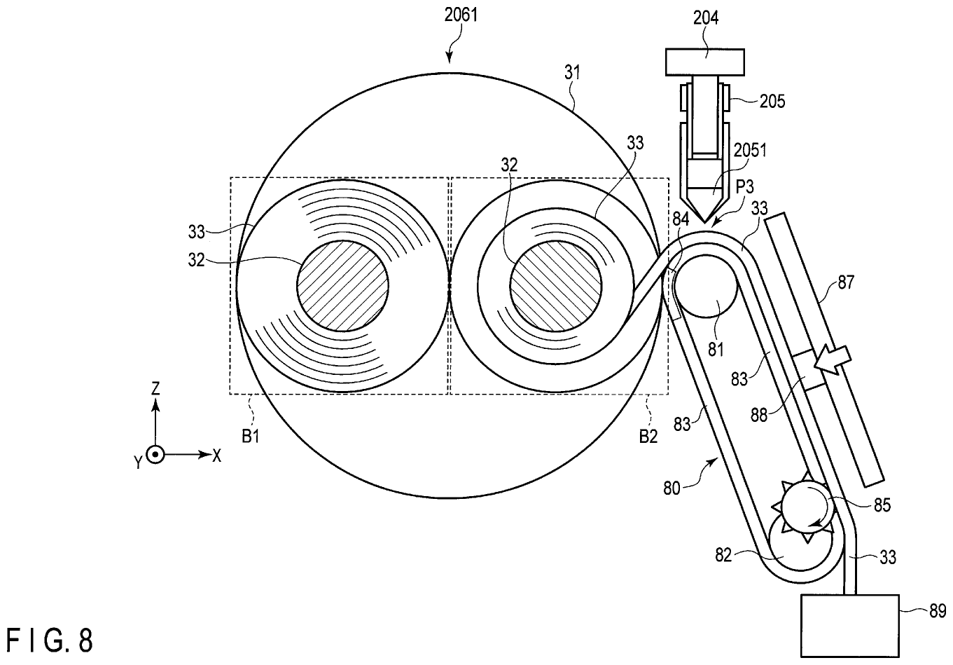

A sampling tip 2051 shown in FIG. 8 is attached to a distal end portion of the dispensing probe 205. The sampling tip 2051 is detachable from the dispensing probe 205, and is disposable. The analysis mechanism 2 also includes a tip attachment mechanism 214 and a tip disposal mechanism 215. The tip attachment mechanism 214 and the tip disposal mechanism 215 are arranged on the traveling path of the dispensing probe 205. When dispensing a sample using the dispensing probe 205, the sample is aspirated into the sampling tip 2051. After discharging the sample to the measurement unit 206, the dispensing probe 205 moves to a position above the tip disposal mechanism 215. The used sampling tip 2051 is removed from the dispensing probe 205 by the tip disposal mechanism 215 and disposed of. The dispensing probe 205 then moves to a position above the tip attachment mechanism 214, and a new sampling tip 2051 is attached to the dispensing probe 205 by the tip attachment mechanism 214.

The use of a disposable sampling tip 2051 eliminates the need to wash the dispensing probe 205, thereby eliminating sample carryover without providing a washing mechanism. By not providing a washing mechanism, the device can be downsized.

Instead of the tip attachment mechanism 214 and the tip disposal mechanism 215, a washing mechanism for washing the dispensing probe 205 with pure water and detergent after dispensing the sample may be provided. In this case, the aforementioned sampling tip 2051 may not be provided.

As described above, the dispensing probe 205 is driven by the drive mechanism 4 so that it ascends or descends at the first aspirating position P1, the second aspirating position P2, the discharging position, a first washing position, and a second washing position. Under the control of the control circuitry 9, the dispensing probe 205 aspirates a sample from a sample rack 201 located at the first aspirating position P1 or the second aspirating position P2. Also, under the control of the control circuitry 9, the dispensing probe 205 discharges the aspirated sample to the measurement unit 206 located at the discharging position. After discharging the sample, the dispensing probe 205 is washed at the first washing position and the second washing position under the control of the control circuitry 9.

Next, a configuration of the measurement unit 206 will be described in detail.

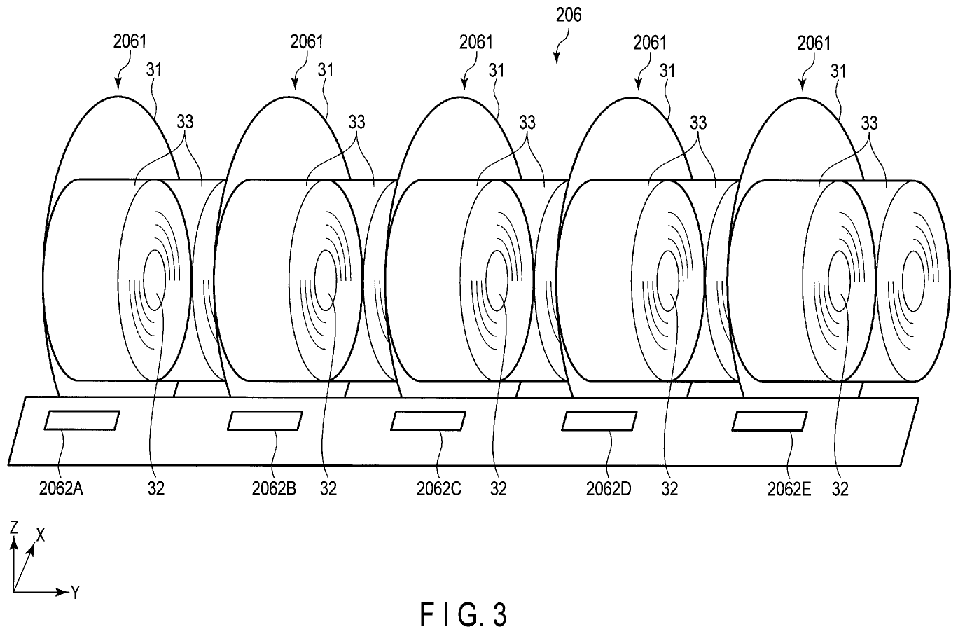

FIG. 3 is a perspective view showing an example of the configuration of the measurement unit 206. The measurement unit 206 includes a plurality of sheet holding parts 2061 holding measurement sheets 33 to be described later. In each sheet holding part 2061, measurement by one type of measurement method is possible. For example, electrode measurement is performed in one sheet holding part 2061, and colorimetric measurement is performed in the other plurality of sheet holding parts 2061. The sheet holding parts 2061 are arranged side by side along the Y-axis direction. The sheet holding parts 2061 are preferably formed of a chemically stable material. Examples of the chemically stable material include, for example, polyethylene, polypropylene, etc. The sheet holding part 2061 is an example of a holding means and a cartridge conveyor mechanism.

The measurement unit 206 also includes a plurality of display parts 2062A to 2062E. The display parts 2062A to 2062E are respectively provided for the sheet holding parts 2061 one for each. Thus, the measurement unit 206 is provided with the same number of display parts 2062A to 2062E as the sheet holding parts 2061. In FIG. 3, five sheet holding parts 2061 and five display parts 2062A to 2062E corresponding to the respective sheet holding parts 2061 are shown.

It suffices that the number of sheet holding parts 2061 provided in the measurement unit 206 is one or more, and eight or more sheet holding parts 2061 may be provided. In the present embodiment, an example is described in which two measurement methods, i.e., colorimetric measurement and electrode measurement, can be executed in the entire measurement unit 206, but the embodiment is not limited thereto. For example, all of the sheet holding parts 2061 may perform colorimetric measurement, or sample measurement by three or more measurement methods may be performed in the entire measurement unit 206.

As shown in FIG. 2, the analysis mechanism 2 includes a reader 216. The reader 9031 is, for example, provided at a position where it can read an optical mark added to the sample rack 201. The optical mark is, for example, a mark, a bar code, a one-dimensional pixel code, a two-dimensional code, etc. obtained by encoding identification information of a sample contained in the sample rack 201. In response to an instruction to start ID reading from the control circuitry 9 as a trigger, the reader 9031 starts reading of the optical mark. Upon arrival of the sample rack 201 at a position where the optical mark can be read, the reader 9031 reads identification information of the sample from that optical mark. The reader 9031 supplies the read identification information to the control circuitry 9. The reader 9031 may be substituted by another sensor using radio frequency identification (RFID), etc.

A reader that reads an optical mark added to a sample rack 201 placed in the emergency analyte placement part 212 may be provided. A reader that reads an optical mark added to each sheet holding part 2061 may be provided in a movable manner. In this case, the reader moves to an arrangement position of each sheet holding part 2061 and reads the optical mark added to the sheet holding part 2061, so as to, for example, acquire a lot, an expiration date for use, a corresponding measurement method, etc., of a measurement sheet held by the sheet holding part 2061. Making the reader movable lowers manufacturing costs as compared to a case of installing one reader for each sheet holding part 2061.

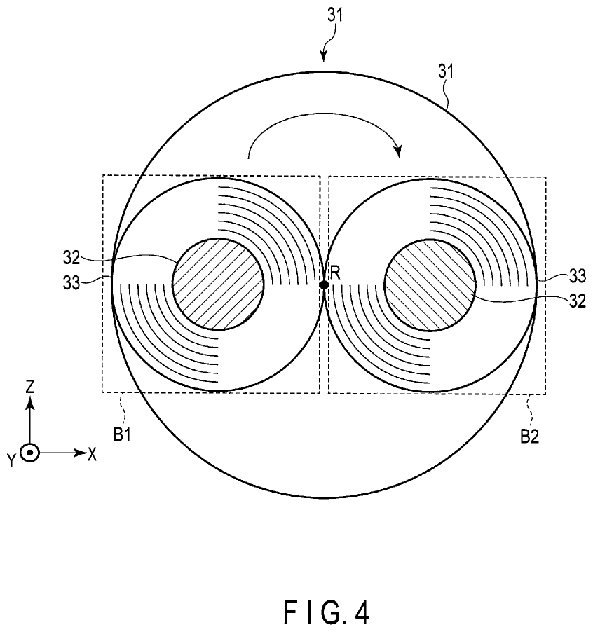

FIG. 4 is a diagram showing an example of a configuration of the sheet holding part 2061. The sheet holding part 2061 includes a rotating plate 31, two attaching shafts 32, and measurement sheets 33 attached to the attaching shafts 32.

The measurement sheet 33 includes a flow channel through which a sample dispensed at a dispensing position flows, and a measurement part that measures the sample that flowed through the flow channel. The measurement sheet 33 is formed in a roll shape. The measurement sheet 33 is a microfluidic analytical device that uses microstructures and flow channels fabricated on a paper substrate as a reaction field to perform sample reaction, analysis, etc. A width of the measurement sheet 33 is, for example, 1 cm to 5 cm. For example, a configuration in which a subject sample is carried to a predetermined position by capillary action is used. It suffices that the measurement sheet 33 has a function to carry a subject sample to a predetermined position. By using the paper substrate, the measurement sheet 33 can be made thin, lightweight, and inexpensive. In addition, by using the paper substrate, even if biological substances adhere to the measurement sheet 33, it can be safely disposed of by incinerating the measurement sheet 33. When a sample is dropped onto the paper, the sample flows naturally through the flow channel by capillary action, thus eliminating the need for an external device such as a pump as compared to a case of using a glass or plastic substrate. As the microstructures or microchannels fabricated on the paper substrate, for example, the ones disclosed in Kentaro Yamada et al., “Microfluidic Paper-based Analytical Devices,” Electrochemistry, The Electrochemical Society of Japan, Dec. 27, 2014, pp. 30-35 can be used. The measurement sheet 33 may be referred to as a sheet for measurement.

Each of the attaching shafts 32 protrudes to one side in the X-axis direction from the rotating plate 31. By the measurement sheet 33 wound in a roll shape being attached to each of the attaching shafts 32, two measurement sheets 33 are housed in the sheet holding part 2061. Each of the attaching shafts 32 can be rotated by the drive mechanism 4. By the rotation of the attaching shaft 32, the measurement sheet 33 fed outside the rotating plate 31 is collected.

The two attaching shafts 32 are provided on opposite sides with respect to a rotation axis R of the rotating plate 31. Each of the attaching shafts 32 is formed in a cylindrical shape extending along the X-axis direction.

The number of measurement sheets 33 housed in each sheet holding part 2061 may be one, or may be three or more.

The rotating plate 31 can be rotated around the rotation axis R by the drive mechanism 4. As the rotating plate 31 rotates 180°, each of the measurement sheets 33 moves between an installation position B1 where the measurement sheet 33 is installed and a measurement position B2 where the placed measurement sheet 33 is used for measurement. The measurement unit 60 is provided with a replacement port near the installation position B1. The measurement sheet 33 placed at the installation position B1 can be detached by a user. The user can replace a used measurement sheet 33 with a new one by attaching and detaching the measurement sheet 33 at the installation position B1 through the replacement port. At the measurement position B2, the measurement sheet 33 is fed by rotation of the attaching shaft 32 and used for sample measurement.

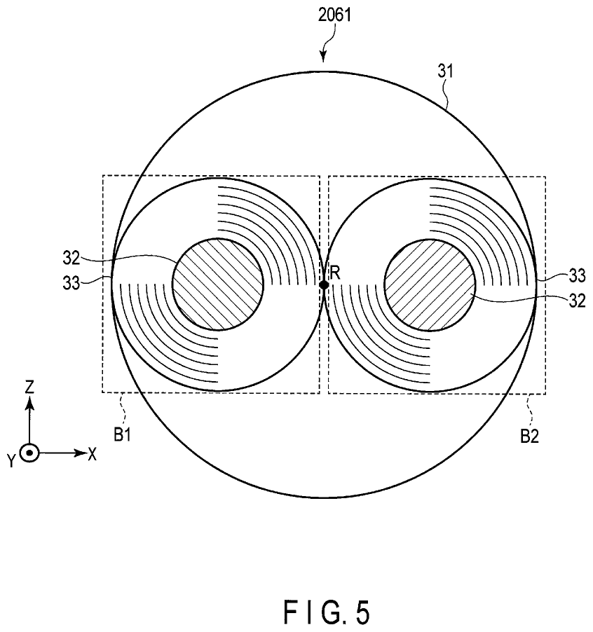

FIG. 5 is a diagram showing the rotating plate 31 rotated 180° from the state shown in FIG. 4. As the rotating plate 31 rotates 180° from the state shown in FIG. 4, the positions of the two measurement sheets 33 are swapped, i.e., the measurement sheet 33 at the measurement position B2 moves to the installation position B1 and the measurement sheet 33 at the installation position B1 moves to the measurement position B2, as shown in FIG. 5.

The display parts 2062A to 2062E shown in FIG. 3 display the state of use or replacement of the measurement sheets 33 in the corresponding sheet holding parts 2061. The display parts 2062A to 2062E are, for example, LEDs.

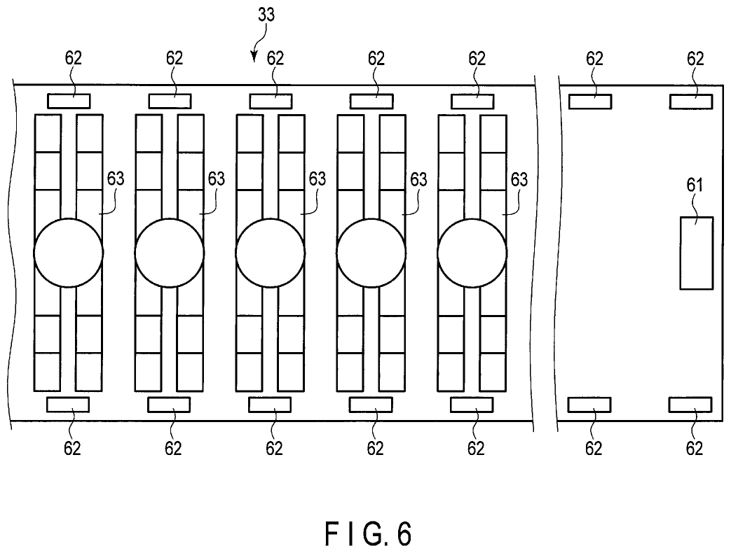

FIG. 6 is a diagram showing an example of a configuration of the measurement sheet 33. FIG. 6 shows an inward-facing side of the measurement sheet 33 as it is wrapped around the attaching shaft 32. As shown in FIG. 6, the measurement sheet 33 includes a first connection part 61, second connection parts 62, and item measurement parts 63.

The first connection part 61 is provided at a distal end portion of the measurement sheet 33. The first connection part 61 is formed in a shape that can engage a connection part 84 provided in a conveyor belt 83 to be described later.

A plurality of second connection parts 62 are provided at each of two ends of the measurement sheet 33 in the width direction of the measurement sheet 33. The second connection part 62 is connected to a feed mechanism 85 to be described later. The second connection part 62 is formed in a shape that can engage the feed mechanism 85. The second connection part 62 is, for example, a hole penetrating the measurement sheet 33.

A plurality of item measurement parts 63 are provided on the measurement sheet 33. The item measurement parts 63 are arranged at regular intervals along a longitudinal direction of the measurement sheet 33. The item measurement parts 63 are used for measurement according to a test item for a discharged sample. The item measurement part 63 is an example of a measurement part. The item measurement part 63 may also be referred to as a part to be measured.

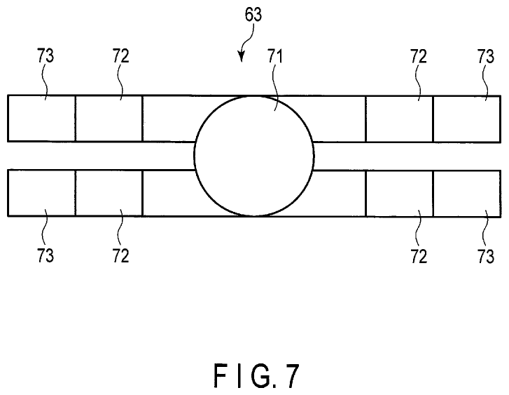

FIG. 7 is an enlarged view of one of the item measurement parts 63 shown in FIG. 6. The item measurement part 63 includes a dispensing section 71, a flow channel 72, and a measurement section 73. The flow channel 72 connects the measurement section 73 to the dispensing section 71.

FIG. 7 describes an example in which four flow channels 72 are connected to one dispensing section 71 and four measurement sections 73 respectively connected to the flow channels 72 are provided. It suffices that the number of measurement sections 73 provided in one item measurement part 63 is one or more. For example, there may be two, five or more. The number of flow channels 72 is equal to the number of measurement sections 73.

The dispensing section 71 opens outward on a front surface of the measurement sheet 33. In the dispensing section 71, an aspirated sample is discharged from the dispensing probe 205. The flow channel 72 is connected to each of the dispensing section 71 and the measurement section 73 inside the measurement sheet 33. In the flow channel 72, the sample dispensed in the dispensing section 71 automatically flows and is conveyed to the measurement section 73. The measurement section 73 opens outward on the front surface of the measurement sheet 33. In the measurement section 73, measurement is performed by a measuring device 88 to be described later on the sample conveyed through the flow channel 72.

In the case of a measurement sheet 33 for colorimetric measurement, each flow channel 72 provided in one measurement section 73 contains a different reagent. The reagent reacts with a given component contained in the sample. The measurement sheet 33 used for the colorimetric measurement may be referred to as a reagent sheet. The sample discharged into the dispensing section 71 flows naturally into the interior of the flow channel 72 by capillary action, and flows through the flow channel 72 to the measurement section 73. In this process, the sample and reagent react inside the flow channel 72. In the measurement section 73, a color change of the sample after reacting with the reagent is measured using the measuring device 88 to be described later. By placing a different reagent in each flow channel 72, four kinds of components can be measured using one item measurement part 63. The reagent may be contained in the measurement section 73 instead of the flow channel 72.

In the case of a measurement sheet 33 for electrode measurement, the sample discharged into the dispensing section 71 flows naturally into the interior of the flow channel 72 by capillary action, and flows through the flow channel 72 to the measurement section 73. In each measurement section 73, a specific electrolyte contained in the sample is measured using the measuring device 88 to be described later, which has an electrode that reacts with a given component contained in the sample and a reference electrode that serves as a reference. For example, if one item measurement part 63 is provided with four flow channels 72 and four measurement sections 73, one item measurement part 63 can be used to measure three electrolytes: sodium ions, potassium ions, and chloride ions.

For example, if ten sheet holding parts 2061 for colorimetric measurement are provided and each of the sheet holding parts 2061 can perform colorimetric measurement for four items, the entire measurement unit 206 can perform colorimetric measurement for 40 items. For example, if nine sheet holding parts 2061 for colorimetric measurement and one sheet holding part 2061 for electrode measurement are provided, and each of the sheet holding parts 2061 for colorimetric measurement can perform colorimetric measurement for four items and the sheet holding part 2061 for electrode measurement can perform electrode measurement for three items, the entire measurement unit 206 can perform colorimetric measurement for 36 items and electrode measurement for 3 items.

The measurement unit 206 further includes a conveyor mechanism 80. The conveyor mechanism 80 conveys the measurement sheet 33 attached to the attaching shaft 32 to the dispensing position where a sample is dispensed and to the measurement position where a sample measurement is performed. One conveyor mechanism 80 is provided for each of the sheet holding parts 2061.

FIG. 8 is a diagram showing a configuration of the conveyor mechanism 80. The conveyor mechanism 80 includes a first roller 81, a second roller 82, a conveyor belt 83, a connection part 84, a feed mechanism 85, and a constant temperature part 86.

The conveyor belt 83 is attached around the first roller 81 and the second roller 82. The first roller 81 and the second roller 82 can rotate around respective rotation axes parallel to each other.

The first roller 81 is arranged near an outer peripheral surface of the measurement sheet 33 attached at the measurement position. The second roller 82 is arranged lower than the first roller 81. The second roller 82 is provided farther from the rotating plate 31 than the first roller 81 in the X-axis direction. The conveyor belt 83 is thus inclined with respect to the vertical and horizontal directions between the first roller 81 and the second roller 82.

The connection part 84 is attached to an outer surface of the conveyor belt 83. The connection part 84 is formed in a shape that can be connected to the first connection part 61 of the measurement sheet 33. The connection between the first connection part 61 and the connection part 84 is realized, for example, by a hook structure or a hook-and-loop fastener structure.

The feed mechanism 85 is formed in a shape that can engage the second connection parts 62 of the measurement sheet 33. For example, the feed mechanism 85 is a gear that has a rotation axis parallel to the first roller 81 and the second roller 82 and whose teeth are inserted into the holes that are the second connection parts 62. For example, the feed mechanism 85 is provided inside the conveyor belt 83 and engages the second connection parts 62 of the measurement sheet 33 conveyed by the conveyor belt 83. As the feed mechanism 85 rotates while engaging the second connection parts 62 of the measurement sheet 33, the measurement sheet 33 is fed. The feed mechanism 85 may be attached to two outer sides of the conveyor belt 83 in the width direction of the conveyor belt 83. The feed mechanism 85 may be attached on the outer side of the conveyor belt 83. In this case, the gear teeth of the feed mechanism 85 are inserted into the second connection parts 62 of the measurement sheet 33 from the top side, thereby engaging the second connection parts 62 of the measurement sheet 33 and the feed mechanism 85.

The constant temperature part 86 is provided inside the conveyor belt 83. The constant temperature part 86 heats the measurement sheet 33 being conveyed on the conveyor belt 83 from the backside of the conveyor belt 83 to maintain it at a constant temperature.

The measurement unit 206 further includes a rail 87 and a measuring device 88. The measuring device 88 moves to the measurement position where a sample is measured and measures a material property value of the sample. One rail 87 and one measuring device 88 are provided for each of the sheet holding parts 2061.

The rail 87 is extended to face a portion of the conveyor belt 83 between the first roller 81 and the second roller 82. That is, the rail 87 is extended along a direction that is inclined with respect to the vertical and horizontal directions.

The measuring device 88 is attached to the rail 87 to face the conveyor belt 83. The measuring device 88 can move on the rail 87 by the drive mechanism 4. That is, the measuring device 88 can move in a direction inclined with respect to the vertical and horizontal directions. The measuring device 88 moves to a position facing the measurement section 73 where measurement is to be performed, and performs colorimetric measurement or electrode measurement. If colorimetric measurement is performed, for example, an imaging device capable of taking pictures of a color change of a sample that reacts with a reagent is used as the measuring device 88. If electrode measurement is performed, for example, a measuring device capable of measuring a potential of the measurement section 73 is used as the measuring device 88. The measuring device 88 may be movable to a discharging position P3 where the sample is dispensed from the dispensing probe 205.

The conveyor mechanism 80 further includes a sheet collection part 89. The sheet collection part 89 is installed below the first roller 81, the second roller 82, and the conveyor belt 83. In the sheet collection part 89, the measurement sheets 33 that have undergone measurement by the measuring device 88 are sequentially conveyed. The sheet collection part 89 temporarily holds the conveyed measurement sheets 33. The sheet collection part 89 is, for example, a collection box with an open top surface.

(Attaching Process of Measurement Sheet)

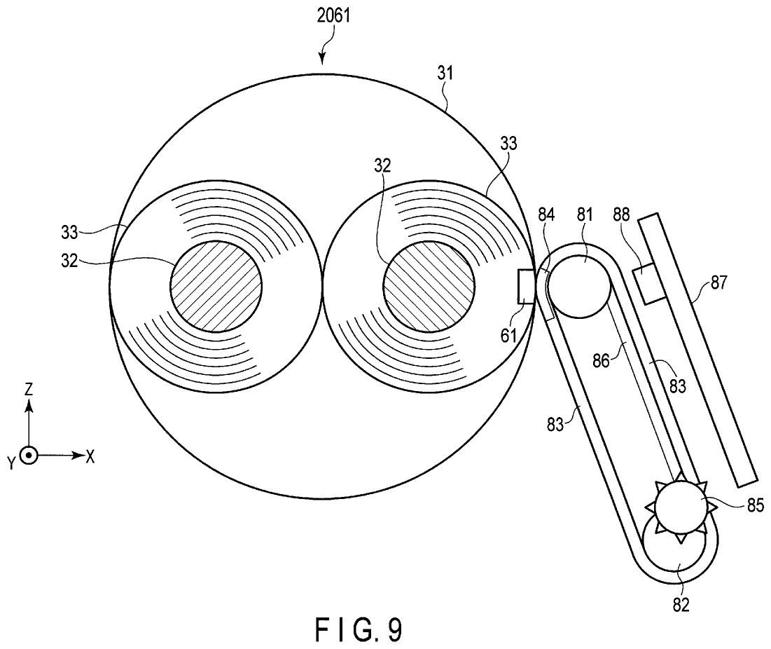

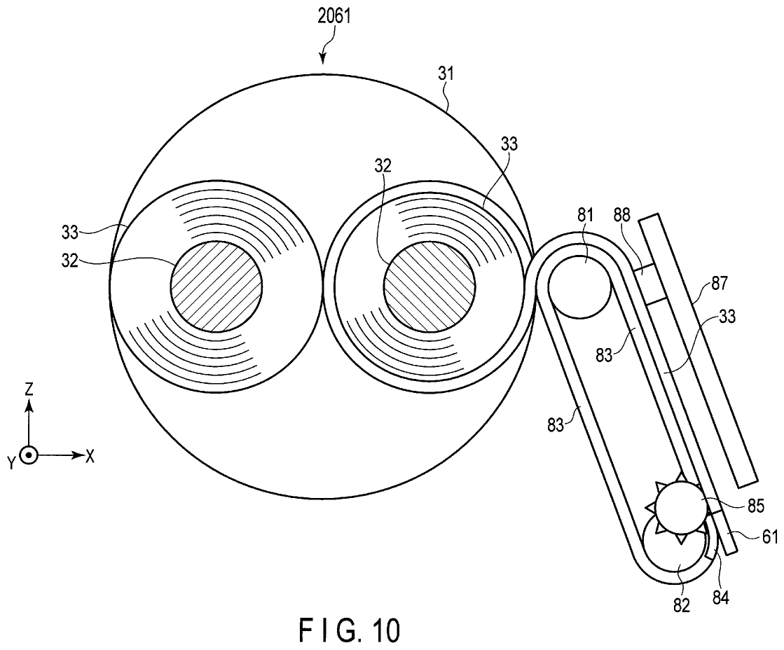

Next, a process of attaching a new measurement sheet 33 to the conveyor mechanism 80 will be described. FIGS. 9 and 10 are diagrams showing that the measurement sheet 33 is attached to the conveyor mechanism 80. To attach a new measurement sheet 33 to the conveyor mechanism 80, the user loads the new measurement sheet 33 into a sheet holding part 2061 to be used from a replacement port provided in the sheet holding part 2061. At this time, the measurement sheet 33 is attached to the attaching shaft 32 located at the installation position. Then, under the control of the control circuitry 9, the rotating plate 31 rotates 180° so that the new measurement sheet 33 moves to the measurement position.

Next, under the control of the control circuitry 9, the first connection part 61 provided at the distal end of the measurement sheet 33 placed at the measurement position is connected to the connection part 84 provided on the conveyor belt 83 of the conveyor mechanism 80. FIG. 9 is a diagram showing connection between the first connection part 61 of the measurement sheet 33 and the connection part 84 of the conveyor belt 83.

Next, the first roller 81 and the second roller 82 are driven under the control of the control circuitry 9, causing the conveyor belt 83 to rotate in the conveyance direction. Since the conveyor belt 83 and the measurement sheet 33 are connected together, as the conveyor belt 83 rotates, the first connection part 61 connected to the connection part 84 is pulled along the conveyance direction, and the measurement sheet 33 is fed along the conveyance direction.

FIG. 10 is a diagram showing a state in which the distal end portion of the measurement sheet 33 has reached a position where the feed mechanism 85 is arranged. As the distal end portion of the measurement sheet 33 reaches the position where the feed mechanism 85 is located, the rotation of the first roller 81 and the second roller 82 stops under the control of the control circuitry 9, thereby stopping the rotation of the conveyor belt 83. This completes the process of attaching the measurement sheet 33 to the conveyor mechanism 80. In the state where the distal end portion of the measurement sheet 33 reaches the position where the feed mechanism 85 is arranged, the gear of the feed mechanism 85 is engaged with the holes of the second connection parts 62 of the measurement sheet 33. In this state, the measurement sheet 33 and the feed mechanism 85 are engaged, so the measurement sheet 33 can be conveyed by rotating the feed mechanism 85.

(Measurement Process)

Next, a process of performing a sample measurement using the measurement sheet 33 attached to the conveyor mechanism 80 will be described.

In the process of performing a sample measurement, the control circuitry 9 executes automatic conveyance processing. The automatic conveyance processing is processing that automatically measures material properties of a sample contained in the sample rack 201. FIG. 11 is a flowchart showing an example of a procedure of the automatic conveyance processing. The processing procedure in each processing described below is only an example, and each processing can be changed as appropriate where possible. Further, with respect to the processing procedure described below, steps can be omitted, replaced, and added as appropriate according to the embodiment. The above explanation about the processing procedure in each processing also applies to each of the following embodiments and modifications.

(Automatic Conveyance Processing)

(Step S101)

The control circuitry 9 sequentially conveys the sample rack 201 containing a sample to be measured from the rack loading part 202 to the first aspirating position P1.

(Step S102)

The control circuitry 9 aspirates the sample contained in the sample rack 201 conveyed to the first aspirating position P1, and starts a measurement process on the aspirated sample. The measurement process is a process of measuring a material property value of a sample by the measurement unit 206. Detailed processing of the measurement process will be described later.

(Step S103)

When the measurement process is started, the control circuitry 9 conveys the sample rack 201, from which the sample has been aspirated, to the during-measurement rack standby part 208. The conveyed sample rack 201 stands by in the during-measurement rack standby part 208 until the measurement by the measurement unit 206 is completed.

(Step S104)

When the measurement by the measurement unit 206 is completed, the control circuitry 9 acquires a measurement result from the measurement unit 206 and determines whether or not remeasurement of the sample is necessary based on the acquired measurement result. For example, if a measured value obtained as a measurement result is out of a normal range, the control circuitry 9 determines that the sample measurement was not completed normally and that remeasurement of the sample is necessary (Yes in step S104). In this case, the process proceeds to step S105. On the other hand, if the measured value obtained as a measurement result is within the normal range, the control circuitry 9 determines that the sample measurement has been completed successfully and that remeasurement of the sample is unnecessary (No in step S104). In this case, the process proceeds to step S106.

(Step S105)

If it is determined that remeasurement of the sample is necessary in the process of step S104, the control circuitry 9 conveys the sample rack 201 for which remeasurement of the sample is determined to be necessary from the during-measurement rack standby part 208 to the second aspirating position P2.

The process then returns to step S102, where the sample contained in the sample rack 201 conveyed to the second aspirating position P2 is aspirated, and a measurement process is started on the aspirated sample. Then, the processes of steps S102 to S104 are repeated until it is determined that remeasurement is unnecessary in the process of step S203.

(Step S106)

If it is determined that remeasurement of the sample is unnecessary in the process of step S104, the control circuitry 9, with the system control function 91, conveys the sample rack 201 for which remeasurement of the sample is determined to be unnecessary from the during-measurement rack standby part 208 to the rack storage part 210.

The sample rack 201 conveyed to the rack storage part 210 is collected by the user via the rack collection part 211.

(Measurement Process)

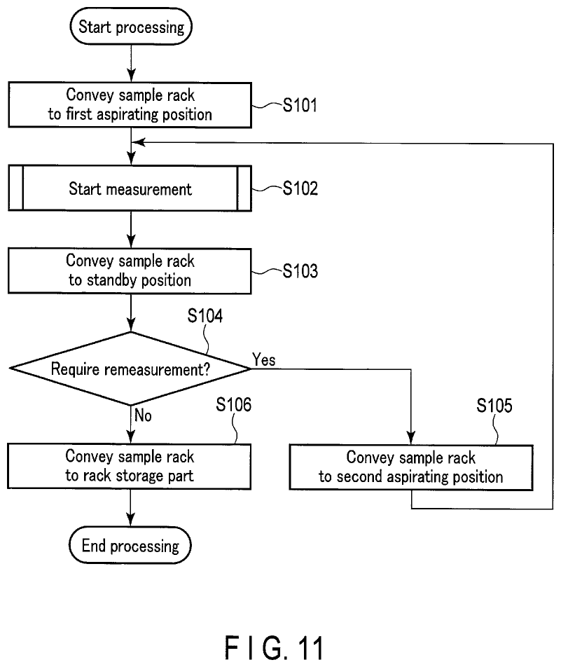

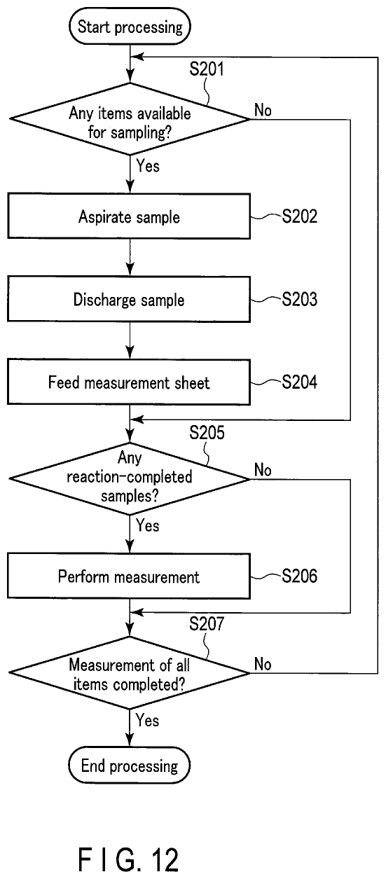

Next, an operation of the measurement process performed in step S102 of the automatic conveyance processing will be described in detail. FIG. 12 is a flowchart showing an example of a procedure of the measurement process.

(Step S201)

In the process of step S101, as the sample rack 201 is conveyed to the first aspirating position P1, the control circuitry 9 determines whether or not there is any item available for sampling. Specifically, the control circuitry 9 determines whether or not there is any item available for sampling by determining whether or not there is any item measurement part 63 to which the sample has not been discharged, among item measurement parts 63 preset for the sample contained in the sample rack 201 conveyed to the first aspirating position P1. If there is an item available for sampling (Yes in step S201), the process proceeds to step S202. If there is no item available for sampling (No in step S201), the process proceeds to step S205.

(Step S202)

Under the control of the control circuitry 9, the dispensing probe 205 aspirates a predetermined amount of the sample from the sample rack 201 placed at the first aspirating position P1.

(Step S203)

Next, the dispensing probe 205 moves to the sheet holding part 2061 where measurement is to be performed, under the control of the control circuitry 9. After that, the dispensing probe 205 discharges the aspirated sample at the discharging position P3, under the control of the control circuitry 9.

(Step S204)

When the sample is discharged to the item measurement part 63 at the discharging position P3, the control circuitry 9 feeds the measurement sheet 33 for one cycle by rotating the feed mechanism 85 for one cycle. That is, the control circuitry 9 feeds the measurement sheet 33 for one cycle each time the sample is dispensed onto the measurement sheet 33. As the measurement sheet 33 is fed for one cycle, each item measurement part 63 of the measurement sheet 33 moves by a predetermined amount in the conveyance direction of the measurement sheet 33. At this time, the item measurement part 63 to which the sample was discharged at the discharging position P3 moves to a position away from the discharging position P3, and a dispensing section 71 of an item measurement part 63 adjacent to the item measurement part 63 that was placed at the discharging position P3 is newly placed at the discharging position P3. Each time the measurement sheet 33 is fed for one cycle, a portion of the measurement sheet 33 where the measurement has been completed is sequentially conveyed to the sheet collection part 89. Inside the item measurement part 63 to which the sample is discharged, the sample discharged into the dispensing section 71 is conveyed through the flow channel 72 to the measurement section 73, where a reaction between the sample and a reagent occurs.

(Step S205)

Next, the control circuitry 9 determines whether or not there is any sample whose reaction has been completed. Specifically, the control circuitry 9 determines whether or not there is any item measurement part 63 in which a reaction has been completed in a measurement section 73. At this time, the control circuitry 9, for example, determines whether or not the sample reaction has been completed for each of the item measurement parts 63 by measuring a time elapsed since the sample was discharged for each of the item measurement parts 63. If there is a reaction-completed sample (Yes in step S205), the process proceeds to step S206. If there is no reaction-completed sample (No in step S205), the process proceeds to step S207.

(Step S206)

If there is a reaction-completed sample (Yes in step S205), measurement of the measurement sheet 33 by the measuring device 88 is executed under the control of the control circuitry 9, and a sample measurement is performed for the item measurement part 63 in which the reaction has been completed. For example, electrode measurement or colorimetric measurement is performed as the sample measurement.

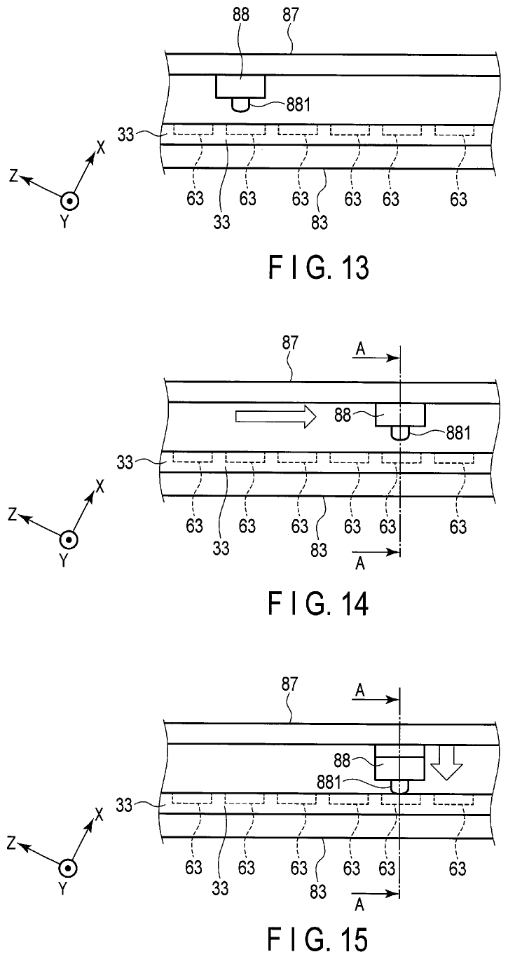

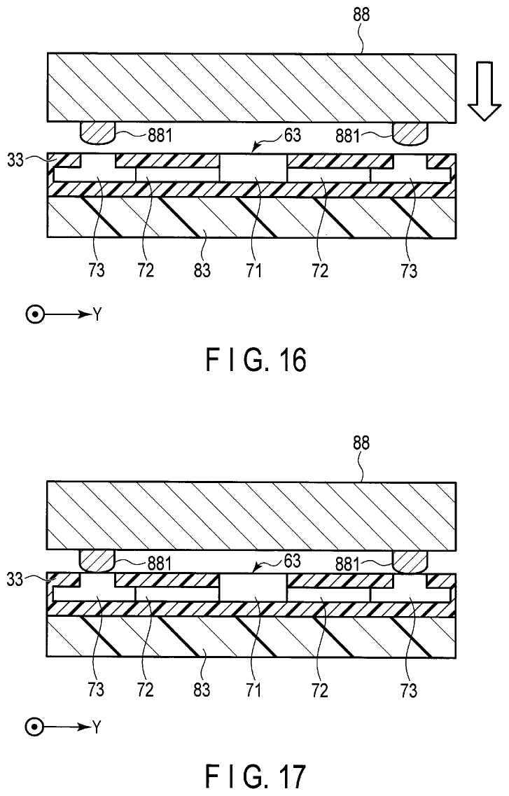

Here, a description will be given of a case in which the electrode measurement is performed by the measuring device 88. FIGS. 13 to 17 show that the electrode measurement is performed by the measuring device 88. FIGS. 13 to 15 are diagrams showing surroundings of the measuring device 88 shown in FIG. 8, as viewed from the front side of the paper. FIG. 16 is a cross-sectional view taken along line A-A in FIG. 14, and FIG. 17 is a cross-sectional view taken along line A-A in FIG. 15. FIGS. 16 and 17 are diagrams showing cross sections that intersect with the conveyance direction of the measurement sheet 33 and the moving direction of the measuring device 88.

The measuring device 88 that performs the electrode measurement includes a connection part 881 on a surface facing the measurement sheet 33 that is conveyed on the conveyor belt 83. The connection part 881 includes one reference electrode and one or more ion-selective electrodes (ISE). Each ion-selective electrode changes in potential according to an amount of a specific component contained in a sample. Specifically, each ion-selective electrode has a sensitive membrane that selectively detects a particular electrolyte. Here, a description will be given of an example in which three ion-selective electrodes are provided to detect sodium ions, potassium ions, and chlorine ions, respectively.

The measuring device 88 can be moved toward or away from the conveyor belt 83 by the drive mechanism 4. As the measuring device 88 approaches the conveyor belt 83, the connection part 881 approaches the measurement sheet 33 placed on the conveyor belt 83. As the measuring device 88 moves away from the conveyor belt 83, the connection part 881 moves away from the measurement sheet 33 placed on the conveyor belt 83.

As shown in FIGS. 13, 14, and 16, when performing the electrode measurement, the measuring device 88 first moves to a position facing the item measurement part 63 in which the reaction has been completed, under the control of the control circuitry 9. Next, as shown in FIGS. 15 and 17, under the control of the control circuitry 9, the measuring device 88 moves in the direction of approaching the measurement sheet 33 placed on the conveyor belt 83, and the connection part 881 is connected to a target measurement section 73. Upon connection of the connection part 881 to the target measurement section 73, each ion-selective electrode and the reference electrode are connected to the item measurement part 63. The measuring device 88 measures a voltage of each ion-selective electrode and a voltage of the reference electrode, and calculates a potential between each ion-selective electrode and the reference electrode. The measuring device 88 then outputs the measured data to the analysis circuitry 3 as standard data or subject data. Then, for example, sodium ions, potassium ions, and chlorine ions contained in the sample are detected. If a constant temperature part 86 is provided on the conveyor belt 83, the measuring device 88 preferably stands by at a position unaffected by the constant temperature part 86 when not performing measurement.

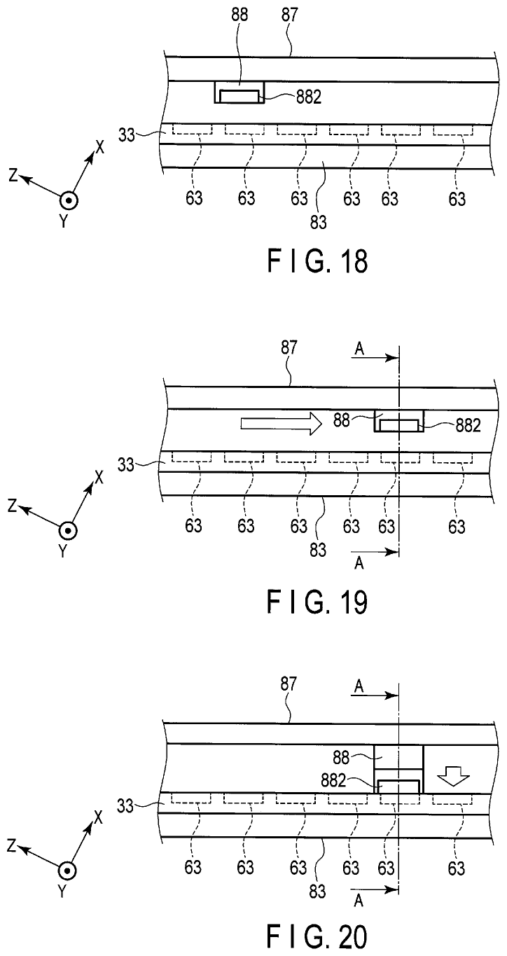

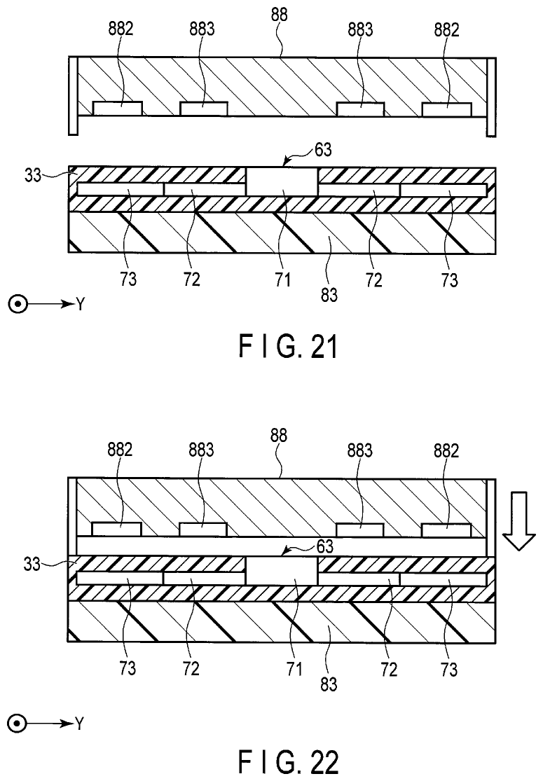

Next, a description will be given of a case in which colorimetric measurement is performed by the measuring device 88. FIGS. 18 to 22 are diagrams showing colorimetric measurement being performed by the measuring device 88. FIGS. 18 to 20 are diagrams showing surroundings of the measuring device 88 shown in FIG. 8, as viewed from the front side of the paper. FIG. 21 is a cross-sectional view taken along line A-A in FIG. 19, and FIG. 22 is a cross-sectional view taken along line A-A in FIG. 20. FIGS. 21 and 22 are diagrams showing cross sections that intersect with the conveyance direction of the measurement sheet 33 and the moving direction of the measuring device 88.

The measuring device 88 that performs the colorimetric measurement includes an imaging part 882 and an illumination part 883 on the surface facing the measurement sheet 33 conveyed on the conveyor belt 83. The imaging part 882 takes images of an opposing item measurement part 63. The imaging part 882 is, for example, a camera. The illumination part 883 irradiates each measurement section 73 of the opposing item measurement part 63 with light to facilitate imaging by the imaging part 882.

The measuring device 88 can be moved toward or away from the conveyor belt 83 by the drive mechanism 4. As the measuring device 88 approaches the conveyor belt 83, the imaging part 882 and the illumination part 883 approach the measurement sheet 33 placed on the conveyor belt 83. As the measuring device 88 moves away from the conveyor belt 83, the imaging part 882 and the illumination part 883 move away from the measurement sheet 33 placed on the conveyor belt 83.

As shown in FIGS. 18, 19, and 21, when performing colorimetric measurement, the measuring device 88 first moves to a position facing the item measurement part 63 in which the reaction has been completed, under the control of the control circuitry 9. Next, as shown in FIGS. 20 and 22, the measuring device 88 moves in the direction of approaching the measurement sheet 33 placed on the conveyor belt 83, under the control of the control circuitry 9. The imaging part 882 measures a color change in the measurement section 73 under the control of the control circuitry 9. The measuring device 88 then generates standard data and subject data including a measurement result, and transmits the generated standard data and subject data to the analysis circuitry 3. If a constant temperature part 86 is provided on the conveyor belt 83, the measuring device 88 preferably stands by at a position unaffected by the constant temperature part 86 when not performing measurement.

(Step S207)

Upon completion of the measurement of the item measurement part 63 in the process of step S206, the control circuitry 9 determines whether or not measurement of all preset items has been completed. At this time, if measurement of all of the preset item measurement parts 63 has been completed (Yes in step S207), the control circuitry 9 determines that measurement of all of the measurement items has been completed. In this case, the process proceeds to step S208.

On the other hand, if there are any items that have not been measured among the item measurement parts 63 to be measured (No in step S207), the control circuitry 9 determines that measurement has not been completed yet for all of the measurement items. In this case, the process returns to step S201, and the processes of steps S201 to S207 are repeated until measurement is performed in all of the item measurement parts 63 in which measurement is to be performed. Upon completion of measurement of all of the present measurement items, the control circuitry 9 ends the measurement process.

Here, a method in which, upon completion of a reaction of a sample discharged to the measurement sheet 33, the measuring device 88 is moved to the item measurement part 63 in which the reaction has been completed to perform measurement has been described, but the method is not limited thereto. For example, the measuring device 88 may be pre-moved before the sample reaction is completed, or the measuring device 88 may be pre-moved to a position where an item measurement part 63 to which a sample is discharged moves by feeding of the measurement sheet 33 before sampling of the sample is performed.

(Measurement Sheet Removal Process)

Next, a process of removing the measurement sheet 33 from the conveyor mechanism 80 will be described. For example, the process of removing the measurement sheet 33 from the conveyor mechanism 80 is executed in a case where all item measurement parts 63 provided on the measurement sheet 33 are used, where a usage period of the measurement sheet 33 expires, where an error related to the measurement sheet 33 occurs, where an instruction to collect the measurement sheet 33 is input by the user, or the like. Here, as an example, a case in which a measurement sheet 33 used to the end is removed and replaced with a new measurement sheet 33 will be described.

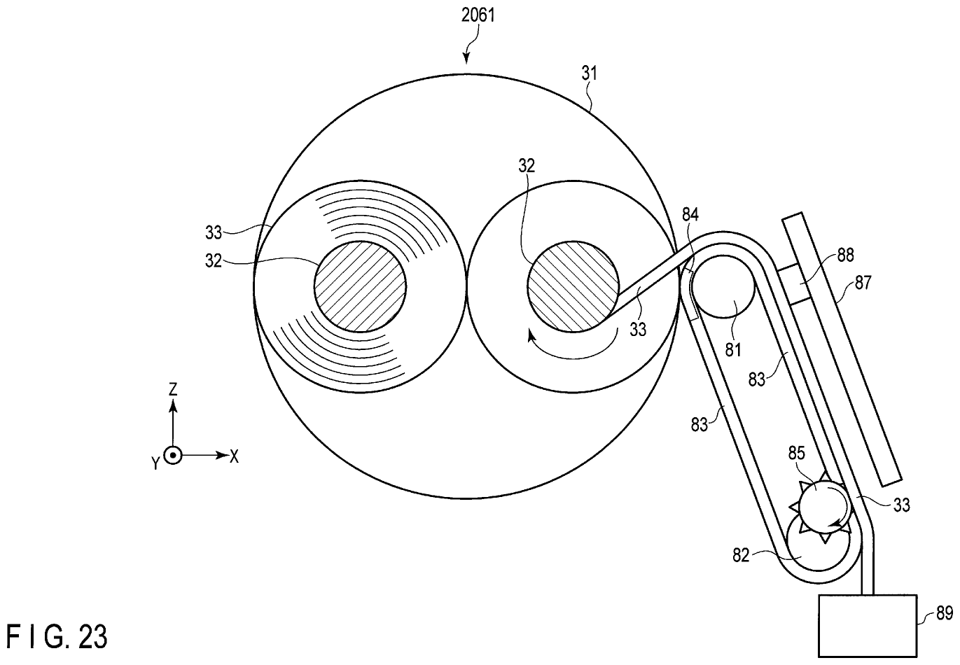

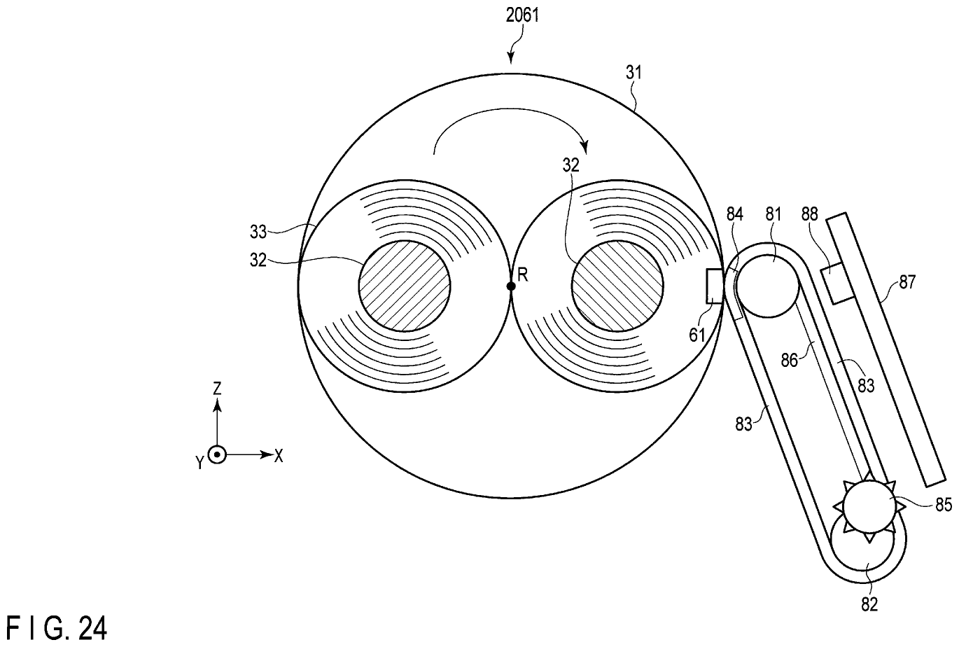

FIG. 23 is a diagram showing a state in which the measurement sheet 33 has been used to the end. When removing the measurement sheet 33 used to the end, the control circuitry 9 rotates the attaching shaft 32 in a direction opposite to that when using the measurement sheet 33. As a result, the measurement sheet 33 held in the sheet collection part 89 is conveyed on the conveyor belt 83 in the conveyance direction, and is rewound around the measurement sheet 33. In this way, the used measurement sheet 33 is collected onto the attaching shaft 32 placed at the measurement position. FIG. 24 is a diagram showing a state in which the used measurement sheet 33 is collected onto the attaching shaft 32 placed at the measurement position.

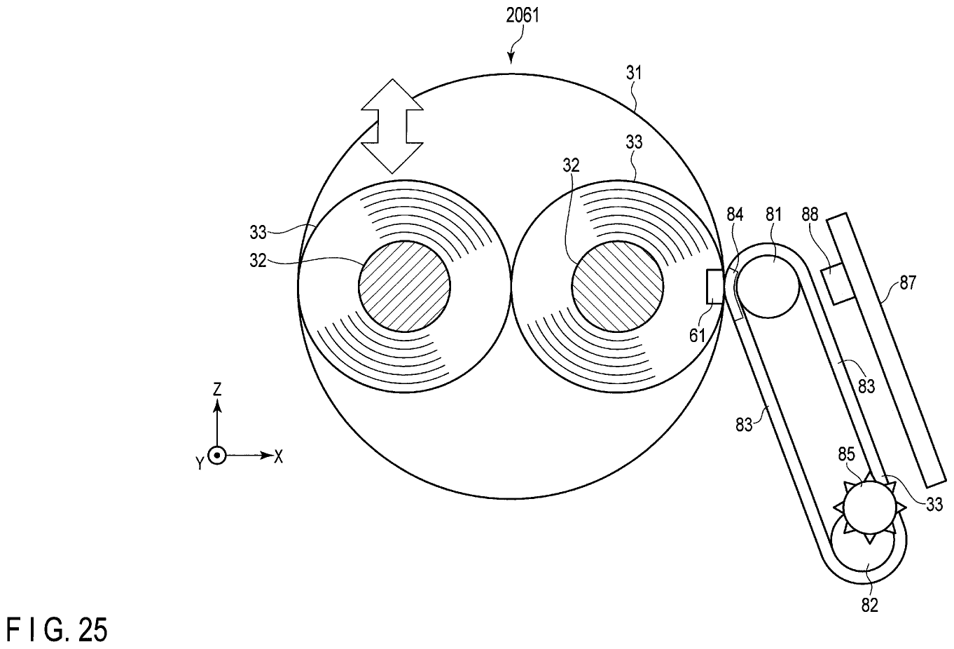

Next, under the control of the control circuitry 9, the rotating plate 31 rotates 180°, causing the used measurement sheet 33 to move from the measurement position to the installation position. At this time, if a new measurement sheet 33 is installed at the installation position, the new measurement sheet 33 moves from the installation position to the measurement position at the same time as the used measurement sheet 33 moves from the measurement position to the installation position. FIG. 25 is a diagram showing a state in which the used measurement sheet 33 has moved to the installation position. The user can remove the used measurement sheet 33 from the replacement port provided in the sheet holding part 2061.

(Status Display Processing)

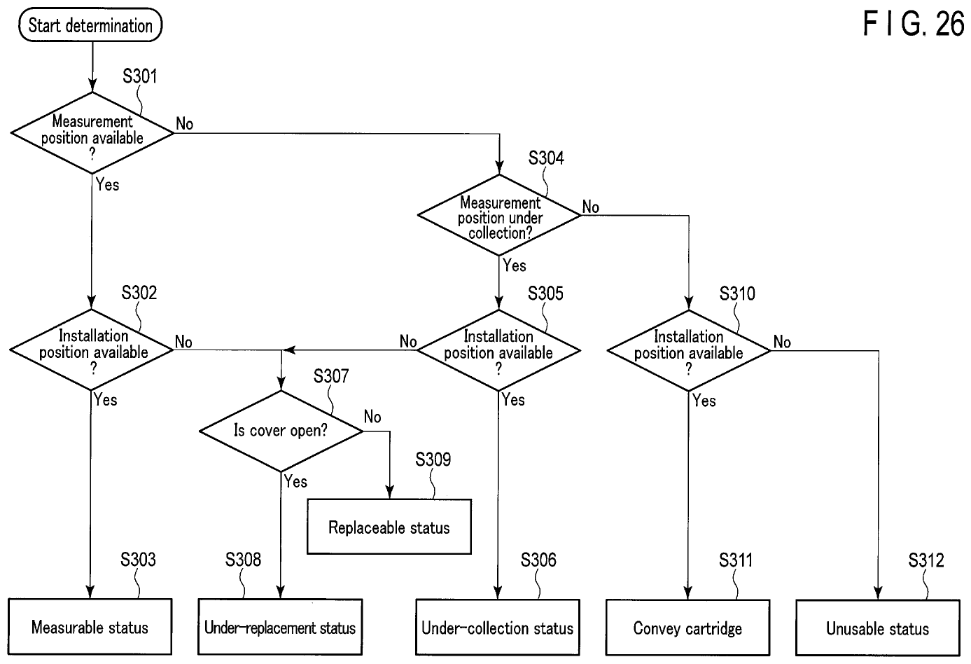

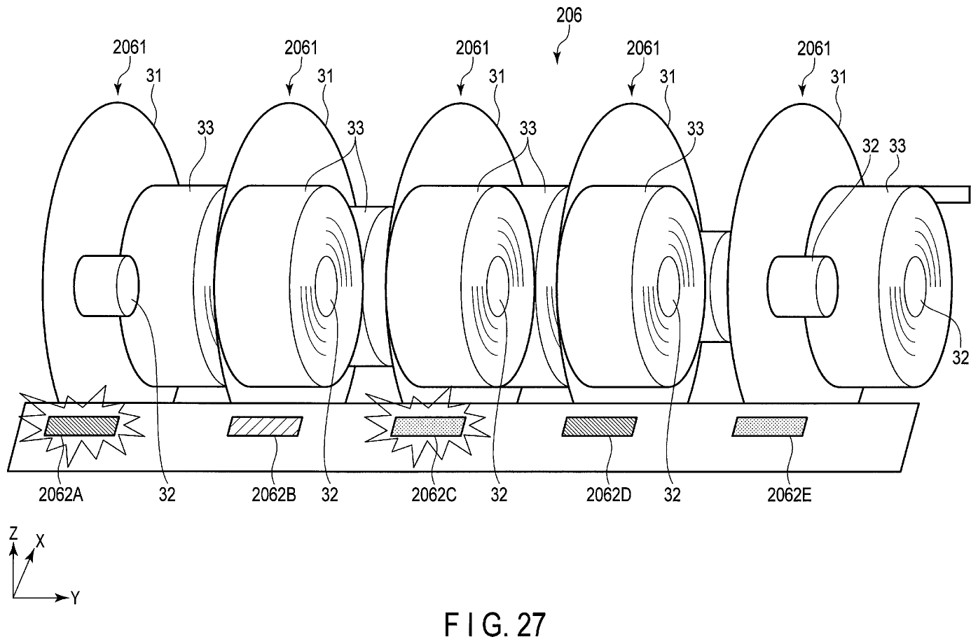

Next, status display processing performed by the control circuitry 9 will be described. The status display processing is processing of, for each of the sheet holding parts 2061, determining a status related to a current state of use or replacement of a measurement sheet 33 and displaying a determination result. FIG. 26 is a flowchart showing an example of a procedure of the status display processing. FIG. 27 is a diagram showing that states of use or replacement of measurement sheets 33 are displayed.

(Status Display Processing)

(Step S301)

The control circuitry 9 determines whether or not the measurement position of the sheet holding part 2061 is available for use. Specifically, the control circuitry 9 determines whether or not the measurement sheet 33 placed at the measurement position is usable. For example, if there is an adequate measurement sheet 33 placed at the measurement position remaining, the control circuitry 9 determines that the measurement sheet 33 is usable. For example, if the measurement sheet 33 placed at the measurement position has been used to the end, the control circuitry 9 determines that the measurement sheet 33 placed at the measurement position is unusable.

(Step S302)

If the measurement sheet 33 placed at the measurement position is usable (Yes in step S301), the control circuitry 9 determines whether or not the installation position is available for use. Specifically, the control circuitry 9 determines whether or not replacement of the measurement sheet 33 placed at the installation position is necessary. For example, if an unused measurement sheet 33 is placed at the installation position, the control circuitry 9 determines that the measurement sheet 33 placed at the installation position is usable. For example, if a used measurement sheet 33 is placed at the installation position, the control circuitry 9 determines that the measurement sheet 33 placed at the installation position is unusable.

(Step S303)

If the measurement sheet 33 placed at the installation position is usable (Yes in step S302), the control circuitry 9 determines that replacement of the measurement sheet 33 placed at the installation position is unnecessary. In this case, the control circuitry 9 causes a corresponding display part to display that the measurement sheet 33 placed at the measurement position is usable. For example, the control circuitry 9 lights the corresponding display part in green. A display part 2062B shown in FIG. 27 is an example of a display part that indicates that the measurement sheet 33 placed at the measurement position is usable.

(Step S304)

If the measurement sheet 33 placed at the measurement position is unusable (No in step S301), the control circuitry 9 determines whether or not the measurement position is under collection. Specifically, the control circuitry 9 determines whether or not the measurement sheet 33 placed at the measurement position is being collected. For example, if the measurement sheet 33 placed at the measurement position is rotating, the control circuitry 9 determines that the measurement sheet 33 placed at the measurement position is being collected. For example, if the attaching shaft 32 holding the measurement sheet 33 placed at the measurement position is not rotating, the control circuitry 9 determines that the collection of the measurement sheet 33 placed at the measurement position has been completed.

(Step S305)

If the measurement sheet 33 placed at the measurement position is being collected (Yes in step S304), the control circuitry 9 determines whether or not the installation position is available for use. For example, the control circuitry 9 determines whether or not the installation position is available in the same manner as the process of step S302.

(Step S306)

If the measurement sheet 33 placed at the installation position is usable (Yes in step S305), the control circuitry 9 determines that replacement of the measurement sheet 33 placed at the installation position is unnecessary. In this case, the control circuitry 9 causes the corresponding display part to display that the measurement sheet 33 placed at the measurement position is being collected. For example, the control circuitry 9 lights the corresponding display part in red. A display part 2062D shown in FIG. 27 is an example of a display part indicating that the measurement sheet 33 placed at the measurement position is being collected. If replacement of the measurement sheet 33 is unnecessary, a cover provided for replacing the measurement sheet 33 placed at the installation position may be locked so that it cannot be opened.

(Step S307)

If the measurement sheet 33 placed at the installation position is unusable (No in step S302 or No in step S305), the control circuitry 9 determines that replacement of the measurement sheet 33 placed at the installation position is necessary. In this case, the control circuitry 9 determines whether or not the cover provided for replacing the measurement sheet 33 placed at the installation position is open.

(Step S308)

If the cover is open (Yes in step S307), the control circuitry 9 determines that the measurement sheet 33 placed at the installation position is being replaced. In this case, the control circuitry 9 causes the corresponding display part to display that the measurement sheet 33 placed at the installation position is being replaced. For example, the control circuitry 9 lights the corresponding display part in orange. A display part 2062E shown in FIG. 27 is an example of a display part that indicates that the measurement sheet 33 is being replaced.

(Step S309)

If the cover is closed (No in step S307), the control circuitry 9 determines that the measurement sheet 33 placed at the installation position is not being replaced. In this case, the control circuitry 9 causes the corresponding display part to display that replacement of the measurement sheet 33 placed at the installation position is possible. For example, the control circuitry 9 lights the corresponding display part in orange. A display part 2062C shown in FIG. 27 is an example of a display part indicating that the measurement sheet 33 placed at the installation position can be replaced.

(Step S310)

If collection of the measurement sheet 33 placed at the measurement position has been completed (No in step S304), the control circuitry 9 determines whether or not the installation position is available for use. For example, the control circuitry 9 determines whether or not the installation position is available in the same manner as the process of step S302.

(Step S311)

If the measurement sheet 33 placed at the installation position is usable (Yes in step S310), the control circuitry 9 determines that replacement of the measurement sheet 33 placed at the installation position is unnecessary. In this case, the control circuitry 9 determines that collection of the measurement sheet 33 placed at the measurement position has been completed and that replacement of the measurement sheet 33 placed at the installation position is unnecessary, and conveys the measurement sheets 33 in the corresponding sheet holding part 2061. Specifically, the control circuitry 9 rotates the rotating plate 31 of the corresponding sheet holding part 2061 by 180°. This causes the collected used measurement sheet 33 to move from the measurement position to the installation position and a new measurement sheet 33 to move from the installation position to the measurement position.

(Step S312)

If the measurement sheet 33 placed at the installation position is unusable (No in step S310), the control circuitry 9 determines that replacement of the measurement sheet 33 placed at the installation position is necessary. In this case, the control circuitry 9 causes the corresponding display part to display that both of the measurement sheet 33 placed at the measurement position and the measurement sheet 33 placed at the installation position are unusable. For example, the control circuitry 9 lights the corresponding display part in red. A display part 2062A shown in FIG. 27 is an example of a display part indicating that both of the measurement sheet 33 placed at the measurement position and the measurement sheet 33 placed at the installation position are unusable.

In the following description, an advantageous effect of the automatic analyzer 1 according to the present embodiment will be described.

The automatic analyzer 1 according to the present embodiment includes the roll-shaped measurement sheet 33, the conveyor mechanism 80, and the measuring device 88. The measurement sheet 33 includes the measurement section 73 where a sample dispensed at the discharging position P3 is measured. The conveyor mechanism 80 conveys the measurement sheet 33 to the discharging position P3 and the measurement position where a sample measurement is performed. The measuring device 88 moves to the measurement position and measures a material property value of the sample. The conveyor mechanism 80 is an example of a conveying means and a sheet conveyor mechanism, and the measuring device 88 is an example of a measuring means and a measurement mechanism.

For example, the measurement sheet 33 includes a plurality of item measurement parts 63. Each of the item measurement parts 63 includes the dispensing section 71 into which a sample is dispensed, the flow channel 72 through which the sample dispensed into the dispensing section 71 automatically flows, and the measurement section 73. In the measurement section 73, measurement is performed by the measuring device 88 for a sample conveyed through the flow channel 72.

With the above configuration, according to the automatic analyzer 1 of the present embodiment, measurement is performed using a paper-based measurement sheet 33 so that the measurement sheet 33 can be made thin, lightweight, and inexpensive. By using the measurement sheet 33, even if biological substances adhere to the measurement sheet 33, it can be safely disposed of by incinerating the measurement sheet 33. When a sample is dropped onto the paper, the sample flows naturally through the flow channel by capillary action, thus eliminating the need for an external device such as a pump and downsizing the device. Besides, using a measurement sheet 33 with a paper disposable after use as a substrate can omit a washing mechanism, etc. of a reaction tube and downsize the device as compared to a case of using a reaction tube that is reused after use, etc.

In addition, the measuring device 88 is independently movable relative to the conveyor mechanism 80. Thus, a sample measurement can be efficiently performed by causing the measuring device 88 to move to a position above a measurement section 73 in which a sample reaction is completed to perform measurement.

Further, the measuring device 88 moves to a position that enables measurement on a reaction-completed sample, and performs sample measurement in order of reaction completion.

If the measuring device 88 is fixed, even if there is no sample to perform measurement next, it is necessary to further feed the measurement sheet 33 in order to convey a measurement section 73 to which a sample is dispensed to the measurement position. In this case, until a measurement section 73 to which a sample was discharged the last time reaches the measurement position, the measurement sheet 33 is fed without the sample being dispensed to a measurement section 73 at the discharging position P3. This results in an unused measurement section 73 in a fed portion of the measurement sheet 33, increasing an amount of waste.

On the other hand, according to the automatic analyzer 1 of the present embodiment, if there is no sample to be measured next, the measuring device 88 is moved to perform measurement with the feeding of the measurement sheet 33 stopped so that measurement can be performed in order starting from a measurement section 73 in which a reaction is completed. This eliminates a need to feed the measurement sheet 33 with the measurement section 73 unused, allowing the measurement section 73 of the measurement sheet 33 to be used without waste, thereby reducing waste.

The conveyor mechanism 80 feeds the measurement sheet 33 each time measurement is performed by the measuring device 88. In a case where measurement is performed by the measuring device 88 at predetermined time intervals, the conveyor mechanism 80 may feed the measurement sheet 33 at the predetermined time intervals.

With the above configuration, according to the automatic analyzer 1 of the present embodiment, sample measurement is performed consecutively.

In addition, electrode measurement can be performed using the measurement sheet 33. In this case, the measuring device 88 includes an electrode that changes in potential according to an amount of a specific component contained in a sample. For example, an ion-selective electrode (ISE) is used as an electrode, and the automatic analyzer 1 detects a concentration of electrolyte contained in a sample by measuring a potential of the ion-selective electrode.

In electrode measurement using a reaction tube, a potential of a calibration liquid needs to be measured between one measurement and the next. This reduces throughput of the measurement. On the other hand, according to the automatic analyzer 1 of the present embodiment, measurement is performed using the measurement sheet 33 so the potential of a calibration liquid does not need to be measured. This improves throughput in the case of performing the electrode measurement consecutively.

Further, colorimetric measurement can be performed using the measurement sheet 33. In this case, the measurement sheet 33 contains a reagent and causes a dispensed sample to react with the reagent. The measuring device 88 measures a change in color of the sample that reacts with the reagent.

The above configuration eliminates the need for a reagent depository, a reagent bottle, a stirring unit to stir a mixture liquid of a reagent and a sample, a probe for dispensing a reagent (hereinafter referred to as a reagent probe), a washing mechanism for washing the reagent probe, etc., because the measurement is performed using the measurement sheet 33 with a reagent encapsulated inside. This allows the device to be downsized and lowers manufacturing costs of the device.

In addition, according to the automatic analyzer 1 of the present embodiment, since no reagent probe is used, carryover of a reagent in a reagent probe does not occur. Thus, throughput when performing consecutive measurement is increased because there is no need to wash a reagent probe between measurement.

The conveyor mechanism 80 further includes the constant temperature part 86 that maintains the measurement sheet 33 at a constant temperature. This configuration allows a sample discharged onto the measurement sheet 33 to be maintained at a constant temperature from the time the sample is discharged onto the measurement sheet 33 until measurement is performed by the measuring device 88.

The automatic analyzer 1 further includes the sheet holding part 2061 that holds the measurement sheet 33. The sheet holding part 2061 also collects the measurement sheet 33 that has been fed. For example, by rotating the attaching shaft 32, to which the measurement sheet 33 is fixed, in a direction opposite to when the measurement sheet 33 is fed, the fed measurement sheet 33 can be collected to the sheet holding part 2061 by rewinding it.

With the above configuration, a measurement sheet 33 to be disposed of is automatically collected to the sheet holding part 2061, thereby reducing the time and effort required for the user to collect the measurement sheet 33 to be disposed of. It also reduces a risk of infection when the user collects the measurement sheet 33 to be disposed of.

The sheet holding part 2061 has the installation position B1 where the measurement sheet 33 is installed and the measurement position B2 where the placed measurement sheet 33 is used for measurement, and moves the measurement sheet 33 between the installation position B1 and the measurement position B2. For example, by rotating the rotating plate 31 around the rotation axis R, the measurement sheet 33 attached to the rotating plate 31 can be moved between the installation position B1 and the measurement position B2.

The measurement sheet 33 installed at the installation position B1 can be detached by the user. For example, the user can replace the used measurement sheet 33 installed at the installation position B1 with a new measurement sheet 33.

Without the installation position B1, in a case where the measurement sheet 33 is used to the end, the next measurement cannot be performed until the user replaces the used measurement sheet 33 with a new measurement sheet 33.

On the other hand, in the present embodiment, in a case where the measurement sheet 33 is used to the end, measurement using the new measurement sheet 33 can be automatically resumed by moving the new sheet holding part 2061, which is pre-installed at the installation position B1, to the measurement position B2 and moving the used measurement sheet 33 to the installation position B1. Even while measurement is being performed using the measurement sheet 33 placed at the measurement position B2, the used measurement sheet 33 placed at the installation position B1 can be replaced with a new measurement sheet 33.

The measuring device 88 may be movable to each of the measurement positions set in the plurality of sheet holding parts 2061. For example, by providing a mechanism to move the measuring device 88 in the Y-axis direction in addition to the direction along the rail 87, a single measuring device 88 can perform measurement on a plurality of sheet holding parts 2061 that perform colorimetric measurement. This configuration reduces the number of measuring devices 88 to be provided.

The automatic analyzer 1 further includes the display parts 2062A to 2062E that display the state of use or replacement of the measurement sheets 33. The control circuitry 9 can determine the state of use or replacement of the measurement sheets 33 based on a drive state of the drive mechanism 4, and control the states of the display parts 2062A to 2062E according to determination results. For example, in a case where a measurement sheet 33 needs to be replaced, a corresponding one of the display parts 2062A to 2062E can be made to blink in a specific color to prompt the user to replace the measurement sheet 33.

In addition to the display parts 2062A to 2062E, another display part that displays the state of use or replacement of the measurement sheet 33 may be provided in the output interface 6. In this case, in addition to the state of use or replacement of the measurement sheet 33, information about the measurement sheet 33 may be displayed on the output interface 6. Information about the measurement sheet 33 includes, for example, an expiration date, a start date of use, a lot, and a serial number of the measurement sheet 33 in use, and the number of unused item measurement parts 63 in the measurement sheet 33. These pieces of information may be displayed only for one of the measurement sheet 33 at the installation position B1 and the measurement sheet 33 at the measurement position B2, or for both. Identification information of a collected measurement sheet 33 may be recorded, and if that measurement sheet 33 is installed at the installation position B1, a message to the effect that the installed measurement sheet 33 is unusable may be displayed. If the installed measurement sheet 33 is unusable, it may be controlled so that the installed measurement sheet 33 is not moved from the installation position B1 to the measurement position B2.

The conveyor mechanism 80 conveys the measurement sheet 33 along a direction inclined with respect to each of the horizontal and vertical directions. That is, the conveyor mechanism 80 is arranged to be inclined with respect to the vertical and horizontal directions. This configuration allows a dimension of the conveying means in the horizontal direction to be reduced and a footprint to be smaller than a case where the conveyor mechanism 80 that conveys the measurement sheet 33 is parallel to the horizontal direction. As compared to a case where the conveying means is arranged in parallel to the vertical direction, the gravity acting on the measurement sheet 33 itself allows the measurement sheet 33 to adhere to the conveyor mechanism 80, and a constant temperature effect by the constant temperature part 86 can be given to the measurement sheet 33 more efficiently.

The automatic analyzer 1 further includes the first aspirating position P1 where unmeasured samples are aspirated, the second aspirating position P2 where samples determined to require remeasurement are aspirated, and the control circuitry 9 that determines a necessity for remeasurement based on a sample measurement result and causes a sample determined to require remeasurement to be conveyed to the second aspirating position. The control circuitry 9 is an example of a controller.

By providing a position for aspirating samples determined to require remeasurement separately from a position for aspirating unmeasured samples, sample remeasurement can be performed efficiently.

The automatic analyzer 1 further includes a dispensing probe 205 that aspirates a sample and dispenses the aspirated sample to a dispensing position of the measurement sheet 33. The disposable sampling tip 2051 is attached to a distal end portion of the dispensing probe 205.

The use of a disposable sampling tip 2051 eliminates the need to wash the dispensing probe 205, thereby eliminating sample carryover without providing a washing mechanism. In addition, by not providing a washing mechanism, the device can be downsized.

### First Modification of First Embodiment

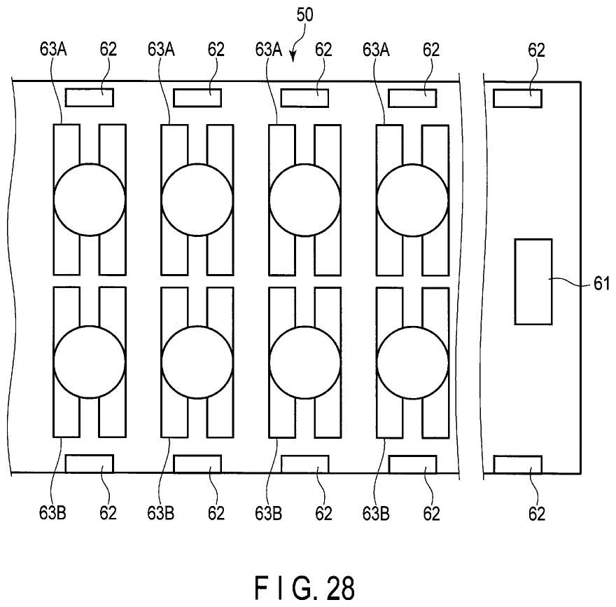

FIG. 28 is a diagram showing a configuration of a measurement sheet 33 according to a first modification of the present embodiment. The measurement sheet 33 according to the present modification is provided with a plurality of item measurement parts in the width direction of the measurement sheet 33. As shown in FIG. 28, the measurement sheet 33 includes a plurality of first item measurement parts 63A and a plurality of second item measurement parts 63B. A set of first item measurement parts 63A and a set of second item measurement parts 63B are arranged at different positions in the width direction of the measurement sheet 33. The first item measurement parts 63A and the second item measurement parts 63B are used to measure different test items. Each of the first item measurement parts 63A and the second item measurement parts 63B is arranged at regular intervals along the longitudinal direction of the measurement sheet 33.

The measuring device 88 measures samples at a plurality of dispensing positions each time the measurement sheet 33 is fed. For example, each time the measuring device 88 aspirates a sample from the sample rack 201 at the first aspirating position P1, it discharges the aspirated sample to each of the first item measurement part 63A and the second item measurement part 63B. The conveyor mechanism 80 then feeds the measurement sheet 33 each time the sample is discharged to each of the first item measurement part 63A and the second item measurement part 63B.

In the following description, an advantageous effect of the automatic analyzer 1 according to the present modification will be described.

A plurality of item measurement parts 63A and 63B according to the present embodiment are provided along the width direction of the measurement sheet 33, and the conveyor mechanism 80 feeds the measurement sheet 33 each time a sample is dispensed to each of the plurality of item measurement parts 63A and 63B provided along the width direction of the measurement sheet 33.

The above configuration enables dispensing of a sample to a plurality of item measurement parts 63A and 63B for each sample aspiration by arranging a plurality of item measurement parts 63A and 63B along the width direction of one measurement sheet 33. This increases the number of test items that can be measured with a single sample aspiration.

### Second Modification of First Embodiment

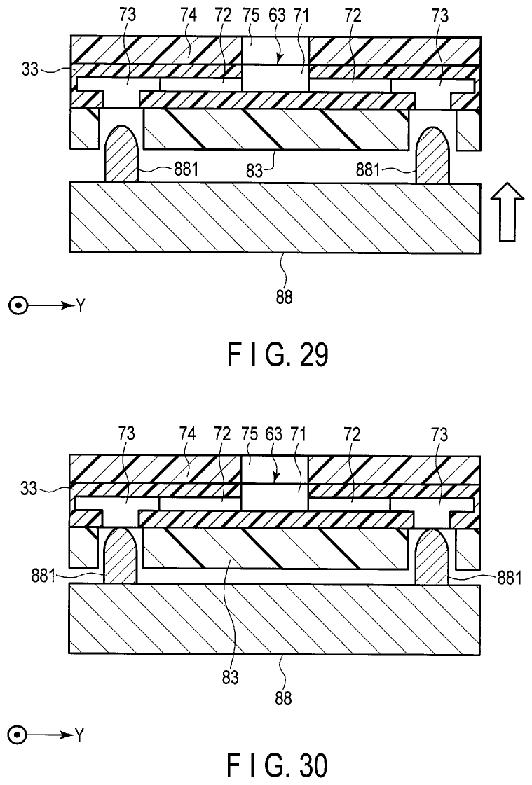

FIGS. 29 and 30 are diagrams showing configurations of a measurement sheet 33, a conveyor mechanism 80, and a measuring device 88 according to a second modification of the present embodiment. FIG. 29 is a diagram showing the measurement sheet 33, conveyor mechanism 80, and measuring device 88 of the present modification in the same cross section as that in FIG. 16. FIG. 30 is a diagram showing the measurement sheet 33, conveyor mechanism 80, and measuring device 88 of the present modification in the same cross section as that in FIG. 17.

The measuring device 88 of the present modification is arranged on a back side of a conveyor belt 83. A measurement section 73 of the measurement sheet 33 opens toward a back side of the measurement sheet 33. A cover 74 is attached to a front surface of the measurement sheet 33. The cover 74 is attached to the conveyor mechanism 80 so that it does not move together with the conveyor belt 83. The cover 74 is attached to the conveyor mechanism 80 to cover the measurement sheet 33 from above to prevent the measurement sheet 33 from moving when a connection part 881 of the measuring device 88 is connected to the measurement section 73. The cover 74 is preferably formed of a scientifically stable material such as polyethylene or polypropylene. The cover 74 has a hole 75 for sampling at a position covering a dispensing section 71 at the discharging position P3.

The conveyor belt 83 has a through hole for inserting the connection part 881 of the measuring device 88. The through hole is provided at a position where the measurement section 73 of the measurement sheet 33 is arranged. The measurement section 73 is exposed through the through hole of the conveyor belt 83 and toward the back side of the conveyor belt 83.

When performing electrode measurement, the measuring device 88 moves from the back side of the conveyor belt 83 in a direction of approaching the measurement sheet 33 placed on the conveyor belt 83 under the control of the control circuitry 9. At this time, the connection part 881 is inserted inside the through hole of the conveyor belt 83. The connection part 881 is connected to the measurement section 73 to be measured. The electrode measurement is then performed in the same manner as in the first embodiment.

In the present modification, the measuring device 88 for electrode measurement is described, but the measuring device 88 for colorimetric measurement can also be arranged on the back side of the conveyor belt 83.

### Third Modification of First Embodiment

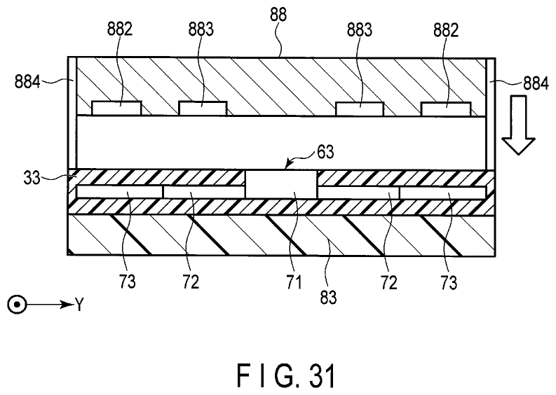

FIG. 31 is a diagram showing a modification of a measuring device 88 for colorimetric measurement. As shown in FIG. 31, the measuring device 88 further includes a disturbance light shielding part 884. The disturbance light shielding part 884 blocks disturbance light that is about to enter an imaging part 882 during colorimetric measurement. By providing the disturbance light shielding part 884, an influence of disturbance light on imaging conditions can be suppressed and the imaging conditions can be kept the same. In a case of performing colorimetric measurement using the measuring device 88 having the disturbance light shielding part 884, instead of bringing the entire measuring device 88 close to the measurement sheet 33, only the disturbance light shielding section 884 may be brought close to the measurement sheet 33.

### Fourth Modification of First Embodiment

In the first embodiment, the measurement can be performed at multiple positions by making the measuring device 88 movable independently of the conveyor mechanism 80, so that the measurement can be performed in order starting from an item measurement part 63 in which a reaction is completed, and waste of the measurement sheet 33 can be suppressed, but the measurement may be performed at multiple positions by other methods.

For example, a plurality of measuring devices 88 may be arranged at regular intervals on the rail 87. In this case, the plurality of measuring devices 88 are arranged at a plurality of measurement positions. The control circuitry 9 causes measurement to be performed using a measuring device 88 arranged at a position that enables measurement of a measurement section 73 in which a reaction is completed among the plurality of measuring devices 88.

### Fifth Modification of First Embodiment

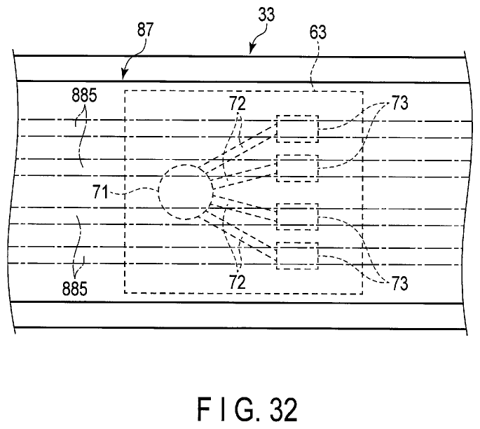

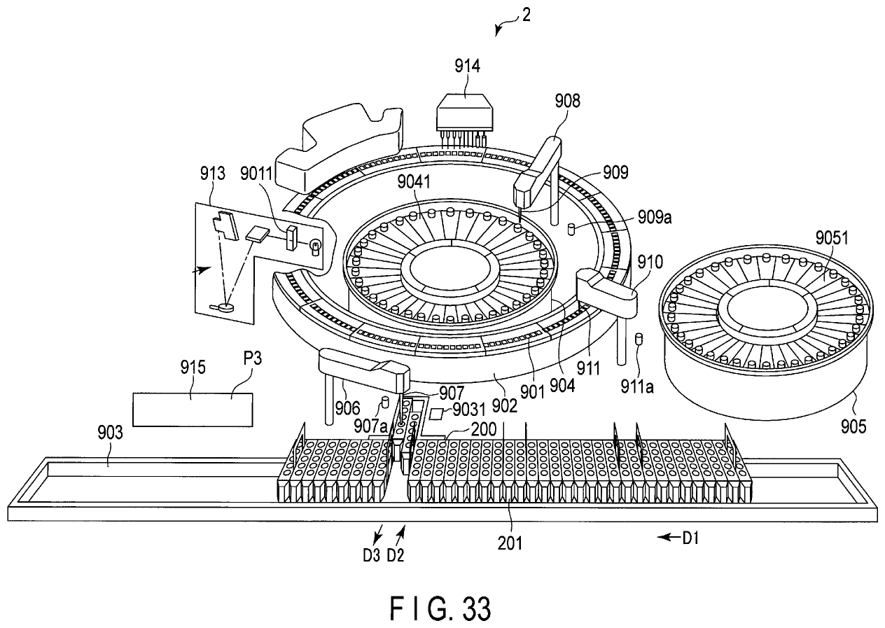

In a case of performing electrode measurement using the measurement sheet 33, a plurality of conduction parts 885 that can be connected to the measurement sections 73 of the measurement sheet 33 may be provided at a plurality of measurement positions, as shown in FIG. 32. In this case, the same number of conduction parts 885 as that of measurement sections 73 provided in one item measurement part 63 are extended in parallel along the rail 87. Each conduction part 885 is electrically connected to a corresponding one of the connection parts 881 provided in a plurality in the measuring device 88. Each conduction part 885 is formed of a conductive material and is secured to the rail 87 while being insulated from adjacent conduction parts. When the conduction part 885 contacts the measurement section 73 of the corresponding item for which a reaction is completed, the measurement section 73 and the connection part 881 become conductive with each other, and electrode measurement by the measuring device 88 is performed. Thus, it is preferable that each measurement section 73 be arranged at a different position in the width direction of the measurement sheet 33 so that the extended positions of the conduction parts 885 do not overlap.

To connect a measurement section 73 in which a reaction is completed to an opposing conduction part 885 at any position, the conduction part 885 may be moved toward the measurement section 73, or the measurement sheet 33 may be moved toward the conduction part 885. In the case of moving the measurement sheet 33 toward the conduction part 885, for example, the conveyor mechanism 80 is provided with a mechanism to push the measurement sheet 33, which is conveyed along the conveyor belt 83, up at any position toward the conduction part 885. By controlling driving of this mechanism, the control circuitry 9 can perform measurement at any position by connecting the measurement section 73 in which a reaction is completed to the opposing conduction part 885.

Switching may also be performed. The conduction parts 885 may be arranged to simultaneously contact a plurality of measurement sections 73 at multiple positions. In this case, a protrusion protruding toward the conveyor mechanism 80 is provided at each measurement position of each conduction part 885, and an electrical path with a connection part 881 is provided for each protrusion. When the measurement sheet 33 is conveyed, the respective protrusions simultaneously contact the measurement sections 73 of a plurality of item measurement parts 63. By switching an electrical connection state between the connection parts 881 and the protrusions, the control circuitry 9 can perform measurement on any desired measurement section 73 at any position by switching conduction between a protrusion and a connection part 881 that are connected together at a timing when a reaction is completed.

### Sixth Modification of First Embodiment

A wasteful use of the measurement sheet 33 may be suppressed by controlling both feeding and winding of the measurement sheet 33. In this case, the control circuitry 9 controls feeding and winding of the measurement sheet 33 by the feed mechanism 85 to move the measurement sheet 33 so that a measurement section 73 in which a reaction is completed at a predetermined measurement timing is located at a measurement position facing the measuring device 88. This allows various measurements to be performed without wasting the measurement sheet 33. In this case, the measuring device 88 may be fixed to the rail 87 and may not be movable.

### Second Embodiment

A second embodiment will be described. The present embodiment is obtained by modifying the configuration of the first embodiment as follows. Descriptions of the configurations, operations, and advantageous effects similar to those of the first embodiment will be omitted. An analysis mechanism 2 of an automatic analyzer 1 according to the present embodiment uses a reaction disk that holds a reaction container to perform colorimetric measurement of a sample, and uses a measurement sheet 33 to perform electrode measurement of a sample.

FIG. 32 is a diagram showing a configuration of the analysis mechanism 2 of the automatic analyzer 1 according to the present embodiment. The analysis mechanism 2 includes a reaction disk 901, a constant temperature part 902, a rack sampler 903, a first reagent depository 904, and a second reagent depository 905. The analysis mechanism 2 also includes a sample dispensing arm 906, a sample dispensing probe 907, a washing tank 907a, a detergent reservoir 907b, a first reagent dispensing arm 908, a first reagent dispensing probe 909, a washing tank 909a, a second reagent dispensing arm 910, a second reagent dispensing probe 911, a washing tank 911a, a photometry unit 913, a washing unit 914, and a measurement unit 915.

First, a description will be given of the reaction disk 901, the constant temperature part 902, the rack sampler 903, the first reagent depository 904, and the second reagent depository 905.

The reaction disk 901 holds a plurality of reaction tubes 9011 containing a mixture liquid of a reagent and a sample in an annular arrangement. The reaction disk 901 is rotated and stopped alternately at predetermined time intervals (hereinafter referred to as “one cycle”) by the drive mechanism 4. The reaction tubes 9011 are made of glass, for example. The reaction tube 9011 is an example of a reaction container.

The constant temperature part 902 stores a thermal medium set at a predetermined temperature. By immersing the reaction tube 9011 in the stored thermal medium, the constant temperature part 902 increases a temperature of the mixture liquid contained in the reaction tube 9011.

The rack sampler 903 supports, in a movable manner, sample racks 201 that can hold a plurality of sample containers 200 containing measurement-requested samples. In an example shown in FIG. 32, the sample racks 201 each capable of holding a row of five sample containers 200 are shown.

The rack sampler 903 has a reader 9031. The reader 9031 is provided at a position where an optical mark added to the sample container 200 can be read, for example.

The optical mark is a mark obtained by encoding identification information, etc. of the sample contained in the sample container 200, such as a bar code, one-dimensional pixel code, or two-dimensional pixel code. In response to an instruction to start ID reading from the control circuitry 9 as a trigger, the reader 9031 starts reading of an optical mark. Upon arrival of a sample container 200 at a position where an optical mark can be read, the reader 9031 reads identification information of the sample from that optical mark. The reader 9031 supplies the read identification information to the control circuitry 9. The reader 9031 may be substituted by another sensor using radio frequency identification (RFID), etc.

The rack sampler 903 includes a conveyor region where the sample racks 201 are conveyed from a loading position where the sample racks 201 are loaded to a collection position where the sample racks 201 that have undergone the measurement operation are collected. In the conveyor region, a plurality of sample racks 201 arranged with their short sides aligned are moved in a direction. D1 by the drive mechanism 4.

The rack sampler 903 also includes a carry-in region where one or more sample racks 201 are drawn from the conveyor region so that each sample container 200 held by the sample racks 201 is moved to a predetermined sample aspirating position. This sample aspirating position is set at, for example, an intersection between a circling trajectory of the sample dispensing probe 907 to be described later and a traveling path of an opening of the sample container that is held by the sample rack 201 and supported by the rack sampler 903. In the carry-in region, the incoming sample rack 201 is moved in a direction D2 by the drive mechanism 4. At a position where optical marks can be read in the carry-in region, an optical mark added to a sample container held in the sample rack 201 moved in the direction D2 is read by the reader 9031.

The rack sampler 903 further includes a carry-back region where the sample racks 201 holding the sample containers from which the samples have been aspirated are returned to the conveyor region. In the carry-back region, the sample rack 201 is moved in a direction. D3 by the drive mechanism 4.

The first reagent depository 904 is adapted for cold storage of a plurality of reagent containers 9041 containing a first reagent for reaction with a given component contained in a standard sample or a given component contained in a subject sample. While not illustrated in FIG. 32, the first reagent depository 904 is covered by a detachable reagent cover. The first reagent depository 904 encloses reagent racks in such a manner that the reagent racks can turn. The reagent racks hold the reagent containers 9041 in an annular arrangement. The reagent racks are turned by the drive mechanism 4.

One or more first reagent aspirating positions are set at predetermined positions on the first reagent depository 904. For example, each first reagent aspirating position is set at an intersection between a circling trajectory of the first reagent dispensing probe 909 to be described later and a traveling path of openings of the reagent containers 9051 annularly arranged in the reagent racks.

The second reagent depository 905 is adapted for cold storage of a plurality of reagent containers 9051 that contain a second reagent for constituting a dual-reagent system with the first reagent. While not illustrated in FIG. 32, the second reagent depository 905 is covered by a detachable reagent cover. The second reagent depository 905 encloses reagent racks in such a manner that the reagent racks can turn. These reagent racks hold the reagent containers 9051 in an annular arrangement. Note that the second reagent kept at a low temperature in the second reagent depository 905 may be a reagent of the same components and the same concentration as the first reagent kept at a low temperature in the first reagent depository 904.

One or more second reagent aspirating positions are set at predetermined positions on the second reagent depository 905. For example, each second reagent aspirating position is set at an intersection between a circling trajectory of the second reagent dispensing probe 911 and the traveling path of the openings of the reagent containers 9051 annularly arranged in the reagent racks.

Next, a description will be given of the sample dispensing arm 906, the sample dispensing probe 907, the washing tank 907a, the detergent reservoir 907b, the first reagent dispensing arm 908, the first reagent dispensing probe 909, the washing tank 909a, the second reagent dispensing arm 910, the second reagent dispensing probe 911, the washing tank 911a, the measurement unit 915, the photometry unit 913, and the washing unit 914.

The sample dispensing arm 906 is provided between the reaction disk 901 and the rack sampler 903. The sample dispensing arm 906 is adapted so that it can vertically ascend and descend and also horizontally rotate, with the assistance of the drive mechanism 4. The sample dispensing arm 906 carries the sample dispensing probe 907 at its one end.

The sample dispensing probe 907 pivots along an arc circling trajectory in conjunction with the rotation of the sample dispensing arm 906. This circling trajectory is set so that the openings of the sample containers held by the sample racks 201 on the rack sampler 903 will come under it.

Also, the circling trajectory of the sample dispensing probe 907 includes one or more sample discharging positions for the sample dispensing probe 907 to discharge aspirated samples to the reaction tubes 9011. Each sample discharging position corresponds to an intersection between the circling trajectory of the sample dispensing probe 907 and the traveling path of the reaction tubes 9011 held by the reaction disk 901.

At a different position from the sample aspirating position and sample discharging position on the circling trajectory of the sample dispensing probe 907, a washing position where the sample dispensing probe 907 is washed is provided. At the washing position, the washing tank 907a to wash the sample dispensing probe 907 is provided.

A detergent aspirating position for the sample dispensing probe 907 to aspirate a detergent may also be provided at a different position from the sample aspirating, sample dispensing, and washing positions on the circling trajectory of the sample dispensing probe 907. The detergent reservoir 907b to store a detergent to be used for washing an electrode unit to be described later may be provided at the detergent aspirating position.

The sample dispensing probe 907 is driven by the drive mechanism 4 so that it ascends or descends at a position directly above the opening of one sample container held by the sample rack 201 on the rack sampler 903, at the sample discharging position, at the washing position, or at the detergent aspirating position.

Under the control of the control circuitry 9, the sample dispensing probe 907 aspirates the sample from the opening of the sample container. Under the control of the control circuitry 9, the sample dispensing probe 907 discharges the aspirated sample into the reaction tube 9011 located directly below it at the sample discharging position. In one example, the sample dispensing probe 907 performs such a series of dispensing actions once in one cycle. The sample dispensing probe 907 is an example of a dispensing mechanism that dispenses a sample to a measurement part.

Further, under the control of the control circuitry 9, the sample dispensing probe 907 aspirates a washing liquid from the washing tank 907a located directly below it at the washing position on the circling trajectory of the sample dispensing probe 907. The washing liquid is, for example, pure water, an alkaline detergent for probe washing or an acid detergent for probe washing. Under the control of the control circuitry 9, the sample dispensing probe 907 discharges the aspirated washing liquid into the reaction tube 9011 located directly below it at the sample discharging position. This washes the sample dispensing probe 907 and the reaction tube 9011 located directly below it at the sample discharging position. In one example, the sample dispensing probe 907 performs such a series of washing actions once in one cycle.

If the detergent reservoir 907b is provided in the automatic analyzer 1, the sample dispensing probe 907 aspirates a detergent from the detergent reservoir 907b located directly below it at the detergent aspirating position on the circling trajectory of the sample dispensing probe 907, under the control of the control circuitry 9. Also under the control of the control circuitry 9, the sample dispensing probe 907 discharges the aspirated detergent into the reaction tube 9011 located directly below it at the sample discharging position. In one example, the sample dispensing probe 907 performs such a series of dispensing actions once in one cycle.

The first reagent dispensing arm 908 is provided between the reaction disk 901 and the first reagent depository 904. The first reagent dispensing arm 908 is adapted so that it can vertically ascend and descend and also horizontally rotate with the assistance of the drive mechanism 4. The first reagent dispensing arm 908 carries the first reagent dispensing probe 909 at its one end.

The first reagent dispensing probe 909 pivots along an arc circling trajectory in conjunction with the rotation of the first reagent dispensing arm 908. This circling trajectory includes said one or more first reagent aspirating positions. Also, the circling trajectory of the first reagent dispensing probe 909 includes one or more first reagent discharging positions set for the first reagent dispensing probe 909 to discharge the aspirated reagent into the reaction tubes 9011. Each first reagent discharging position corresponds to an intersection between the circling trajectory of the first reagent dispensing probe 909 and the traveling path of the reaction tubes 9011 held by the reaction disk 901. Furthermore, at a different position from the first reagent aspirating position and the first reagent discharging position on the circling trajectory of the first reagent dispensing probe 909, there is a washing position where the first reagent dispensing probe 909 is washed. At the washing position, the washing tank 909a is provided to wash the first reagent dispensing probe 909.

The first reagent dispensing probe 909 is driven by the drive mechanism 4 so that it ascends or descends at the first reagent aspirating position, the first reagent discharging position, or the washing position on the circling trajectory.

Under the control of the control circuitry 9, the first reagent dispensing probe 909 aspirates the first reagent from the reagent container located directly below it at the first reagent aspirating position. That is, the first reagent dispensing probe 909 is an example of a reagent dispensing probe according to the present embodiment. Also under the control of the control circuitry 9, the first reagent dispensing probe 909 discharges the aspirated first reagent into the reaction tube 9011 located directly below it at the first reagent discharging position. In one example, the first reagent dispensing probe 909 performs such a series of dispensing actions once in one cycle.

Under the control of the control circuitry 9, the first reagent dispensing probe 909 aspirates a washing liquid from the washing tank 909a located directly below it at the washing position on the circling trajectory of the first reagent dispensing probe 909. Under the control of the control circuitry 9, the first reagent dispensing probe 909 discharges the aspirated washing liquid into the reaction tube 9011 located directly below it at the first reagent discharging position. This washes the first reagent dispensing probe 909 and the reaction tube 9011 located directly below it at the first reagent discharging position. In one example, the first reagent dispensing probe 909 performs such a series of washing actions once in one cycle.

The second reagent dispensing arm 910 is provided between the reaction disk 901 and the second reagent depository 905. The second reagent dispensing arm 910 is adapted so that it can vertically ascend and descend and also horizontally rotate with the assistance of the drive mechanism 4. The second reagent dispensing arm 910 carries the second reagent dispensing probe 911 at its one end.

The second reagent dispensing probe 911 pivots along an arc circling trajectory in conjunction with the rotation of the second reagent dispensing arm 910. This circling trajectory includes said one or more second reagent aspirating positions.

Also, the circling trajectory of the second reagent dispensing probe 911 includes one or more second reagent discharging positions set for the second reagent dispensing probe 911 to discharge the aspirated reagent to the reaction tubes 9011. Each second reagent discharging position corresponds to an intersection between the circling trajectory of the second reagent dispensing probe 911 and the traveling path of the reaction tubes 9011 held by the reaction disk 901.

The circling trajectory of the second reagent dispensing probe 911 includes a detergent discharging position set for the second reagent dispensing probe 911 to discharge the aspirated detergent to the reaction tubes. The detergent discharging position corresponds to an intersection between the circling trajectory of the second reagent dispensing probe 911 and the traveling path of the reaction tubes 9011 held by the reaction disk 901, and is a position different from the second reagent discharging position.

At a different position from the second reagent aspirating position, the second reagent discharging position, and the detergent discharging position on the circling trajectory of the second reagent dispensing probe 911, there is a washing position where the second reagent dispensing probe 911 is washed. At the washing position, the washing tank 911a to wash the second reagent dispensing probe 911 is provided.

The second reagent dispensing probe 911 is driven by the drive mechanism 4 so that it ascends or descends at the second reagent aspirating position, the second reagent discharging position, the detergent discharging position, or the washing position on the circling trajectory.

Under the control of the control circuitry 9, the second reagent dispensing probe 911 aspirates the second reagent from the reagent container located directly below it at the second reagent aspirating position. That is, the second reagent dispensing probe 911 is one example of a reagent dispensing probe according to the present embodiment. Also under the control of the control circuitry 9, the second reagent dispensing probe 911 discharges the aspirated second reagent into the reaction tube 9011 located directly below it at the second reagent discharging position. In one example, the second reagent dispensing probe 911 performs such a series of dispensing actions once in one cycle.

Under the control of the control circuitry 9, the second reagent dispensing probe 911 aspirates a washing liquid from the washing tank 911a located directly below it at the washing position on the circling trajectory of the second reagent dispensing probe 911. Also under the control of the control circuitry 9, the second reagent dispensing probe 911 discharges the aspirated washing liquid into the reaction tube 9011 located directly below it at the second reagent discharging position. This washes the second reagent dispensing probe 911 and the reaction tube 9011 located directly below it at the second reagent discharging position. In one example, the second reagent dispensing probe 911 performs such a series of washing actions once in one cycle.

The photometry unit 913 optically measures a given component in a mixture liquid of a sample and a reagent discharged into the reaction tube 9011. The photometry unit 913 has a light source and a photodetector. Under the control of the control circuitry 9, the photometry unit 913 emits light from the light source. The emitted light enters the reaction tube 9011 through a first sidewall, and exits the reaction tube 9011 through a second sidewall facing the first sidewall. The photometry unit 913 detects the light that exited from the reaction tube 2011 with the photodetector. The photometry unit 913 is an example of a second measuring means that measures a material property value of the mixture liquid of a reagent and a sample by measuring a change in color of the mixture liquid.

Specifically, for example, the photodetector detects the light that has passed through the mixture liquid of a standard sample and a reagent in a reaction tube 9011, and generates standard data represented as an absorbance, etc., based on an intensity of the detected light. The photodetector also detects the light that has passed through the mixture liquid of a subject sample and a reagent in a reaction tube 9011, and generates subject data represented as an absorbance, etc., based on an intensity of the detected light. The photometry unit 913 outputs the generated standard data and subject data to the analysis circuitry 3.

The washing unit 914 washes the inside of the reaction tube 9011 that has undergone the measurement operation of the mixture liquid in the photometry unit 913. This washing unit 914 includes a washing liquid supply pump (not shown) for supplying a washing liquid to wash the reaction tubes 9011. The washing unit 914 also includes a washing nozzle (not shown) adapted to discharge the washing liquid supplied from the washing liquid supply pump into the reaction tubes 9011, and to aspirate each of the mixture liquid and the washing liquid in the reaction tubes 9011.

The measurement unit 915 measures an electrolyte concentration of a sample that is discharged onto a measurement sheet 33 and reacts with a reagent contained in the measurement sheet 33, and generates standard data and subject data based on a measurement result. The photometry unit 915 outputs the generated standard data and subject data to the analysis circuitry 3.

The measurement unit 915 includes a sheet holding part 2061 that holds a measurement sheet 33, a conveyor mechanism 80 that conveys a sample discharged onto the measurement sheet 33 to a measurement position, and a measuring device 88 that measures a material property of the sample conveyed to the measurement position. In the present embodiment, a measurement sheet for electrode measurement is used as the measurement sheet 33, and a measuring device 88 for electrode measurement shown in FIGS. 13 to 17 is used as the measuring device 88. That is, the measuring device 88 includes an electrode that changes in potential according to an amount of a specific component contained in a sample. The sheet holding part, conveyor mechanism 80, and measuring device 88 are similar to the configurations shown in FIG. 8, so a detailed description thereof is omitted.

Also, the circling trajectory of the sample dispensing probe 907 includes the discharging position P3 for the sample dispensing probe 907 to discharge an aspirated sample to the measurement sheet 33. The sample dispensing probe 907 is driven by the drive mechanism 4 to move in a vertical direction at the discharging position P3.

Under the control of the control circuitry 9, the sample dispensing probe 907 aspirates a sample from an opening of a sample container. Also under the control of the control circuitry 9, the sample dispensing probe 907 discharges the aspirated sample onto the measurement sheet 33 located at the discharging position P3. In one example, the sample dispensing probe 907 performs such a series of dispensing actions once in one cycle.

The control circuitry 9, with the system control function 91, controls all units in the automatic analyzer 1 based on, for example, input information input from the input interface 5, etc. Specifically, the control circuitry 9 controls the rotation of the reaction disk 901, the pivoting and dispensing actions of the sample dispensing probe 207, and the pivoting and dispensing actions of the second reagent dispensing probe 911.

In the following description, an advantageous effect of the automatic analyzer 1 according to the present embodiment will be described.

The automatic analyzer 1 according to the present embodiment includes the reaction disk 901 that holds the plurality of reaction tubes 9011 containing a mixture liquid of a reagent and a sample, and the photometry unit 913 that measures a material property value of the mixture liquid. The reaction tube 9011 is an example of a reaction container, and the photometry unit 913 is an example of a second measuring means.

With the above configuration, according to the automatic analyzer 1 according to the present embodiment, both a method of measuring the components of a sample using the reaction disk 901 that holds the reaction tubes 9011 and a measurement method using the measurement sheet 33 can be mounted on a single automatic analyzer 1.

The measuring device 88 according to the present embodiment also includes the connection part 881. The connection part 881 is an electrode that changes in potential in response to a specific component contained in a sample. The photometry unit 913 measures a change in color of the mixture liquid. That is, it measures a change in color of a mixture liquid of a reagent and a sample.

The above configuration enables colorimetric measurement of a sample based on an absorbance using the reaction disk 901 holding a plurality of reaction tubes 9011 and electrode measurement of a sample using the measurement sheet 33. Using the measurement sheet 33 to perform electrode measurement improves throughput in a case of performing consecutive electrode measurement in the same manner as in the first embodiment.

The measurement method implemented using each of the reaction disk 901 and the measurement sheet 33 is not limited to the above configuration. For example, electrode measurement may be performed using the reaction disk 901 and colorimetric measurement may be performed using the measurement sheet 33 and an imaging device. Both colorimetric measurement and electrode measurement may be performed using the reaction disk 901, and both electrode measurement and colorimetric measurement may be performed using the measurement sheet 33.

### Modification of Second Embodiment

In the present embodiment, a single sample dispensing probe 907 is used to dispense a sample into both the reaction tube 9011, which is placed on the reaction disk 901, and the measurement sheet 33 to perform colorimetric measurement of the sample in the reaction disk 901 and electrode measurement of the sample on the measurement sheet 33, allowing a plurality of test items to be tested on a single sample. At this time, one test item is measured per sample per cycle. For example, In the first cycle, electrode measurement is performed using the measurement sheet 33, and in the next cycle, colorimetric measurement is performed using the reaction disk 901. After that, another test item may be measured using another test device.

In a case of performing measurement by moving the measurement sheet 33, the following processes are consecutively performed in one cycle: feeding the measurement sheet 33 to convey the item measurement part 63 to which a sample is dispensed to a position facing the measuring device 88, performing measurement by the measuring device 88 on the item measurement part 63 in which a reaction is completed, rewinding the measurement sheet 33 and conveying the next item measurement part 63 to the sample discharging position P3, and dispensing the sample to the next item measurement part 63. Thus, depending on a reaction time of the sample, etc., it may be difficult to complete all of the above processes within the time of one cycle. In this case, the order of tests to be conducted on a single test item may be changed as appropriate. For example, if electrode measurement using the measurement sheet 33 is not completed within the time of one cycle, the order to conduct tests may be controlled in such a manner that the order of tests for the next sample is switched to perform colorimetric measurement using the reaction disk 901 first and then perform electrode measurement using the measurement sheet 33 later. This makes it possible to efficiently conduct tests on a plurality of test items.

A length of one cycle of a test using the measurement sheet 33 and a length of one cycle of a test using the reaction disk 901 are preferably the same. However, if it is difficult to complete all of the above processes using the measurement sheet 33 within the time of one cycle, the length of one cycle may be an integer multiple of the length of the other cycle. For example, the length of one cycle in electrode measurement using the measurement sheet 33 may be double the length of one cycle in colorimetric measurement using the reaction disk 901.

### Third Embodiment

In a case in which a measurement cartridge having a measurement sheet containing reagents is used in an automatic analyzer, a reagent bottle that contains a reagent, a reagent depository that holds the reagent bottle, a reagent dispensing probe that dispenses the reagent in the reagent bottle, etc. are no longer necessary, which can downsize the device. In addition, by not using the reagent dispensing probe, no carryover occurs.

However, in the case of using the measurement cartridge having a measurement sheet, the user needs to collect a used measurement sheet to be disposed of. Also, in the case of using the measurement cartridge having a measurement sheet, a measurement efficiency is reduced because measurement is not resumed until the user replaces a used measurement cartridge with a new measurement cartridge having a new measurement sheet.

An automatic analyzer according to the present embodiment includes a measurement cartridge, a dispensing mechanism, a measurement mechanism, a sheet conveyor mechanism (conveying means), a cartridge conveyor mechanism (holding means), and a sheet collection mechanism. The measurement cartridge houses a roll-shaped measurement sheet on which a plurality of parts to be measured (measurement parts) for measuring a measurement target component in a sample are arranged. The dispensing mechanism dispenses the sample into the parts to be measured. The measurement mechanism (measuring means) measures the sample dispensed into the parts to be measured. The sheet conveyor mechanism pulls out the measurement sheet from the measurement cartridge at a measurement position and conveys it to the dispensing mechanism and the measurement mechanism. The cartridge conveyor mechanism conveys the measurement cartridge from the measurement region to a collection region different from the measurement region. The sheet collection mechanism collects the measurement sheet after use into the measurement cartridge in the collection region.

One problem to be solved by the present embodiment is to improve the measurement efficiency.

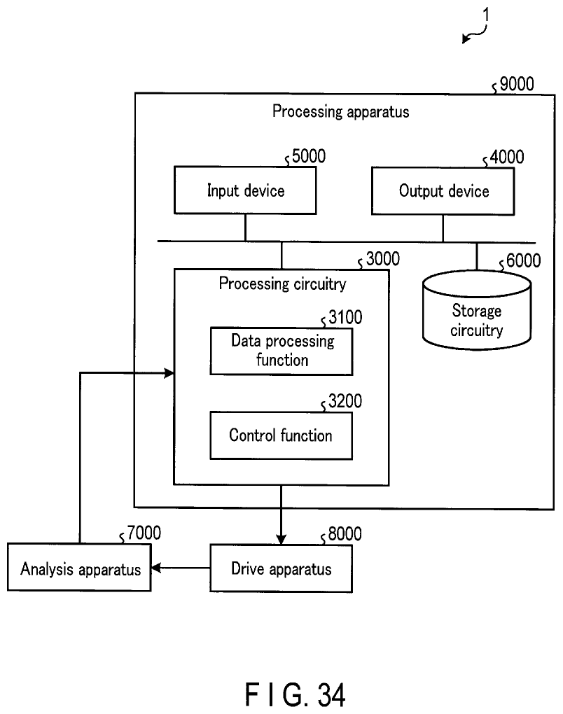

FIG. 34 is a block diagram showing an example of a configuration of an automatic analyzer 1 according to the present embodiment. The automatic analyzer 1 shown in FIG. 34 includes an analysis apparatus 7000, a drive apparatus 8000, and a processing apparatus 9000.

The analysis apparatus 7000 generates standard data and test data by measuring a mixture liquid of a standard sample for each test item, a subject sample (biological sample such as blood or urine) taken from an analyte, and a reagent to be used in analysis of each test item. The analysis apparatus 7000 has a plurality of units that dispense samples, dispense reagents, etc., and the drive apparatus 8000 drives each unit of the analysis apparatus 7000. The processing apparatus 9000 controls the drive apparatus 8000 to operate each unit of the analysis apparatus 7000.

The processing apparatus 9000 has an input device 5000, an output device 4000, processing circuitry 3000, and storage circuitry 6000.

The input device 5000 includes input devices such as a keyboard, a mouse, buttons, and a touch key panel, and performs input for setting analysis parameters for each test item, input for setting subject identification information and test items of a subject sample, etc.

The output device 4000 includes a printer and a display. The printer prints data generated by the processing circuitry 3000. The display is a monitor, such as a cathode ray tube (CRT) or a liquid crystal panel, which displays the data generated by the processing circuitry 3000.

The storage circuitry 6000 is, for example, a semiconductor memory device such as a random access memory (RAM) and a flash memory, or a storage device such as a hard disk and an optical disk.

The processing circuitry 3000 controls the entire system. For example, the processing circuitry 3000 performs a data processing function 3100 and a control function 3200, as shown in FIG. 34. The control function 3200 controls the drive apparatus 8000 to operate each unit of the analysis apparatus 7000. The data processing function 3100 processes standard data and subject data generated by the analysis apparatus 7000 to generate calibration data and analysis data for each test item.

For example, the standard data generated by the analysis apparatus 7000 represents data for determining an amount and a concentration of a substance (calibration curve or standard curve), and the subject data generated by the analysis apparatus 7000 represents data of a result of measuring a subject sample. The calibration data output from the processing circuitry 3000 represents data representing measurement results such as the amount and concentration of a substance derived from the subject data and the standard data, and the analysis data output from the processing circuitry 3000 represents data representing positive or negative determination results. That is, the calibration data is data to derive the analysis data representing positive or negative determination results.

Here, for example, each processing function performed by the components of the processing apparatus 3000 is recorded in the storage circuitry 6000 in the form of a program executable by a computer. The processing circuitry 3000 is a processor that reads each program from the storage circuitry 6000 and executes the program to realize a function corresponding to the program. In other words, the processing circuitry 3000 which has read each program has each function shown in the processing circuitry 3000 of FIG. 34.

While FIG. 34 assumes that the single processing circuitry 3000 realizes each processing function to be described below, processing circuitry may be constituted by a combination of a plurality of independent processors each running a program to realize the respective function.

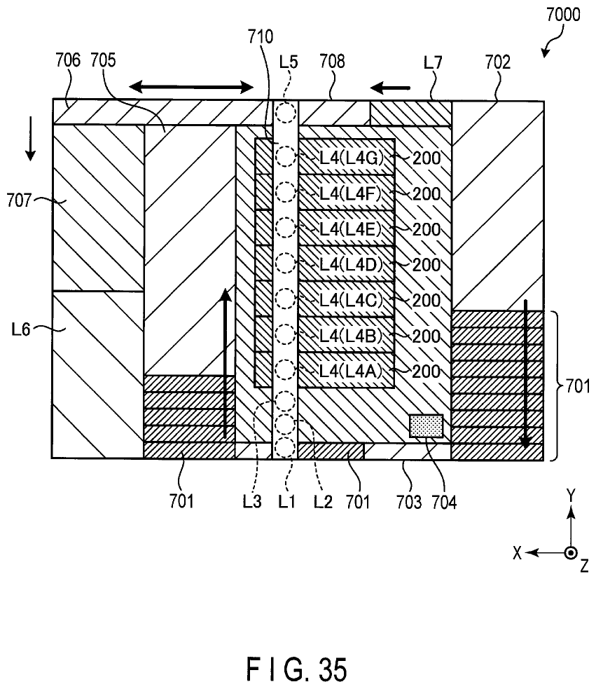

FIG. 35 is a diagram showing an example of a configuration of the analysis apparatus 7000 in the automatic analyzer 1 according to the present embodiment.

The analysis apparatus 7000 includes a rack arrangement part 702, a sampling lane 703, and a reading part 704.

The rack arrangement part 702 is a lane into which a sample rack 701, which holds a plurality of sample containers before they are sampled, is loaded. The rack arrangement part 702 moves the loaded sample rack 701 into the sampling lane 703. The movement of the sample rack 701 in the rack arrangement part 702 is realized by, but not limited to, for example, a conveyor belt.

An optical label containing identification information (e.g., a rack ID) for identifying it as a rack containing sample containers is added to the sample rack 701. Also, each of the sample containers held by the sample rack 701 is given an optical label containing identification information (e.g., patient information, a sample ID, a test item, the presence or absence of a retest, etc.) for identifying a sample contained in the sample container. The optical label is, for example, a bar code.

The sampling lane 703, for example, moves the sample rack 701 that has been moved to the sampling lane 703 to a reading position of the reading part 704. The movement of the sample rack 701 in the sampling lane 703 is realized by, but not limited to, for example, a conveyor belt.

The reading part 704 reads the identification information from the optical label of the sample rack 701 that has been moved to the reading position. If the optical label is a bar code, the reading part 704 is, for example, a bar code reader. The reading part 704 outputs, as the read identification information, identification information of a sample such as patient information, a sample ID, and a test item and identification information of the sample rack 701 such as a rack ID to the processing circuitry 3000 of the processing apparatus 9000.

The sampling lane 703 moves the sample rack 701, whose identification information has been read, to a sample aspirating position L1. Specifically, the sampling lane 703 moves each of the sample containers held by the sample rack 701 to the sample aspirating position L1. The sampling lane 703 moves the sample rack 701 after sampling to a during-measurement rack placement part 705.

The analysis apparatus 7000 further includes a dispensing mechanism 710, a detergent storage part (not shown), and a washing tank (not shown). The dispensing mechanism 710 has a sampling probe rail (not shown), a sampling probe (not shown), and a sampling pump (not shown).

In the dispensing mechanism 710, the sampling probe is provided on the sampling probe rail, and the sampling pump is connected to the sampling probe via tubing or the like. For example, the sampling probe rail supports the sampling probe in such a manner that the sampling probe can be moved. For example, the sampling probe moves along the sampling probe rail between the sample aspirating position L1 and a sample aspirating position L5 to be described later, by driving of the drive apparatus 8000.

In a case where the sampling lane 703 moves the sample rack 701 to the sample aspirating position L1, the sampling probe performs dispensing of a sample in a sample container moved to the sample aspirating position L1 in the dispensing mechanism 710. Specifically, the sampling probe aspirates the sample in the sample container moved to the sample aspirating position L1 for each test item, and discharges the sample in an amount set as an analysis parameter for that test item to a measurement sheet located at a sample discharging position L4. The sampling pump causes the sampling probe to aspirate and discharge samples.

For example, the analysis apparatus 7000 is provided with a plurality of measurement sheets 7200 for performing potential measurement and colorimetric measurement. The measurement sheets 7200 are assigned sample discharging positions L4A to L4G, respectively, as the sample discharging positions L4. For example, the sample discharging positions L4 are provided between the sample aspirating position L1 and the sample aspirating position L5 to be described later. The measurement sheet 7200 and a mechanism for conveying the measurement sheet 7200 will be described later.

The analysis apparatus 7000 has a detergent storage part containing a detergent and a washing tank for washing the sampling probe. In the dispensing mechanism 710, the sampling probe is washed with a detergent at the end of each sample dispensing. Specifically, the sampling probe aspirates the detergent in the detergent storage part located at a detergent aspirating position L2, and performs washing by discharging of the detergent and aspirating of a washing water in the washing tank located at a washing position L3. For example, the detergent aspirating position L2 and the washing position L3 are located between the sample aspirating position L1 and the sample discharging position L4.

The analysis apparatus 7000 further includes the during-measurement rack placement part 705, a relay lane 706, a measurement-completed rack placement part 707, and a standby lane 708.

The during-measurement rack placement part 705 is a lane where a sample rack 701 housing a sample container whose sample is under measurement is moved, as a sample rack 701 from the sampling lane 703. For example, the during-measurement rack placement part 705 moves the sample rack 701 housing a sample container whose sample is under measurement to the relay lane 706. The relay lane 706 moves the sample rack 701 from the during-measurement rack placement part 705 to the measurement-completed rack placement part 707. The movement of the sample rack 701 in the during-measurement rack placement part 705 and the relay lane 706 is realized by, but not limited to, for example, a conveyor belt.

The measurement-completed rack placement part 707 is a lane that moves a sample rack 701 housing a sample container that has undergone a measurement operation. For example, the measurement-completed rack placement part 707 moves the sample rack 701 housing a sample container that has undergone a measurement operation to a rack collection position L6. The movement of the sample rack 701 in the measurement-completed rack placement part 707 is realized by, but not limited to, for example, a conveyor belt.

The standby lane 708 is a lane where a retest sample rack, which is a sample rack 701 holding a sample container to be retested, is temporarily retracted. The retest sample rack is temporarily retracted from the during-measurement rack placement part 705 to the standby lane 708 until a time when sampling is performed for retesting. If sampling is performed for retesting, the standby lane 708 moves the sample rack 701 to the sample aspirating position L5. Specifically, the standby lane 708 moves each of a plurality of sample containers held in the sample rack 701 to the sample aspirating position L5. The movement of the sample rack 701 in the standby lane 708 is realized by, but not limited to, for example, a conveyor belt.

The standby lane 708 also has an emergency analyte loading position L7. For example, the emergency analyte loading position L7 is a portion where a sample rack 701 which holds sample containers containing a sample related to an emergency analyte test or priority measurement is loaded. In a case where a sample rack 701 is loaded into the emergency analyte loading position L7 of the standby lane 708, the standby lane 708 moves the sample rack 701 loaded into the emergency analyte loading position L7 to the sample aspirating position L5 with priority over the sample rack 701 loaded into the rack placement part 702. Specifically, the standby lane 708 moves each of a plurality of sample containers held in the sample rack 701 to the sample aspirating position L5.

In a case where the standby lane 708 moves the sample rack 701 to the sample aspirating position L5, in the dispensing mechanism 710, the sampling probe dispenses the sample in the sample container moved to the sample aspirating position L5. Specifically, the sampling probe aspirates the sample in the sample container moved to the sample aspirating position L5 according to the test item, and discharges the sample in an amount set as an analysis parameter for that test item to a measurement sheet located at the sample discharging position L4.

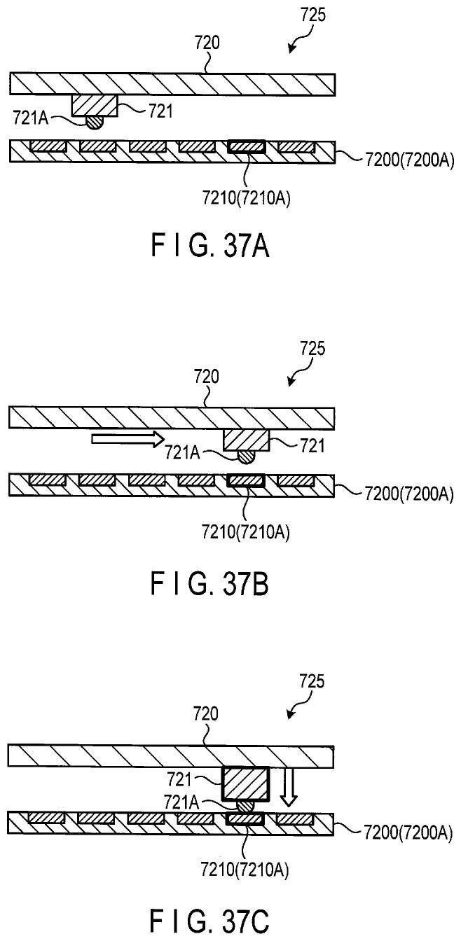

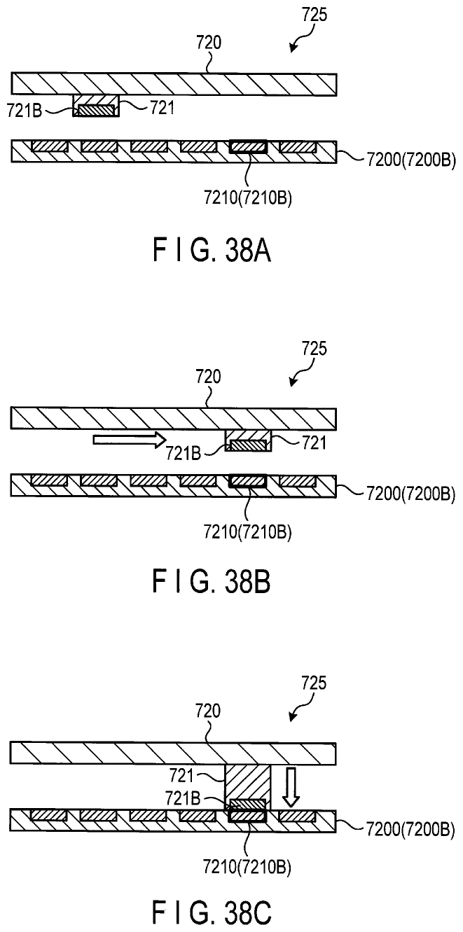

The analysis apparatus 7000 further includes a measurement mechanism 725 (see FIGS. 37A to 37C and FIGS. 38A to 38C). The measurement mechanism 725 has a measurement rail 720 and a measurement part 721. In FIG. 35, illustration of the measurement mechanism 725 is omitted.

The measurement rail 720 is provided with the measurement part 721. For example, the measurement rail 720 supports the measurement part 721 in such a manner that the measurement part 721 can be moved. For example, the measurement part 721 provided on the measurement rail 720 moves along the measurement rail 720 by driving of the drive apparatus 8000. The measurement part 721 performs measurement based on test items.

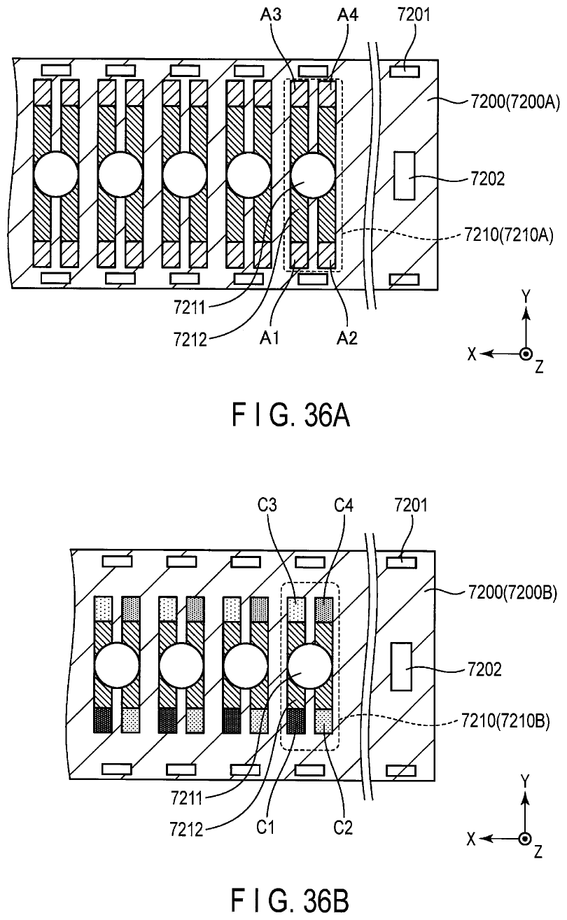

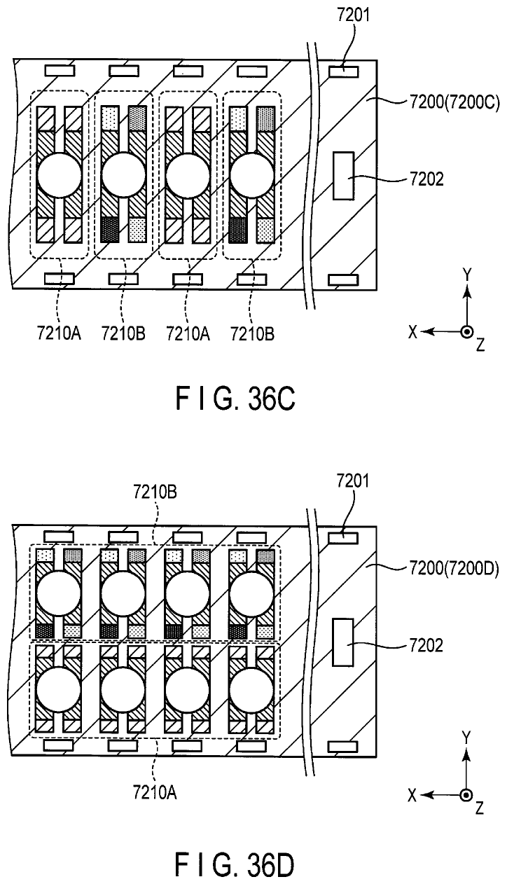

FIGS. 36A to 36D are diagrams showing an example of a measurement sheet 7200 according to the present embodiment. FIGS. 37A to 37C are diagrams showing an example of potential measurement using the measurement sheet 7200 in the present embodiment. FIGS. 38A to 38C are diagrams showing an example of colorimetric measurement using the measurement sheet 7200 in the present embodiment.

As shown in FIGS. 36A to 36D, the measurement sheet 7200 has a plurality of parts to be measured 7210. The part to be measured 7210 is an example of a measurement part.

The plurality of parts to be measured 7210 are arranged at equal intervals on the measurement sheet 7200. Each of the plurality of parts to be measured 7210 has a sampling position 7211 where a sample is discharged by a sampling probe, a plurality of measurement sites, and a flow channel 7212 that moves the sample from the sampling position 7211 to the plurality of measurement sites. The flow channel 7212 is composed of, for example, paper that moves a liquid by capillary action. The flow channel 7212 is not limited to paper, etc. as long as the sample can be moved to the plurality of measurement sites.

FIG. 36A shows a potential measurement sheet 7200A as an example of the measurement sheet 7200. In a part to be measured 7210A, which is a part to be measured 7210 of the measurement sheet 7200A, there are electrodes A1 to A4 as a plurality of measurement sites. For example, the flow channel 7212 moves a sample discharged to the sampling position 7211 to the electrodes A1 to A4. Here, in FIGS. 37A to 37C, the measurement part 721 of the measurement mechanism 725 has a connection section 721A, and after the sample is sampled at the sampling position 7211, the measurement part 721 performs potential measurement according to a test item by connecting a target electrode by the connection section 721A. For example, in a case of measuring electrolytes in blood as a component to be measured in the sample, ion-selective electrodes such as sodium (Na) ion, potassium (K) ion, and chloride (Cl) ion are used as the electrodes A2 to A4. In this case, the electrode A1 is used as a reference electrode (Ref), and the electrodes A2, A3, and A4 are ion-selective electrodes (Cl, Na, and K) as working electrodes, respectively.

For example, in the measurement mechanism 725, the measurement part 721 is provided on the measurement sheet 7200 and moves along the measurement rail 720 by driving of the drive apparatus 8000, as shown in FIG. 37A. Specifically, as shown in FIG. 37B, the measurement part 721 moves to a part to be measured 7210 as a test target above the measurement sheet 7200. For example, in FIG. 37C, the measurement part 721 calculates a concentration of sodium ions by the connection section 721A measuring a potential between the electrodes A1 and A2. The measurement part 721 also calculates a concentration of potassium ions by the connection section 721A measuring a potential between the electrodes A1 and A3. The measurement part 721 calculates a concentration of chloride ions by the connection section 721A measuring a potential between the electrodes A1 and A4.

FIG. 36B shows a colorimetric measurement sheet 7200B as an example of the measurement sheet 7200. In a part to be measured 7210B, which is a part to be measured 7210 of the colorimetric measurement sheet 7200B, there are colorimetric reaction sections C1 to C4, each holding a reagent, as a plurality of measurement sites. For example, a flow channel 7212 moves a sample discharged at a sampling position 7211 to the colorimetric reaction sections C1 to C4. Here, in FIGS. 38A to 38C, the measurement part 721 of the measurement mechanism 725 has an imaging section 21B, and after a sample is sampled at the sampling position 7211, the measurement part 721 performs colorimetric measurement according to a test item by having the imaging section 21B photograph a target reaction. In a case of checking for the presence or absence of a colorimetric reaction, such as coloration or discoloration to a specific reagent, as a component to be measured in a sample, the colorimetric reaction sections C1 to C4 are used as a colorimetric reaction measurement. In this case, respective reagents are held in the colorimetric reaction sections C1 to C4.

For example, in the measurement mechanism 725, the measurement part 721 is provided above the measurement sheet 7200 and moves along the measurement rail 720 by driving of the drive apparatus 8000, as shown in FIG. 38A. Specifically, as shown in FIG. 38B, the measurement part 721 moves to a part to be measured 7210 as a test target above the measurement sheet 7200. In FIG. 38C, the measurement part 721 checks for the presence or absence of a colorimetric reaction such as coloration or discoloration to the reagents in the colorimetric reaction sections C1 to C4 holding the respective reagents by having the imaging section 21B photograph the colorimetric reaction sections C1 to C4.

Here, FIGS. 36C and 36D show measurement sheets 7200C and 7200D that can perform potential measurement and colorimetric measurement as examples of the measurement sheet 7200. For example, as parts to be measured 7210 of the potential measurement sheet 7200C, a part to be measured 7210A that can perform potential measurement and a part to be measured 7210B that can perform colorimetric measurement may be arranged alternately as shown in FIG. 36C, or as parts to be measured 7210 of the potential measurement sheet 7200D, parts to be measured 7210A and measured parts 7210B may be arranged in parallel as shown in FIG. 36D.

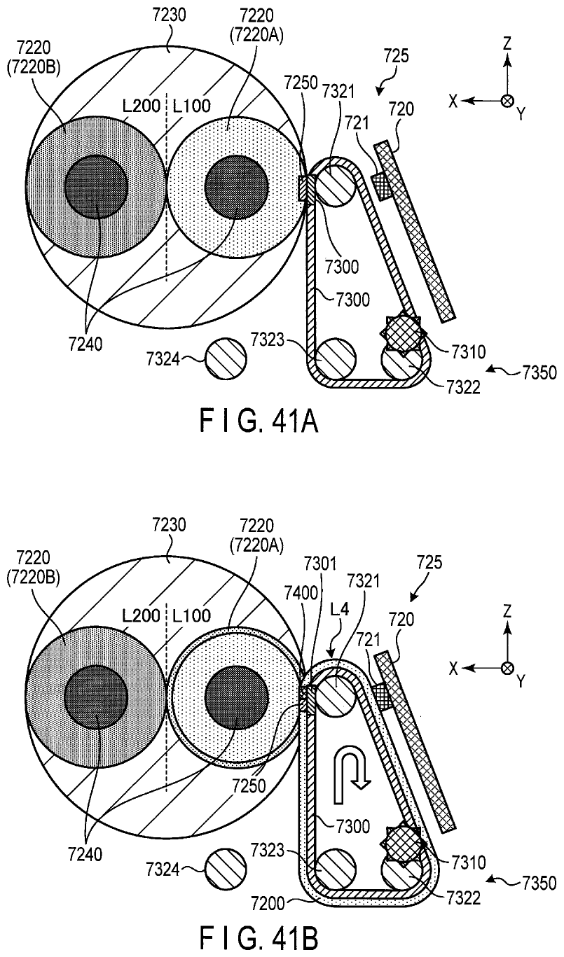

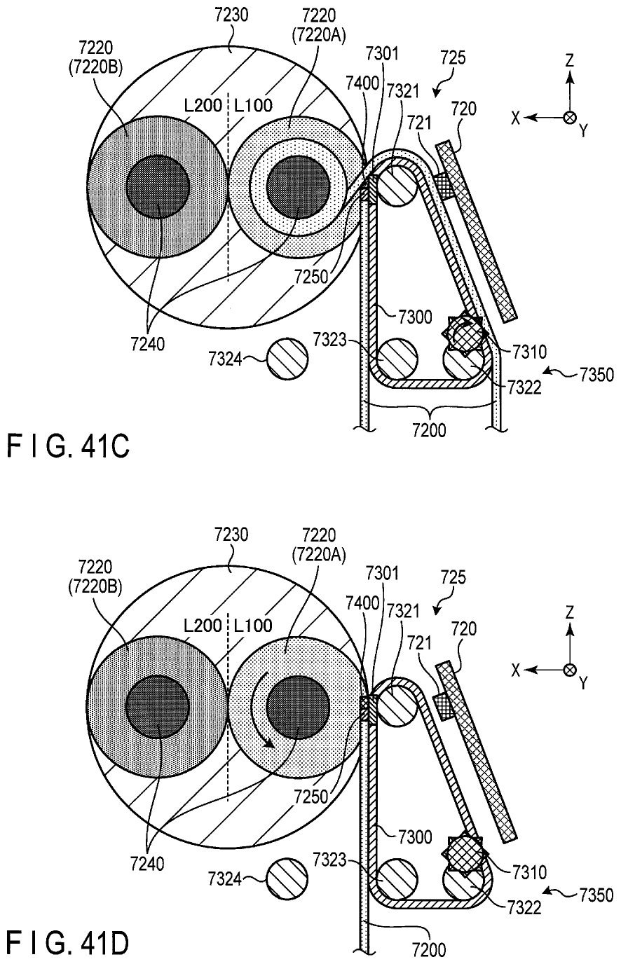

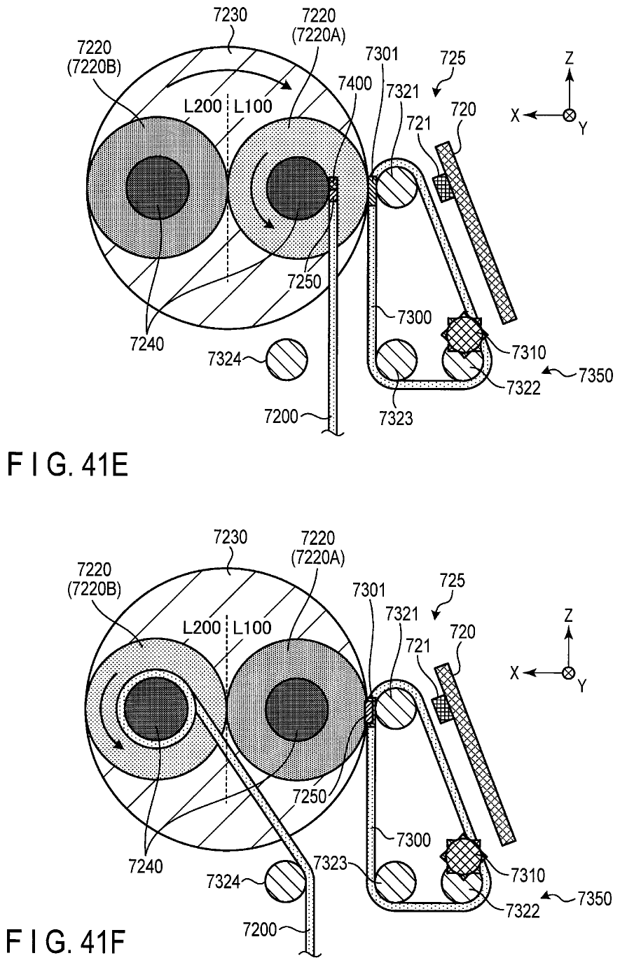

As shown in FIGS. 36A to 36D, the measurement sheet 7200 further has a sheet feed connection part 7201 and a sheet distal end connection part 7202. The sheet feed connection parts 7201 are arranged at the same intervals as those of the parts to be measured 7210 on the measurement sheet 7200. The sheet feed connection parts 7201 are connected to a sheet feed part 7310 (see FIG. 41A) of a sheet conveyor mechanism 7350 to be described later. For example, the sheet feed connection parts 7201 are holes drilled at equal intervals, and the sheet feed part 7310 is a gear whose teeth fit into the holes of the sheet feed connection parts 7201, etc. The structure is not limited to a hole or gear configuration as long as it is capable of feeding the measurement sheet 7200. The sheet distal end connection part 7202 is provided at a distal end of the measurement sheet 7200 on the measurement sheet 7200. The sheet tip connection part 7202 is connected to a sheet conveyance part 7300 (see FIG. 41A) of the sheet conveyor mechanism 7350 to be described later via a sheet collection mechanism connection part 7250 (see FIG. 41A) to be described later, and the measurement sheet 7200 is pulled out by an operation of the sheet conveyance part 7300. Examples of the sheet distal end connection part 7202 include structures such as a magnet and a hook-and-loop fastener.

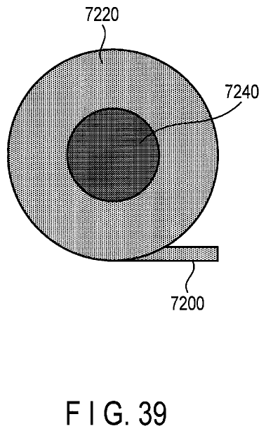

FIG. 39 is a diagram showing an example of a measurement cartridge 7220 in the present embodiment.

The analysis apparatus 7000 further includes the measurement cartridge 7220. As described above, the analysis apparatus 7000 is provided with the plurality of measurement sheets 7200 for performing potential measurement and colorimetric measurement, and the plurality of parts to be measured 7210 for measuring a measurement target component in a sample are arranged on each of the measurement sheets 7200. For example, as shown in FIG. 39, the measurement cartridge 7220 has the measurement sheet 7200 described above and a core part 7240, which is the center of the measurement cartridge 7220, with the measurement sheet 7200 rewound around the core part 7240. That is, the measurement cartridge 7220 houses the measurement sheet 7200 in a roll shape. A material of the measurement cartridge 7220 is, for example, polyethylene or polypropylene. The material is not limited to polyethylene or polypropylene as long as it can house the measurement sheet 7200.

In this way, since the automatic analyzer 1 according to the present embodiment uses the measurement cartridge 7220 having the measurement sheet 7200 containing a reagent in advance, a reagent bottle that contains a reagent, a reagent depository that holds the reagent bottle, a reagent dispensing probe that dispenses the reagent in the reagent bottle, a reagent dispensing arm, and a reagent dispensing pump to dispense the reagent to the reagent dispensing probe are no longer necessary. In addition, the automatic analyzer 1 according to the present embodiment eliminates the need for a stirring unit to stir a sample and a reagent with an agitator, and a washing unit to wash the reagent dispensing probe and agitator. Thus, the automatic analyzer 1 according to the present embodiment can be downsized. In addition, since the automatic analyzer 1 according to the present embodiment does not use a reagent dispensing probe, carryover does not occur.

However, in a case of using the measurement cartridge 7220 having the measurement sheet 7200, in order to dispose of a used measurement sheet 7200, the user needs to collect the measurement sheet 7200 to be disposed of. Here, the user may become infected when collecting the measurement sheet 7200 to be disposed of, due to contact with samples adhering to that measurement sheet 7200, etc. In a case of using the measurement cartridge 7220 having the measurement sheet 7200, the measurement efficiency is reduced because measurement is not resumed until the user replaces a used measurement cartridge 7220 with a measurement cartridge 7220 having a measurement sheet 7200 before use.

Accordingly, the automatic analyzer 1 according to the present embodiment is formed as follows to reduce the risk of infection and improve the measurement efficiency. The automatic analyzer 1 according to the present embodiment includes the measurement cartridge 7220, the dispensing mechanism 710, the measurement mechanism 725, the sheet conveyor mechanism, the cartridge conveyor mechanism, and the sheet collection mechanism. The measurement cartridge 7220 houses the roll-shaped measurement sheet 7200 on which the plurality of parts to be measured 7210 to measure a measurement target component in a sample are arranged. The dispensing mechanism 710 dispenses a sample into the parts to be measured 7210. The measurement mechanism 725 measures the sample dispensed into the parts to be measured 7210. The sheet conveyor mechanism pulls out the measurement sheet 7200 from the measurement cartridge 7220 in a measurement region, and conveys that measurement sheet 7200 to the dispensing mechanism 710 and the measurement mechanism 725. The cartridge conveyor mechanism conveys the measurement cartridge 7220 from the measurement region to a collection region that is different from the measurement region. The sheet collection mechanism collects a used measurement sheet 7200 into the measurement cartridge 7220 in the collection region.

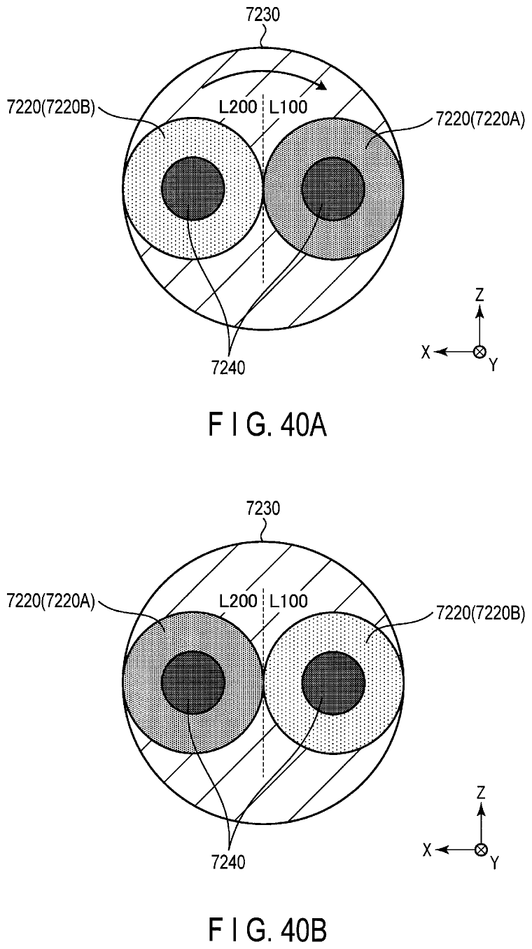

FIGS. 40A and 40B are diagrams showing an example of a cartridge conveyor mechanism 7230 in the present embodiment.

As shown in FIG. 40A, the analysis apparatus 7000 further includes the cartridge conveyor mechanism 7230. The cartridge conveyor mechanism 7230 holds a plurality of measurement cartridges 7220 in such a manner that the measurement cartridges 7220 can be rotated. Rotation of the measurement cartridge 7220 is realized by, but not limited to, a turntable. For example, the cartridge conveyor mechanism 7230 is provided with a measurement region L100 for pulling out a measurement sheet 7200 from the measurement cartridge 7220 and an installation region L200 for installing a new measurement cartridge 7220 that houses a measurement sheet 7200 before use. For example, measurement cartridges 7220A and 220B are installed in the measurement region. L100 and the installation region L200, respectively, as the measurement cartridges 7220. In the measurement region L100, for example, a measurement sheet 7200 of the measurement cartridge 7220A is pulled out in the measurement region L100 by a sheet conveyor mechanism 7350 to be described later, and the pulled out measurement sheet 7200 is conveyed to the dispensing mechanism 710 and the measurement mechanism 725. For example, a sample is dispensed into the parts to be measured 7210 of the measurement sheet 7200 by the dispensing mechanism 710, and potential measurement and colorimetric measurement are performed by the measurement mechanism 725.

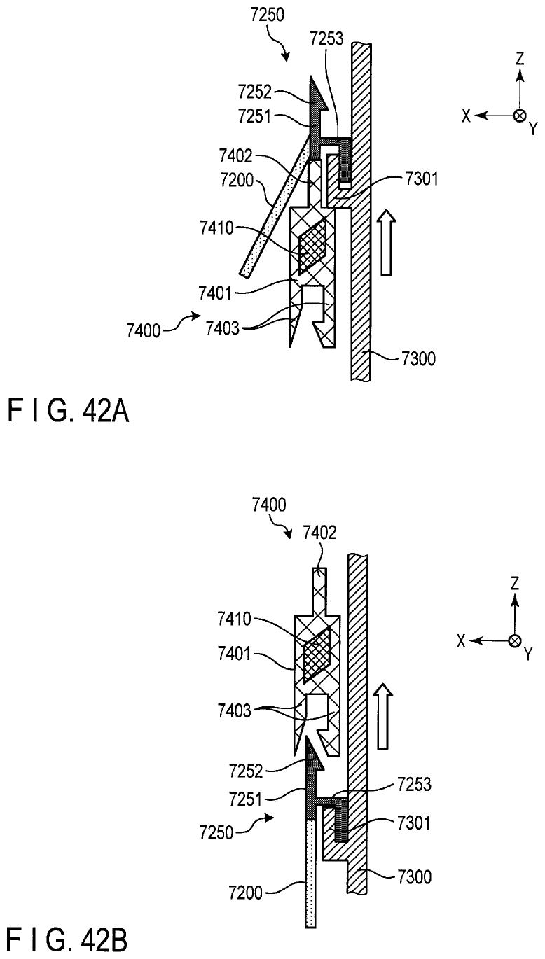

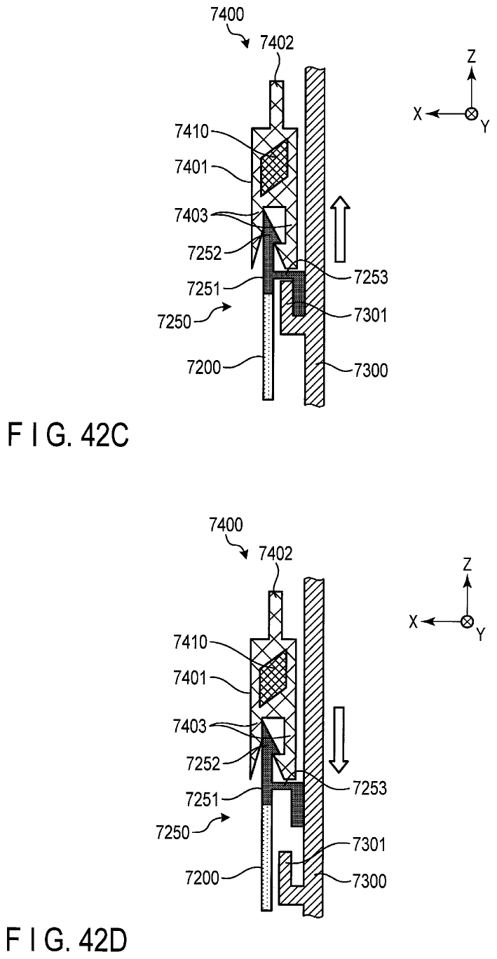

Here, in FIG. 40B, in a case of collecting a used measurement sheet 7200 of the measurement cartridge 7220A, the cartridge conveyor mechanism 7230 conveys the measurement cartridge 7220A from the measurement region L100 to the installation region L200 by rotating the measurement cartridges 7220A and 220B, and conveys a new measurement cartridge 7220B housing a measurement sheet 7200 before use from the installation region L200 to the measurement region L100. At this time, the installation region L200 is used as a collection region. For example, a used measurement sheet 7200 is collected in the measurement cartridge 7220A in the collection region by a sheet collection slide mechanism 7400 (see FIGS. 42 to 44) to be described later. The user then replaces the measurement cartridge 7220 having the used measurement sheet 7200 with the measurement cartridge 7220 having the measurement sheet 7200 before use in the installation region. L200. In this way, the user can dispose of the measurement cartridge 7220A having the used measurement sheet 7200 in the installation region L200 while the measurement sheet 7200 of the measurement cartridge 7220B is being used in the measurement region L100, and install the new measurement cartridge 7220 in the cartridge conveyor mechanism 7230.

FIGS. 41A to 41F are diagrams for explaining processing of the automatic analyzer 1 according to the present embodiment. As shown in FIGS. 41A to 41F, the analysis apparatus 7000 further includes a sheet collection mechanism connection part 7250, the sheet conveyor mechanism 7350, and the sheet collection slide mechanism 7400. In FIGS. 41A and 41F, illustration of the sheet collection slide mechanism 7400 is omitted. The sheet collection slide mechanism 7400 is an example of a sheet collection mechanism.

The sheet conveyor mechanism 7350 has a sheet conveyance part 7300, a sheet feed part 7310, and guide parts 7321 to 7324. The sheet feed part 7310 is provided at a position corresponding to the sheet feed connection parts 7201 of the measurement sheet 7200, and is, for example, a gear whose teeth fit into the holes of the sheet feed connection parts 7201. The sheet conveyance part 7300 has a connection part 7301 for conveying the measurement sheet 7200. For example, the sheet conveyance part 7300 is a belt conveyor. The structure is not limited to a belt conveyor as long as it is capable of conveying the measurement sheet 7200. The guide parts 7321 to 7323 are used when conveying the measurement sheet 7200 from the measurement cartridge 7220 in the measurement region L100, and the guide part 7324 is used when collecting the measurement sheet 7200.

FIGS. 42A to 42D are diagrams for explaining the sheet collection mechanism connection part 7250 and the sheet collection slide mechanism 7400 in the present embodiment. As shown in FIGS. 42A to 42D, the sheet collection mechanism connection part 7250 has a body part 7251 and connection parts 7252 and 7253 in the body part 7251. The body part 7251 is provided with the connection parts 7252 and 7253. The sheet collection mechanism connection part 7250 is provided at the distal end of the measurement sheet 7200. Specifically, as shown in FIG. 42A, the body part 7251 of the sheet collection mechanism connection part 7250 is connected to the sheet distal end connection part 7202 provided at the distal end of the measurement sheet 7200.

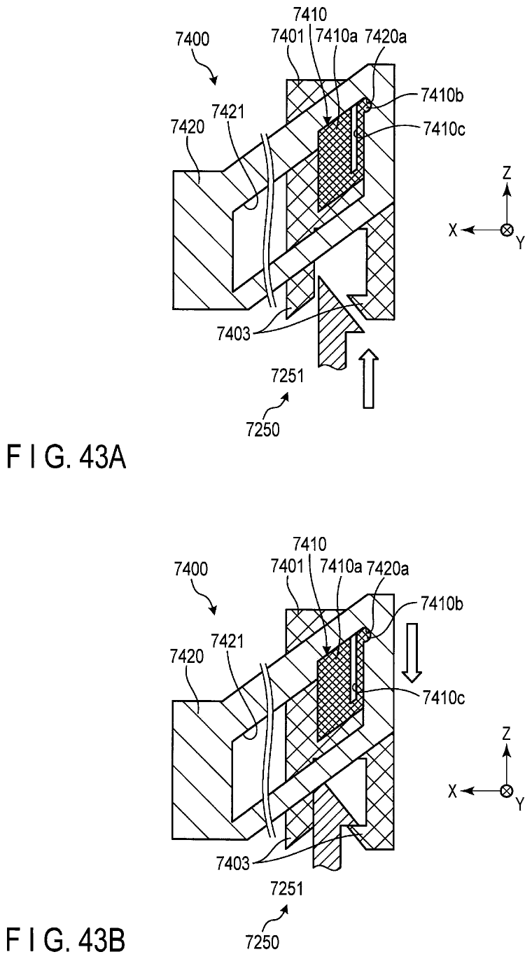

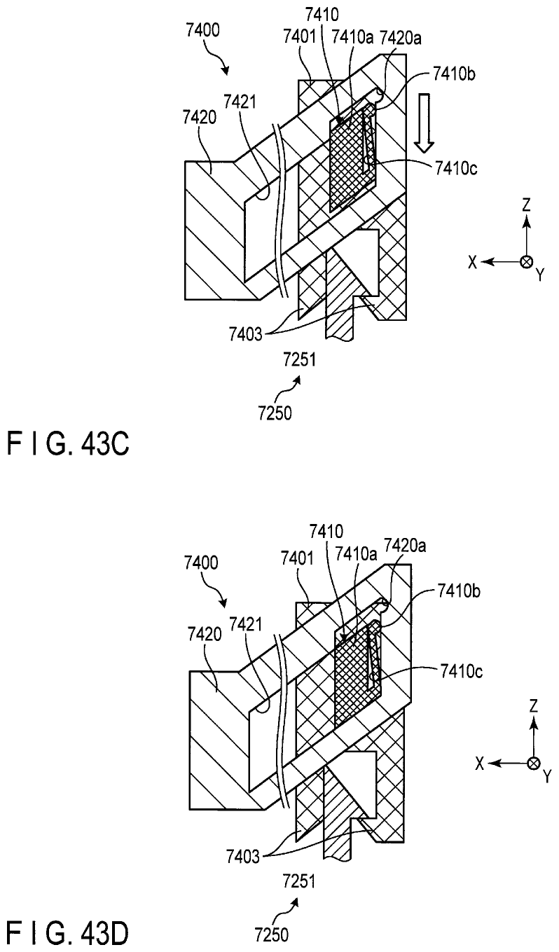

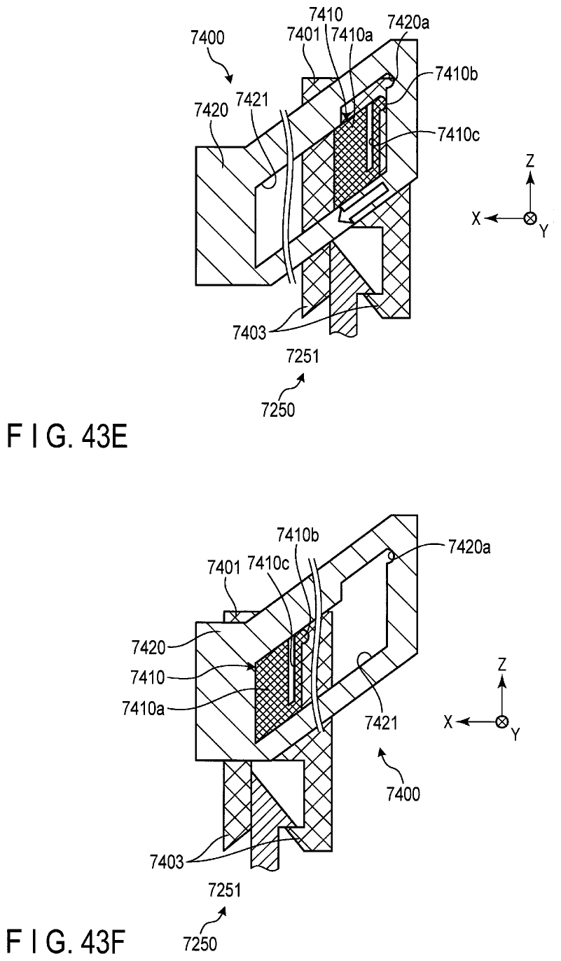

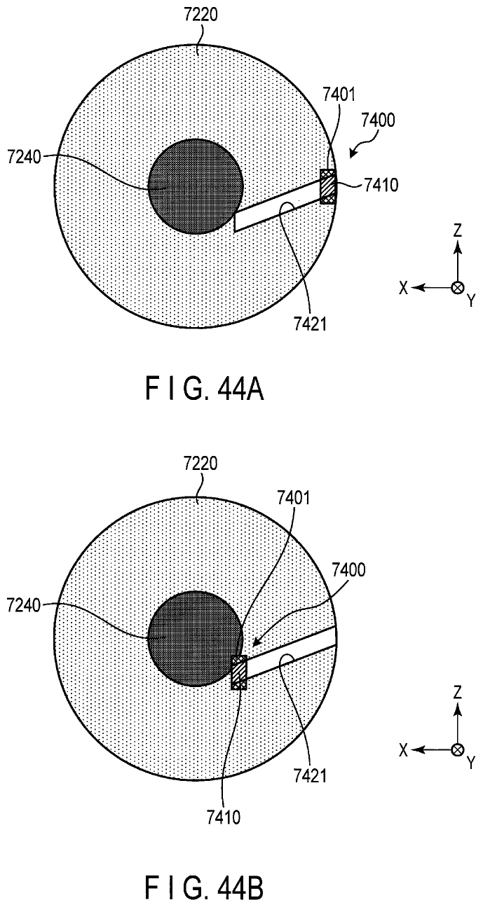

FIGS. 43A to 43F, 44A, and 44B are diagrams for explaining the sheet collection slide mechanism 7400 in the present embodiment. The sheet collection slide mechanism 7400 is connected to the sheet collection mechanism connection part 7250, and collects a used measurement sheet 7200 into the measurement cartridge 7220A on the cartridge conveyor mechanism 7230. The sheet collection slide mechanism 7400 has a body part 7401, connection parts 7402 and 7403, a slide guide 7410, and a slide guide support part 7420. Here, illustrations of the slide guide support part 7420 and a slide rail 7421 are omitted in FIGS. 42A to 42D. In FIGS. 43A to 43F, illustration of the connection part 7402 is omitted. In FIGS. 44A and 44B, illustrations of the connection parts 7402 and 7403 and the slide guide support part 7420 are omitted.

The body part 7401 is provided with the connection parts 7402 and 7403 and the slide guide 7410. As shown in FIG. 42A, the body part 7251 of the sheet collection mechanism connection part 7250 is connected to the connection part 7402. Connection between the body part 7251 and the connection part 7402 is realized by, but not limited to, a magnet and a hook-and-loop fastener. As shown in FIG. 44A, the slide guide support part 7420 is a member that extends from a portion from which the measurement sheet 7200 is pulled out from the measurement cartridge 7220 to the core part 7240 of the measurement cartridge 7220. As shown in FIGS. 43A and 44A, the slide rail 7421, which is a groove into which the slide guide 7410 can slide, is formed at a center portion of the slide guide support part 7420. An orientation of the slide rail 7421 is inclined with respect to the horizontal direction, and the slide rail 7421 slopes downward from a beginning to an end. In FIG. 43A, the slide guide 7410 is locked to the slide guide support part 7420. Specifically, the slide guide support part 7420 is provided with a groove part 7420a on the beginning side of the slide rail 7421, and the slide guide 7410 includes a slide guide body 7410a, a protrusion 7410b provided on the slide guide body 7410a, and a notch 7410c. The protrusion 7410b is fitted into the groove 7420a of the slide guide support part 7420 so that the slide guide 7410 and the slide guide support part 7420 are locked together. The slide guide 7410 and the slide guide support part 7420 are members for guiding a used measurement sheet 7200 to the core part 7240, which is the center of the measurement cartridge 7220A, on the cartridge conveyor mechanism 7230.

Processing of the automatic analyzer 1 according to the present embodiment will be described with reference to FIGS. 41A to 41F, 42A to 42C, 43A to 43F, 44A, and 44B.

First, in FIG. 41A, for example, two measurement cartridges 7220, the measurement cartridges 7220A and 7220B, are installed in the cartridge conveyor mechanism 7230. The measurement cartridge 7220A is arranged in the measurement region L100, and the measurement cartridge 7220B is arranged in the installation region L200. Here, in FIG. 42A, by rotating the sheet conveyance part 7300 of the sheet conveyor mechanism 7350 clockwise by driving of the drive apparatus 8000, the connection part 7253 of the sheet collection mechanism connection part 7250 provided at the distal end of the measurement sheet 7200 housed in the measurement cartridge 7220A is connected to the connection part 7301 of the sheet conveyance part 7300.

Next, in FIG. 41B, for example, by further clockwise rotation of the sheet conveyance part 7300 of the sheet conveyor mechanism 7350 by driving of the drive apparatus 8000, the connection between the body part 7251 of the sheet collection mechanism connection part 7250 and the connection part 7402 of the sheet collection slide mechanism 7400 is released, and the measurement sheet 7200 is pulled out from the measurement cartridge 7220A in the measurement region L100. Here, the pulled-out measurement sheet 7200 is conveyed to the dispensing mechanism 710 and the measurement mechanism 725. Specifically, the dispensing mechanism 710 discharges a sample to a part to be measured 7210 of the measurement sheet 7200 that is located at the sample discharging position L4, and the measurement mechanism 725 performs potential measurement and colorimetric measurement as measurement based on test items.

FIG. 41B also shows, for example, a state in which the measurement sheet 7200 pulled out from the measurement cartridge 7220A in the measurement region L100 is returned from a position where the measurement sheet 7200 is pulled out back to the same position via the guide parts 7321 to 7323 by further clockwise rotation of the sheet conveyance part 7300 of the sheet conveyor mechanism 7350 by driving of the drive apparatus 8000. That is, FIG. 41B shows a state in which the measurement sheet 7200 pulled from the measuring cartridge 7220A in the measurement region L100 has made one round and returned to that position from the state of FIG. 41A to enter the state of FIG. 41B.

At this time, as shown in FIGS. 42B, 42C, 43A, and 43B, the connection part 7252 of the sheet collection mechanism connection part 7250 provided at the distal end of the measurement sheet 7200 is connected to the connection part 7403 of the sheet collection slide mechanism 7400. Here, in FIG. 42D, for example, connection between the connection part 7301 of the sheet conveyance part 7300 and the connection part 7253 of the sheet collection mechanism connection part 7250 is released by rotating the sheet conveyance part 7300 of the sheet conveyor mechanism 7350 counterclockwise by driving of the drive apparatus 8000.

Next, in FIG. 41C, for example, the measurement sheet 7200 is fed by clockwise rotation of the sheet feed part 7310 of the sheet conveyor mechanism 7350 by driving of the drive apparatus 8000. The measurement sheet 7200 fed by the sheet feed part 7310 is conveyed to the dispensing mechanism 710 and the measurement mechanism 725, and once there, it is housed in a container (not shown).

Next, in FIG. 41D, for example, all of the measurement sheet 7200 is fed by further clockwise rotation of the sheet feed part 7310 of the sheet conveyor mechanism 7350 by driving of the drive apparatus 8000, and the fed measurement sheet 7200 is conveyed to the dispensing mechanism 710 and the measurement mechanism 725.

As described above, the protrusion 7410b of the slide guide 7410 and the groove 7420a of the slide guide support part 7420 are locked together. Here, as shown in FIGS. 43B to 43D, the lock between the protrusion 7410b of the slide guide 7410 and the groove 7420a of the slide guide support part 7420 is released when the slide guide 7410 is deformed by the notch 7410c.

For example, the following four patterns can be used to release the lock between the protrusion 7410b of the slide guide 7410 and the groove 7420a of the slide guide support part 7420.

In the first and second patterns, for example, the slide guide 7410 is deformed by the notch 7410c by moving the slide guide 7410 when the measurement sheet 7200 is fed, thereby releasing the lock between the protrusion 7410b of the slide guide 7410 and the groove 7420a of the slide guide support part 7420.

Specifically, in the first pattern, in FIG. 42D, the connection between the connection part 7301 of the sheet conveyance part 7300 and the connection part 7253 of the sheet collection mechanism connection part 7250 is released while the sheet collection slide mechanism 7400 and the sheet collection mechanism connection part 7250 are pulled downward (e.g., in a direction opposite to the Z direction in FIG. 42D) together with the sheet conveyance part 7300 by counterclockwise rotation of the sheet conveyance part 7300 of the sheet conveyor mechanism 7350 by driving of the drive apparatus 8000. Here, when the slide guide 7410 is displaced downward in the process of pulling the sheet collection slide mechanism 7400 and the sheet collection mechanism connection part 7250 downward, the slide guide 7410 is deformed by the notch 7410c, as shown in FIGS. 43B to 43D, which releases the lock between the protrusion 7410b of the slide guide 7410 and the groove 7420a of the slide guide support part 7420.

In the second pattern, first, in FIG. 42D, the connection between the connection part 7301 of the sheet conveyance part 7300 and the connection part 7253 of the sheet collection mechanism connection part 7250 is released while the sheet collection slide mechanism 7400 and the sheet collection mechanism connection part 7250 are pulled downward (e.g., in the direction opposite to the Z direction in FIG. 42D) together with the sheet conveyance part 7300 by counterclockwise rotation of the sheet conveyance part 7300 of the sheet conveyor mechanism 7350 by driving of the drive apparatus 8000. Then, further, by counterclockwise rotation of the sheet conveyance part 7300 of the sheet conveyor mechanism 7350 by driving of the drive apparatus 8000, the connection part 7301 of the sheet conveyance part 7300 is returned from a position where the slide guide 7410 is provided to that position through the guide parts 7323 to 7321. At this time, the connection part 7301 of the sheet conveyance part 7300 is brought into contact with the protrusion 7410b of the slide guide body 7410a. Here, when the slide guide 7410 is displaced downward in the process of the connection part 7301 of the sheet conveyance part 7300 contacting the protrusion 7410b of the slide guide body 7410a, the slide guide 7410 is deformed by the notch 7410c as shown in FIGS. 43B to 43D, which releases the lock between the protrusion 7410b of the slide guide 7410 and the groove 7420a of the slide guide support part 7420.

In a third pattern, for example, in a case where all of the measurement sheet 7200 has been fed, an arm (not shown) moves the slide guide 7410 to deform the slide guide 7410 by means of the notch 7410c to release the lock between the protrusion 7410b of the slide guide 7410 and the groove 7420a of the slide guide support part 7420.

Specifically, in the third pattern, in a case where all of the measurement sheet 7200 has been fed, an arm (not shown) displaces the slide guide 7410 downward (e.g., in a direction opposite to the Z direction in FIG. 43B) by driving of the drive apparatus 8000. Here, when the slide guide 7410 is displaced downward, the slide guide 7410 is deformed by the notch 7410c, as shown in FIGS. 43B to 43D, which releases the lock between the protrusion 7410b of the slide guide 7410 and the groove 7420a of the slide guide support part 7420.

In a fourth pattern, for example, when all of the measurement sheet 7200 has been fed, the slide guide support part 7420 is moved, while the slide guide 7410 is fixed, to deform the slide guide 7410 by the notch 7410c to release the lock between the protrusion 7410b of the slide guide 7410 and the groove 7420a of the slide guide support part 7420.

Specifically, in the fourth pattern, by driving of the drive apparatus 8000, the slide guide 7410 is first restrained from moving in an upward direction (e.g., in the Z direction in FIG. 43A), either by an arm (not shown) fixing the slide guide 7410 or by an arm (not shown) fixing the measurement sheet 7200 in a state where the sheet collection slide mechanism 7400 having the slide guide 7410 and the sheet collection mechanism connection part 7250 are connected together. Alternatively, the weight of that measurement sheet restrains the upward movement of the slide guide 7410. In FIG. 41D, all of the measurement sheet 7200 is fed by clockwise rotation of the sheet feed part 7310 of the sheet conveyor mechanism 7350 by driving of the drive apparatus 8000, and the fed measurement sheet 7200 is conveyed to the dispensing mechanism 710 and the measurement mechanism 725. Then, by driving of the drive apparatus 8000, an arm (not shown) shifts the slide guide support part 7420 upward while fixing the slide guide 7410. Here, when the slide guide support part 7420 shifts upward, as shown in FIGS. 43B to 43D, the slide guide 7410 is deformed by the notch 7410c, which releases the lock between the protrusion 7410b of the slide guide 7410 and the groove 7420a of the slide guide support part 7420. The drive apparatus 8000 then releases the fixing of the slide guide 7410 by the arm (not shown).

In a case where the lock between the protrusion 7410b of the slide guide 7410 and the groove 7420a of the slide guide support part 7420 is released by any one of the above four patterns, the slide guide 7410 is led to the beginning of the slide rail 7421 formed on the slide guide support part 7420, as shown in FIG. 43E. Here, the slide rail 7421 slopes downward from the beginning to the end, so the slide guide 7410 slides on the slide rail 7421 from the position where the measurement sheet 7200 is pulled out to the core part 7240 of the measurement cartridge 7220A, as shown in FIGS. 41E, 43E, 43F, 44A, and 44B. In this way, the slide guide 7410 and the slide guide support part 7420 slide a distal end portion of a used measurement sheet 7200 on the cartridge conveyor mechanism 7230, guiding that distal end portion to the core part 7240, which is the center of the measurement cartridge 7220A.

Next, in FIG. 41E, for example, the measurement cartridges 7220A and 7220B on the cartridge conveyor mechanism 7230 are rotated by driving of the drive apparatus 8000. At this time, in FIG. 41F, the used measurement sheet 7200 of the measurement cartridge 7220A is collected in the collection region, which is the installation region L200, by counterclockwise rotation of the core part 7240 of the measurement cartridge 7220A, for example, by driving of the drive apparatus 8000. That is, the cartridge conveyor mechanism 7230 conveys the measurement cartridge 7220A from the measurement region L100 to the installation region L200 by rotation of the measurement cartridges 7220A and 7220B, and causes the sheet collection slide mechanism 7400 to collect the used measurement sheet 7200 into the measurement cartridge 7220A in the installation region L200. At this time, the sheet collection slide mechanism 7400 collects the used measurement sheet 7200 into the measurement cartridge 7220A by rewinding the used measurement sheet 7200 starting from the center of the measurement cartridge 7220A in the installation region L200.

For example, the user replaces the measurement cartridge 7220 having the used measurement sheet 7200 with a measurement cartridge 7220 having a measurement sheet 7200 before use in the installation region L200 while the measurement sheet 7200 of the measurement cartridge 7220B is being used. In this way, the user can dispose of the measurement cartridge 7220A having the used measurement sheet 7200 while the measurement sheet 7200 of the measurement cartridge 7220B is being used, and install a new measurement cartridge 7220 in the cartridge conveyor mechanism 7230 in the installation region L200.

As described above, in the automatic analyzer 1 according to the present embodiment, the sheet conveyor mechanism 7350 pulls out a measurement sheet 7200 from the measurement cartridge 7220A in the measurement region L100 and conveys that measurement sheet 7200 to the dispensing mechanism 710 and the measurement mechanism 725. The cartridge conveyor mechanism 7230 conveys the measurement cartridge 7220A from the measurement region L100 to the installation region L200, and the sheet collection slide mechanism 7400 collects the used measurement sheet 7200 into the measurement cartridge 7220A in the installation region L200. For example, the installation region L200 is used as a collection region for collecting used measurement sheets 7200. In the collection region, the sheet collection slide mechanism 7400 slides the distal end portion of the used measurement sheet 7200 to the core part 7240, which is the center of the measurement cartridge 7220A, to guide that distal end portion to the core part 7240, and collects the used measurement sheet 7200 into the measurement cartridge 7220A.

In this way, the automatic analyzer 1 according to the present embodiment collects the used measurement sheet 7200 into the measurement cartridge 7220A, thus reducing the risk of infection due to reasons such as the user coming into contact with samples adhering to a measurement sheet 7200 when disposing of it. The automatic analyzer 1 according to the present embodiment automatically collects a used measurement sheet 7200 into the measurement cartridge 7220A, thus saving the user the trouble of collecting the used measurement sheet 7200.

In addition, in the automatic analyzer 1 according to the present embodiment, by collecting the used measurement sheet 7200 in the installation region L200, which is provided separately from the measurement region L100, the user can dispose of the measurement cartridge 7220A having the used measurement sheet 7200 and install a new measurement cartridge 7220 in the cartridge conveyor mechanism 7230 in the installation region L200 while the measurement sheet 7200 of the measurement cartridge 7220B is being used. That is, the measurement efficiency is improved because the user does not need to interrupt the measurement when replacing a used measurement cartridge 7220 with a measurement cartridge 7220 having a measurement sheet 7200 before use.

### OTHER EMBODIMENTS

The embodiments described so far may be implemented in a variety of different forms in addition to those described above.

Modifications of the present embodiment will be described below.

### First Modification of Third Embodiment

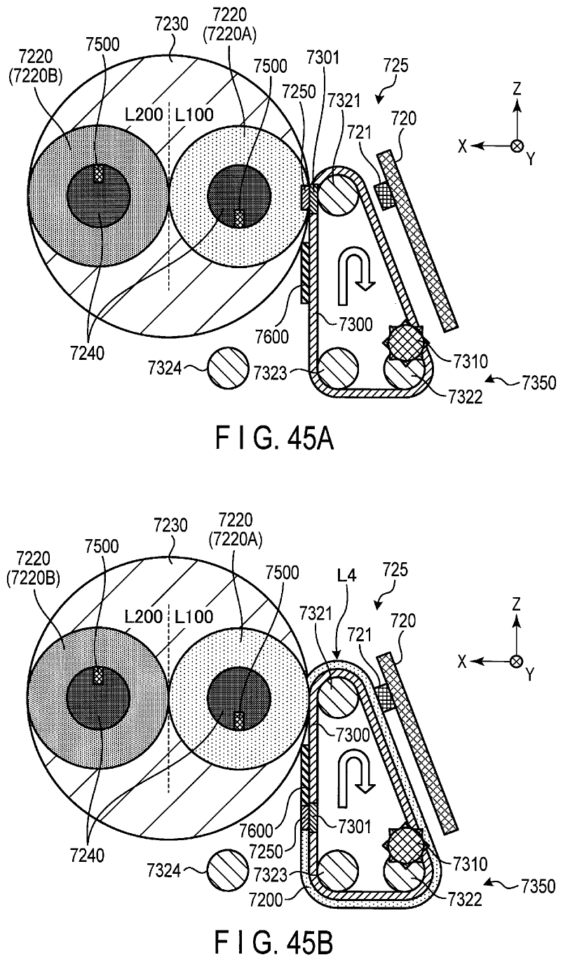

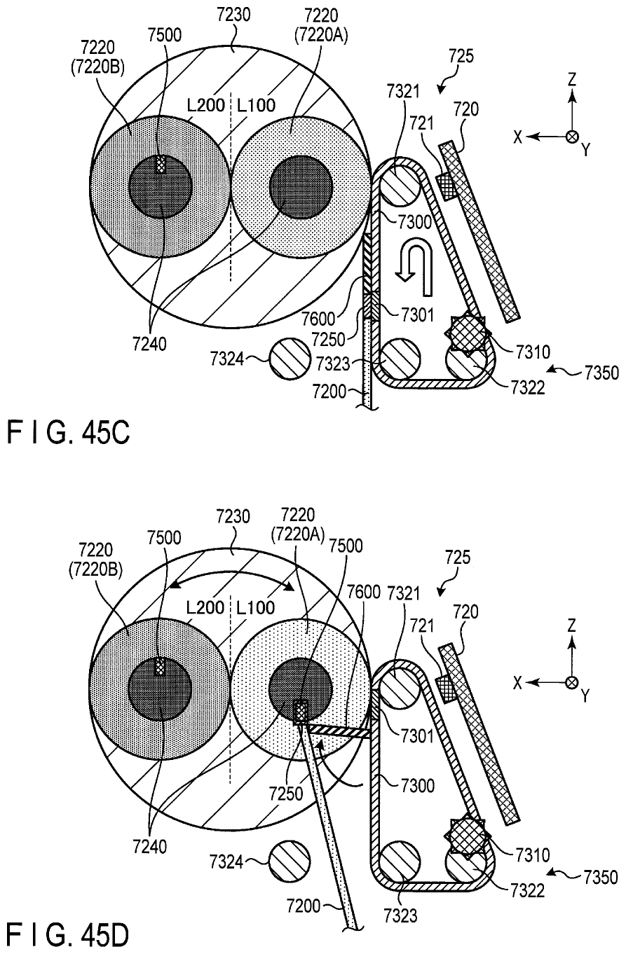

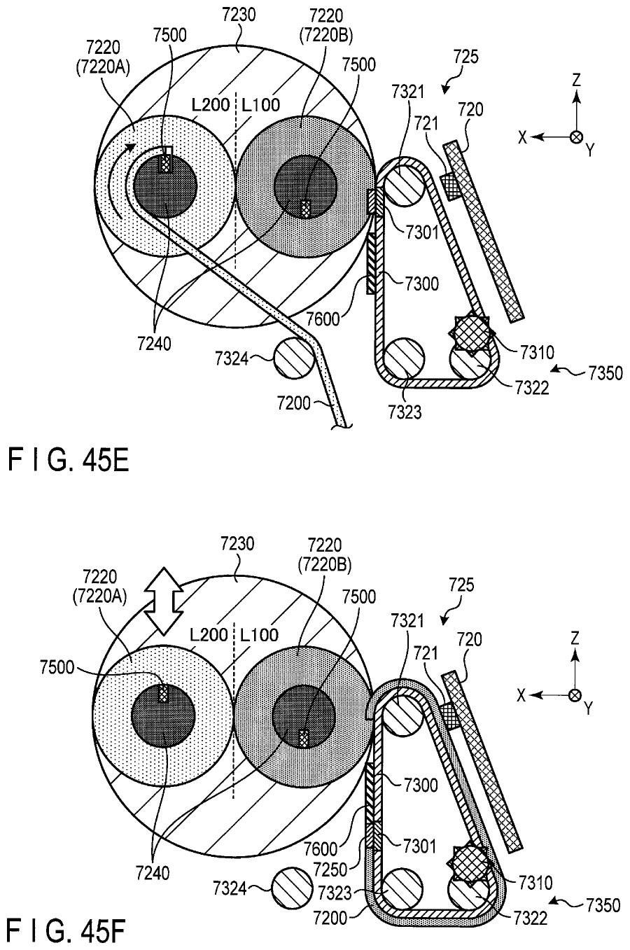

FIGS. 45A to 45F are diagrams for explaining processing of an automatic analyzer 1 according to a first modification of the present embodiment. In FIGS. 45A to 45F, the shape of the sheet collection mechanism connection part 7250 differs from that in the embodiment described above, with a sheet collection mechanism 7500 and a connection part conveyor mechanism 7600 instead of the sheet collection slide mechanism 7400 in the embodiment described above. For example, the sheet collection mechanism 7500 is provided in the core part 7240, which is the center of the measurement cartridge 7220, and the connection part conveyor mechanism 7600 is provided in the sheet conveyance part 7300 of the sheet conveyor mechanism 7350. The sheet collection mechanism 7500 and the connection part conveyor mechanism 7600 are examples of sheet collection mechanisms.

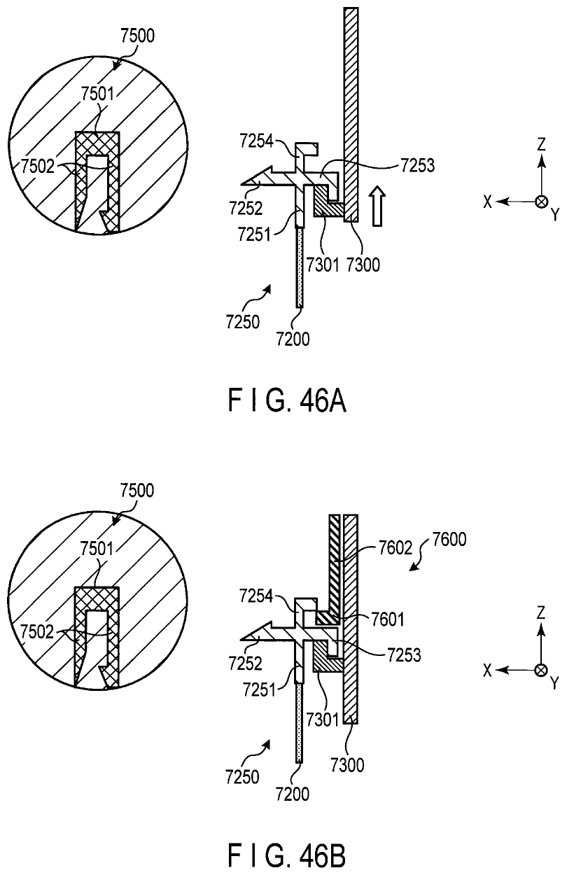

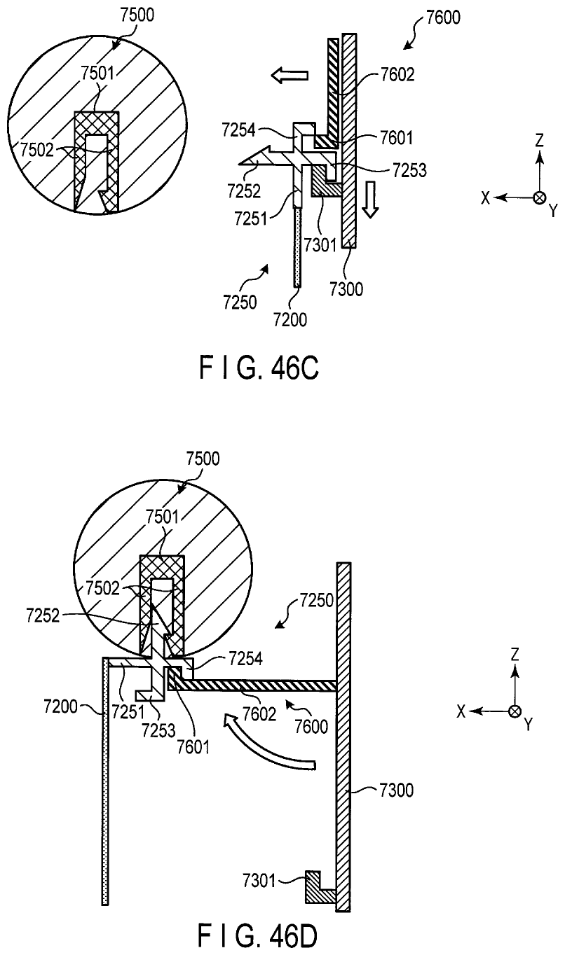

FIGS. 46A to 46D are diagrams for explaining the sheet collection mechanism connection part 7250 and the sheet collection mechanism 7500 in the first modification of the present embodiment. As shown in FIGS. 46A to 46D, the sheet collection mechanism connection part 7250 has a body part 7251 and connection parts 7252 to 7254 provided on the body part 7251. The body part 7251 is provided with the connection parts 7252 to 7254. The sheet collection mechanism connection part 7250 is provided at the distal end of the measurement sheet 7200. Specifically, as shown in FIG. 46A, the body part 7251 of the sheet collection mechanism connection part 7250 is connected to the sheet distal end connection part 7202 provided at the distal end of the measurement sheet 7200.

At the core part 7240 of the measurement cartridge 7220, the sheet collection mechanism 7500 collects a used measurement sheet 7200 into the measurement cartridge 7220A on the cartridge conveyor mechanism 7230. The sheet collection mechanism 7500 has a body part 7501 and a connection part 7502. The body part 7501 is provided with the connection part 7502.

The connection part conveyor mechanism 7600 is a member for guiding a used measurement sheet 7200 to the core part 7240, which is the center of the measurement cartridge 7220A, on the cartridge conveyor mechanism 7230. The connection part conveyor mechanism 7600 has a connection part 7601 and a support part 7602. The connection part 7601 is provided at one end of the support part 7602. The other end of the support part 7602 is connected to the sheet conveyance part 7300 of the sheet conveyor mechanism 7350. Before collecting the measurement sheet 7200, the support part 7602 is provided along the sheet conveyance part 7300.

Processing of the automatic analyzer 1 according to the first modification of the present embodiment will be described with reference to FIGS. 45A to 45F and 46A to 46D.

First, in FIG. 45A, two measurement cartridges 7220, the measurement cartridges 7220A and 7220B, for example, are installed in the cartridge conveyor mechanism 7230. The measurement cartridge 7220A is arranged in the measurement region L100, and the measurement cartridge 7220B is arranged in the installation region L200. Here, in FIG. 46A, for example, by clockwise rotation of the sheet conveyance part 7300 of the sheet conveyor mechanism 7350 by driving of the drive apparatus 8000, the connection part 7253 of the sheet collection mechanism connection part 7250 provided at the distal end of the measurement sheet 7200 housed in the measurement cartridge 7220A is connected to the connection part 7301 of the sheet conveyance part 7300.

Next, in FIG. 45B, for example, the measurement sheet 7200 is pulled out from the measurement cartridge 7220A in the measurement region L100 by further clockwise rotation of the sheet conveyance part 7300 of the sheet conveyor mechanism 7350 by driving of the drive apparatus 8000. Here, the pulled-out measurement sheet 7200 is conveyed to the dispensing mechanism 710 and the measurement mechanism 725. Specifically, the dispensing mechanism 710 discharges a sample to a part to be measured 7210 of the measurement sheet 7200 that is located at the sample discharging position L4, and the measurement mechanism 725 performs potential measurement and colorimetric measurement as measurement based on test items.

In FIG. 45B, for example, by further clockwise rotation of the sheet conveyance part 7300 of the sheet conveyor mechanism 7350 by driving of the drive apparatus 8000, the measurement sheet 7200 pulled out from the measurement cartridge 7220A in the measurement region L100 is returned from a position where the measurement sheet 7200 is pulled out to that position via the guide parts 7321 to 7323. At this time, as shown in FIGS. 45B and 46B, the connection part 7254 of the sheet collection mechanism connection part 7250 at the distal end of the measurement sheet 7200 is connected to the connection part 7601 of the connection part conveyor mechanism 7600.

In FIG. 45B, for example, the measurement sheet 7200 is fed by clockwise rotation of the sheet feed part 7310 of the sheet conveyor mechanism 7350 by driving of the drive apparatus 8000. The measurement sheet 7200 fed by the sheet feed part 7310 is conveyed to the dispensing mechanism 710 and the measurement mechanism 725, and once there, it is housed in a container (not shown).

Next, for example, all of the measurement sheet 7200 is fed by further clockwise rotation of the sheet feed part 7310 of the sheet conveyor mechanism 7350 by driving of the drive apparatus 8000, and the fed measurement sheet 7200 is conveyed to the dispensing mechanism 710 and the measurement mechanism 725. Here, in FIGS. 45C and 46C, for example, the connection between the connection part 7301 of the sheet conveyance part 7300 and the connection part 7253 of the sheet collection mechanism connection part 7250 is released by counterclockwise rotation of the sheet conveyance part 7300 of the sheet conveyor mechanism 7350 by driving of the drive apparatus 8000. In FIGS. 45D, 46C, and 46D, for example, the support part 7602 of the connection part conveyor mechanism 7600 is erected by driving of the drive apparatus 8000 to guide the used measurement sheet 7200 to the core part 7240 of the measurement cartridge 7220A on the cartridge conveyor mechanism 7230, and the connection part 7252 of the sheet collection mechanism connection part 7250 provided at the distal end of the measurement sheet 7200 is connected to the connection part 7502 of the sheet collection mechanism 7500.

In FIG. 45E, for example, the measurement cartridges 7220A and 7220B on the cartridge conveyor mechanism 7230 are rotated by driving of the drive apparatus 8000. At this time, for example, the used measurement sheet 7200 of the measurement cartridge 7220A is collected in the collection region, which is the installation region L200, by counterclockwise rotation of the core part 7240 of the measurement cartridge 7220A by driving of the drive apparatus 8000. That is, by rotating the measurement cartridges 7220A and 7220B, the cartridge conveyor mechanism 7230 conveys the measurement cartridge 7220A from the measurement region L100 to the installation region L200, and causes the sheet collection mechanism 7500 to collect the used measurement sheet 7200 into the measurement cartridge 7220A in the installation region L200. At this time, the sheet collection mechanism 7500 collects the used measurement sheet 7200 into the measurement cartridge 7220A by rewinding the used measurement sheet 7200 starting from the center of the measurement cartridge 7220A in the installation region L200.

In FIG. 45F, for example, the user replaces the measurement cartridge 7220 having the used measurement sheet 7200 with a measurement cartridge 7220 having a measurement sheet 7200 before use in the installation region L200 while the measurement sheet 7200 of the measurement cartridge 7220B is being used. In this way, the user can dispose of the measurement cartridge 7220A having the used measurement sheet 7200 and install a new measurement cartridge 7220 in the cartridge conveyor mechanism 7230 in the installation region L200 while the measurement sheet 7200 of the measurement cartridge 7220B is being used.

### Second Modification of Third Embodiment

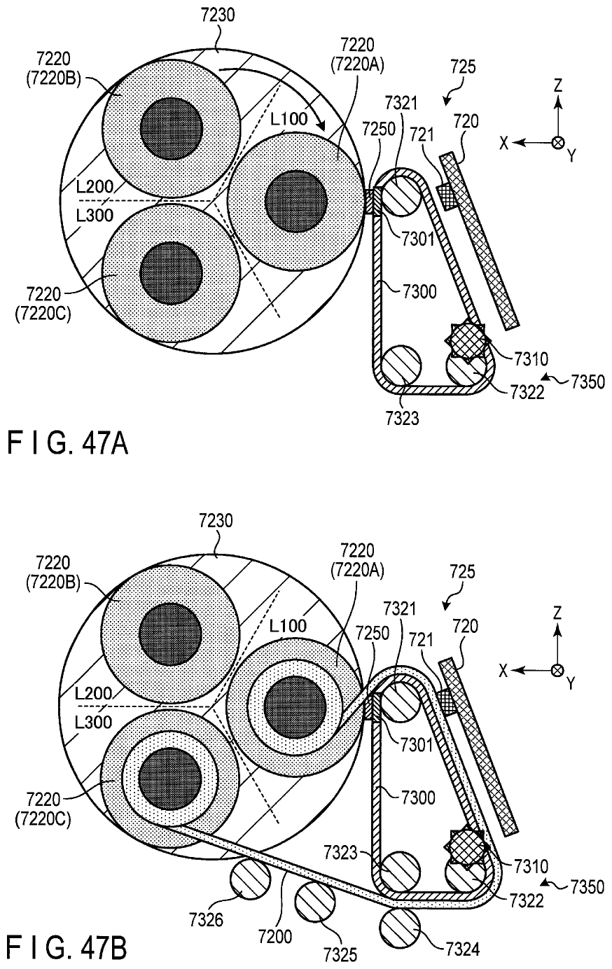

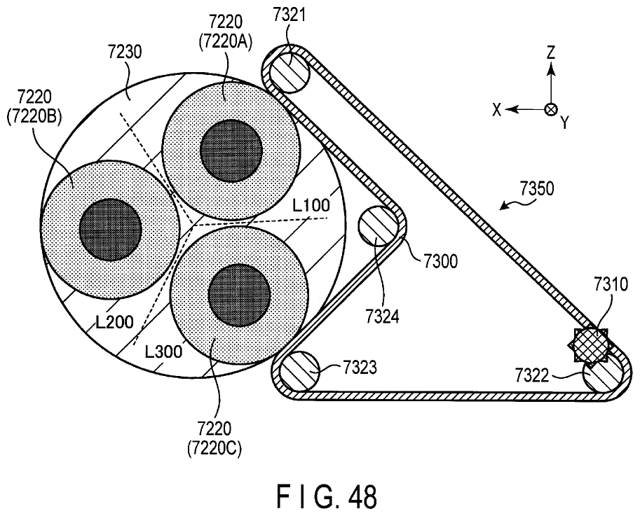

FIGS. 47A, 47B, and 48 are diagrams for explaining processing of an automatic analyzer 1 according to a second modification of the present embodiment.

In the above-described embodiment, the cartridge conveyor mechanism 7230 holds two measurement cartridges 7220 in such a manner that the measurement cartridges 7220 can be rotated, but it can also hold three or more measurement cartridges 7220 in such a manner that the measurement cartridges can be rotated. For example, as shown in FIG. 47A, the cartridge conveyor mechanism 7230 is provided with a measurement region L100 for pulling out a measurement sheet 7200 from a measurement cartridge 7220, a collection region L300 for collecting a used measurement sheet 7200 into a measurement cartridge 7220, and an installation region L200 for installing a new measurement cartridge 7220 housing a measurement sheet 7200 before use. For example, measurement cartridges 7220A, 7220B, and 7220C are installed in the measurement region L100, installation region L200, and collection region L300, respectively, as the measurement cartridges 7220.

Here, in FIG. 47B, for example, the user disposes of the measurement cartridge 7220C in the collection region L300. In a case of collecting a used measurement sheet 7200 of the measurement cartridge 7220A, the cartridge conveyor mechanism 7230 conveys the measurement cartridge 7220A from the measurement region L100 to the collection region L300 and conveys the new measurement cartridge 7220B housing a measurement sheet 7200 before use from the installation region L200 to the measurement region L100 by rotating the measurement cartridges 7220A and 7220B. In this case, as shown in FIGS. 47B and 48, guides 7325 and 7326 may be added or the shape of the sheet conveyance part 7300 may be modified to guide the distal end portion of the used measurement sheet 7200 to the core part 7240, which is the center of the measurement cartridge 7220A.

### Third Modification of Third Embodiment

As processing of an automatic analyzer 1 according to a third modification of the present embodiment, the control function 3200 of the processing circuitry 3000 in FIG. 34 displays state information indicating a state of use of a measurement cartridge 7220 on a display part. The control function 3200 is an example of a controller. For example, the display part is a display realized by the output device 4000. Alternatively, in the example shown in FIG. 41, the display part is a light emitting diode (LED) provided near the installation region L200.

In a case of displaying state information on an LED in the example shown in FIG. 41, the control function 3200 lights the LED in green if, as a state of a measurement cartridge 7220 in the installation region L200 (or collection region), the measurement cartridge 7220A is used for measurement in the measurement region L100 and a new measurement cartridge 7220B housing a measurement sheet 7200 before use is installed in the installation region L200. If the sheet collection mechanism described above has completed its operation and the measurement cartridge 7220A which has collected the used measurement sheet 7200 is present in the installation region L200, the control function 3200 lights the LED in orange. If the sheet collection mechanism described above is in operation and the sheet collection mechanism is collecting the used measurement sheet 7200, the control function 3200 lights the LED in red.

This allows the user to check the state of use of the measurement cartridge 7200 and replace the used measurement cartridge 7220 with a measurement cartridge 7220 having a measurement sheet 7200 before use.

According to the above-described third embodiment, it is possible to improve the measurement efficiency.

According to at least one embodiment described above, it is possible to realize downsizing of the device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An automatic analyzer comprising:
a holding unit configured to hold a measurement sheet having a roll shape, the measurement sheet including a measurement section where a sample dispensed at a dispensing position is measured;
a conveyance unit configured to convey the measurement sheet to the dispensing position and a measurement position where measurement is performed on the sample; and
a measurement unit configured to move to the measurement position and measure a material property value of the sample.

2. The automatic analyzer according to claim 1, wherein
the measurement unit is configured to move to a position that enables measurement on a reaction-completed sample and perform sample measurement in order of reaction completion.

3. The automatic analyzer according to claim 1, wherein
the conveyance unit is configured to feed the measurement sheet each time the sample is dispensed to the measurement sheet.

4. The automatic analyzer according to claim 1, wherein
the conveyance unit is configured to feed the measurement sheet at predetermined time intervals.

5. The automatic analyzer according to claim 1, wherein
the measurement unit includes an electrode that changes in potential according to an amount of a specific component contained in the sample.

6. The automatic analyzer according to claim 1, wherein
the measurement sheet contains a reagent and causes the dispensed sample to react with the reagent, and
the measurement unit is configured to measure a change in color of the sample that reacts with the reagent.

7. The automatic analyzer according to claim 1, wherein
the conveyance unit further includes a constant temperature part configured to keep the measurement sheet at a constant temperature.

8. The automatic analyzer according to claim 1, wherein
the measurement sheet held by the holding unit includes a plurality of measurement sheets.

9. The automatic analyzer according to claim 8, wherein
the holding unit is configured to collect a fed measurement sheet.

10. The automatic analyzer according to claim 8, wherein
an installation position where the measurement sheet is installed and a measurement position where a placed measurement sheet is used for measurement are set in the holding unit, and the holding unit is configured to move the measurement sheet between the installation position and the measurement position.

11. The automatic analyzer according to claim 8, wherein
the holding unit includes a plurality of holding units, and
the measurement unit is configured to move to measurement positions set in the holding units.

12. The automatic analyzer according to claim 1, wherein
the measurement sheet includes a plurality of item measurement parts, and
each of the item measurement parts includes a dispensing section into which a sample is dispensed, a flow channel through which the sample dispensed into the dispensing section automatically flows, and a measurement section where measurement is performed by the measurement unit on the sample conveyed through the flow channel.

13. The automatic analyzer according to claim 12, wherein
the plurality of item measurement parts are provided along a width direction of the measurement sheet, and
the conveyance unit is configured to feed the measurement sheet each time the sample is dispensed to each of the item measurement parts provided along the width direction.

14. The automatic analyzer according to claim 1, further comprising:
a first aspirating position where an unmeasured sample is aspirated;
a second aspirating position where a sample determined to require remeasurement is aspirated; and
a control part configured to determine a necessity for remeasurement based on a sample measurement result and convey the sample determined to require remeasurement to the second aspirating position.

15. The automatic analyzer according to claim 1, further comprising:
a reaction disk configured to hold a plurality of reaction containers each containing a mixture liquid of a reagent and a sample; and
a second measurement unit configured to measure a material property value of the mixture liquid.

16. The automatic analyzer according to claim 15, wherein
the measurement unit includes an electrode that changes in potential according to an amount of a specific component contained in the sample, and
the second measurement unit is configured to measure a change in color of the mixture liquid.

17. The automatic analyzer according to claim 1, further comprising a control part configured to move the measurement sheet so that a reaction-completed sample is located at a measurement position at a predetermined measurement timing by controlling feeding and winding of the measurement sheet performed by the conveyance unit.

18. The automatic analyzer according to claim 1, further comprising:
a plurality of the measurement units arranged at a plurality of measurement positions; and
a control part configured to cause the measurement to be performed using a measurement unit, among the measurement units, that is arranged at a position that enables measurement of a measurement section in which a reaction is completed.

19. The automatic analyzer according to claim 1, wherein
the measurement unit includes an electrode and a conduction part, the electrode changing in potential according to an amount of a specific component contained in the sample, the conduction parts being electrically connected to the electrode and connectible to the measurement section at a plurality of measurement positions, and
the measurement unit is configured to perform the measurement by connecting a measurement section in which a reaction is completed to the conduction part.

20. The automatic analyzer according to claim 1, further comprising:
a measurement cartridge configured to house the measurement sheet;
a dispensing mechanism configured to dispense the sample to the measurement sheet;
a cartridge conveyor mechanism configured to convey the measurement cartridge from a measurement region to a collection region different from the measurement region; and
a sheet collection mechanism configured to collect the measurement sheet after use into the measurement cartridge in the collection region,
wherein the conveyance unit is configured to pull out the measurement sheet from the measurement cartridge in the measurement region to convey the measurement sheet to the dispensing mechanism and the measurement unit.

21. The automatic analyzer according to claim 20, wherein
the cartridge conveyor mechanism is provided with the measurement region and an installation region for installing a new measurement cartridge housing a measurement sheet before use,
the cartridge conveyor mechanism is configured to convey the measurement cartridge from the measurement region to the installation region when the measurement sheet after use is collected, and
the installation region is used as the collection region.

22. The automatic analyzer according to claim 20, wherein
the cartridge conveyor mechanism is provided with the measurement region, the collection region, and an installation region for installing a new measurement cartridge housing a measurement sheet before use, and
the cartridge conveyor mechanism is configured to convey the measurement cartridge from the measurement region to the collection region when the measurement sheet after use is collected.

23. The automatic analyzer according to claim 20, wherein
the sheet collection mechanism is configured to collect the measurement sheet after use into the measurement cartridge by rewinding the measurement sheet after use in the collection region.

24. The automatic analyzer according to claim 20, wherein
the cartridge conveyor mechanism is configured to convey the measurement cartridge from the measurement region to the collection region by rotating the measurement cartridge and cause the sheet collection mechanism to collect the measurement sheet after use into the measurement cartridge in the collection region.
